(19) United States
(12) Patent Application Publication
(10) Pub. No.: US 2022/0075812 A1
(43) Pub. Date: Mar. 10, 2022

(54) USING CONTENT

(71) Applicant: ClipFile Corporation, Newton Center, MA (US)

(72) Inventors: Rolly Rouse, Newton Center, MA (US); Shawn C. Becker, Waltham, MA (US)

(21) Appl. No.: 17/314,921

(22) Filed: May 7, 2021

Related U.S. Application Data
(63) Continuation of application No. 13/896,097, filed on May 16, 2013, now abandoned.
Application No. 13/896,097 is a continuation of application No. 13/895,325, filed on May 15, 2013, now abandoned.
Application No. 13/896,097 is a continuation of application No. PCT/US2013/041253, filed on May 15, 2013.
(60) Provisional application No. 61/649,031, filed on May 18, 2012.
(60) Provisional application No. 61/649,031, filed on May 18, 2012.

(51) Int. Cl. G06F 16/41; G06F 16/35

(52) U.S. Cl. CPC G06F 16/41; G06F 16/353

(57) ABSTRACT

Among other things, the ability of people and entities to produce, distribute, and use text, images, video, and other items of digital content is enhanced by providing software tools that enable them to (a) clip items of the digital content on any platform that is capable of presenting the digital content, (b) store copies of the clipped items along with copies of items clipped by other people or entities, in a common storage place controlled by a host, (c) form and store meshes of tags to represent their mindsets about items of content. The tags include primary tags that express their direct observations about the content and secondary tags that express their observations about the primary tags and the secondary tags. Meshes of the tags are made available to the people who formed them and, if permitted by them, to other people and entities for use in understanding their mindsets and in producing, delivering, and using digital content.

### CROSS-REFERENCE

This application is a continuation of and claims priority under 35 U.S.C. § 120 to U.S. patent application Ser. No. 13/896,097, filed May 16, 2013, which is a continuation of and claims priority under 35 U.S.C. § 120 to U.S. patent application Ser. No. 13/895,325, filed May 15, 2013, and PCT Application No. PCT/US2013/041253 filed May 15, 2013 (which both claim priority to U.S. Provisional Application Ser. No. 61/649,031, filed May 18, 2012), and claims priority to U.S. Provisional Application Ser. No. 61/649,031, filed May 18, 2012, the entire contents of each of which are hereby incorporated by reference.

### BACKGROUND

This description relates to using content.

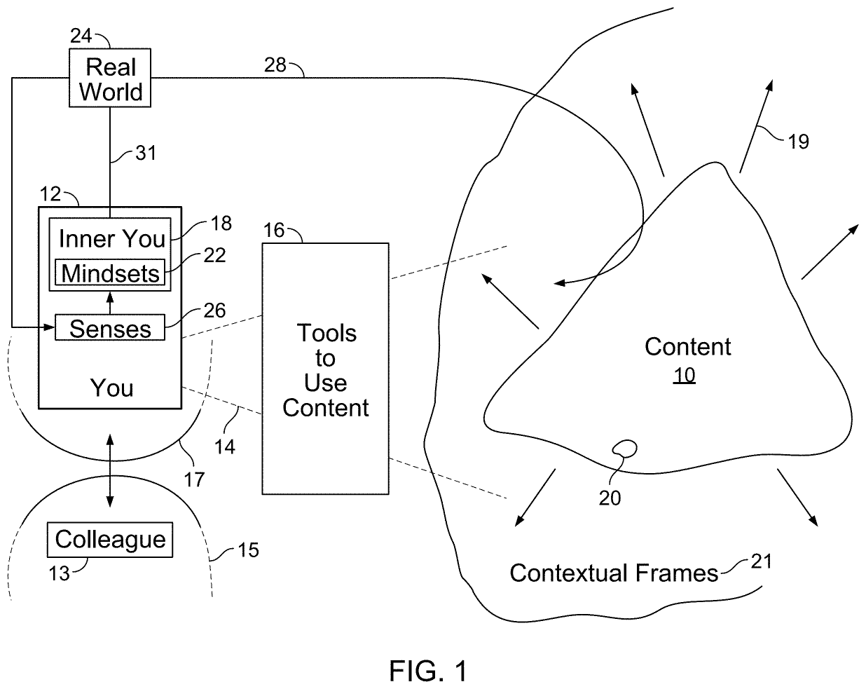

Thanks to personal electronic gizmos, a reliable Internet, and dirt-cheap memory, we all have access continually and everywhere to a huge mound of digital content 10 (FIG. 1). The volume can overwhelm you. And using it can be painful.

Try finding things that match your interests. Or take a stab at saving the good stuff somewhere handy. See if you can organize big bunches of it in a way that squares with your perspective on the world. Do you 12 (see FIG. 1) have personal control of your view 14 into content that sings to you? Or are the search engine, the social network, and other tools for using content 16 that stand between you and the content in charge of what you see? Try sharing your treasure (and your way of looking at it) with a colleague 13. And is there any easy way to get a view into what a friend or a group of them has gathered and the meaning that it has to her or them, without invading your privacy 17 or theirs 15?

This wealth of digital content is going to grow. Explosively 12. And so is the pain of using it. The availability of this content holds the tantalizing promise of a richer life, more nuanced learning, deeper thinking, and a better matching of your intellectual connection 31 to the world with the inner you 18. Will the opportunity be lost for lack of effective tools 16 to find, save, organize, annotate, and share the content? And will this lack of efficient access to meaningful content keep you from creating and sharing content yourself?

The instruments at hand to find, organize, use, and share digital content (search engines, databases, social networks, real-time networks, social bookmarking systems, and others) are powerful. But our idea (laid out below) promises to elevate personal inquiry and understanding, and personalization of your information experience wherever you go, to levels these tools do not and perhaps cannot make possible.

### SUMMARY

In general, in an aspect, the ability of people and entities to produce, distribute, and use text, images, video, and other items of digital content is enhanced by providing software tools that enable them to (a) clip items of the digital content on any platform that is capable of presenting the digital content, (b) store copies of the clipped items along with items clipped by other people and entities in a common storage place controlled by a host, (c) form and store meshes of tags to represent their mindsets about items of content. The tags include primary tags that express direct observations about the content and secondary tags that express observations about the primary tags and the secondary tags. Meshes of the tags are made available to the people who formed them and, if permitted by them, to other people and entities for use in understanding their mindsets and in producing, delivering, and using digital content.

In general, in an aspect, a publisher of content obtains access to information about stored tags that represent mindsets of users of text, images, video, and other items of digital content. The tags include primary tags that express direct observations of users about the content and secondary tags that express their observations about the primary tags and the secondary tags. The information about the stored tags is used in selecting, organizing, or editing content, and electronically delivering the selected, organized, or edited content to users.

In general, in an aspect, a host receives text, images, video, or other items of digital content that have been designated by users of websites, mobile applications, or other content delivery platforms. Copies of the items of content and associated attribution information, timestamps, and identifications of users who designated the items are stored. The information that associates the users with the items of content is protected from disclosure except with permission of the users. Tags are stored and they include primary tags that express the direct observations of users about the content and secondary tags that express observations of the users about the primary tags and the secondary tags. Information that associates the tags with the users who expressed them is stored. The tags represent mindsets. The information that associates the tags with the users who expressed them is protected, except with permission of the users. The tags are made available to users for use in understanding mindsets and for application in producing, delivering, and using digital content.

In general, in an aspect, at a time when text, an image, a video, or another item of digital content is being presented to a user on a website, a mobile application, or other delivery platform, a user interface element is presented to user that shows possible tags that can be selected by the user to represent observations of the user about the content being presented. The tags include primary tags that express direct observations about the content and secondary tags that express observations about the primary tags and the secondary tags.

In general, in an aspect, at a time when text, an image, a video, or another item of digital content is being presented to a user on a website, a mobile application, or other delivery platform, a user interface element is presented to the user that enables the user to designate a part that is less than the entire item of digital content and to have a copy of that part of the item saved at a central server along with copies of parts of items of content designated by other users of other delivery platforms, the copies being saved with attribution information, identification of the user, and a timestamp.

In general, in an aspect, a repository contains (a) copies of text, images, videos, and other items of digital content, (b) tags that represent mindsets of users, the tags including primary tags that express direct observations of users about the content and secondary tags that express their observations about the primary tags and the secondary tags, and (c) identification information that associates each of the users with the tags that represent the user's mindsets. A host of the repository protects the identification information from disclosure to any party other than the user without the user's permission.

In general, in an aspect, a repository accesses and digitally stores copies of items of content received electronically, without limiting the accepting and storing on the basis of a volume of the items.

Implementations may include one or more of the following features. The repository is under control of a single authority. The accepting and storing of the copies of items of content is not limited on the basis of the number of the items of content. The accepting and storing of the copies of items of content is not limited on the basis of the size of any of the items of content. The accepting and storing of the copies of items of content is not limited on the basis of times when copies of items of content are accepted. The repository includes digital storage servers.

In general, in an aspect, at a repository, copies are accepted and digitally stored of items of content received electronically, essentially without limiting the accepting and storing on the basis of a source of the items.

Implementations may include one or more of the following features. The repository is under control of a single authority. The items are accepted and stored without limitation as to a hardware platform from which they are received. The items are accepted and stored without limitation as to a software platform from which they are received. The items are accepted and stored without limitation as to a communication medium through which they are received. The items are accepted and stored without limitation as to an identity of a user from whom or which they are received. The items are accepted and stored without limitation as to a relationship between the source and the item.

In general, in an aspect, a repository accepts and digitally stores copies of items of content received electronically. At least a some of the items of content include granular pieces of less than all of original items of content from which the copies were made, the items having any degree of granularity relative to the original items.

Implementations may include one or more of the following features. The repository is under control of a single authority. One of the original items of content includes pieces represented in at least two different formats. The granular pieces and the stored copies of items of content include pieces that are each of a single format. The two different formats include a text format and an image or video format. One of the stored copies of items of content is of only text format and another of the stored copies of items of content is of only image or video format. The degree of granularity is finer than a sentence of text, a full image, or a full video.

In general, in an aspect, through a user interface, users are enabled (a) to designate items of content presented to them by content presentation platforms, (b) to express recursive observations about the items of content, and (b) to have copies of the designated items of content and the recursive observations stored digitally at a repository.

Implementations may include one or more of the following features. The content delivery platforms are under independent control of one another. The repository is under control of a single authority. The user interface provides a common interface experience for designating the items across the content presentation platforms. The user interface is presented to a user simultaneously with presentation of the items of content. The user interface is presented independently of the presentation of the items of content. The designating of an item of content includes selecting a portion that is less than all of the content being presented to the user at a given time. Potential recursive observations (e.g., a pool of tags) are presented to the user through the user interface. The potential recursive observations include previously stored observations. The potential recursive observations include previously stored observations of the user to whom the items of content are being presented. The potential recursive observations correspond to a mindset of the user to whom the items of content are being presented. The potential recursive observations include previously stored observations of users other than the user to whom the items of content are being presented.

In general, in an aspect, items of content from content presentation platforms that are under independent control with respect to one another and with respect to a single authority that controls the repository automatically accumulating and storing in a repository.

Implementations may include one or more of the following features. Observations about the items of content are automatically inferred, the observations being associated with users of the content presentation platforms. The observations are inferred based on the content. The observations are inferred based on information about the users. The observations are inferred based on a context in which the users are expected to experience the items of content. The observations are inferred based on mindsets of users. The inferred observations and explicit observations of users are stored in the repository.

In general, in an aspect, at a repository, copies are stored of items of content that were designated for storing by unrelated users of independent content presentation platforms. In association with the copies of the items, information is stored about the items or contexts in which the users identified them.

Implementations may include one or more of the following features. The information includes attribution for the items of content. The information includes timestamps associated with the designation, storage, or use of items of content. The information includes identifications of users associated with the items. The information includes identifiers of locations of the items from which the copies were made. The repository is under control of a single authority.

In general, in an aspect, a body of items of content have been stored in a repository based on designations (e.g., they have been clipped) by unrelated users on independent content delivery platforms. The items are then organized based on contexts in which the designations were made.

Implementations may include one or more of the following features. The context includes identities of users. The context includes the times when designations were made. The context includes attribution of the items of content.

In general, in an aspect, users have access through any content presentation platform to any item of content stored in a repository that contains stored copies of items of content essentially without limit as to the volume of the stored items, the sources of the stored items, or the degree of granularity of the stored items relative to the original items from which they were copied.

Implementations may include one or more of the following features. The content delivery platform includes an online facility. The content delivery platform includes a website. The access is provided through a user interface. The repository is under control of a single authority.

In general, in an aspect, users of independent content presentation platforms on which content from independent content sources may be presented, can discover items of content one after another, the discovery occurring in a direct sequence from one of the independent content delivery platforms to another. Discovery is based on stored observations about content that suggest the next content item in the direct sequence will be of interest to the users.

Implementations may include one or more of the following features. The direct sequence includes a user experiencing an item of content and, immediately after experiencing the item of content, experiencing another item of content in the direct sequence. The stored observations are presented to the user in connection with the discovery. The stored observations represent a mindset. The discovery is guided by the user based on stored observations. The observations were stored with respect to the user who is engaged in the discovery. The observations were stored with respect to at least one user other than the user who is engaged in the discovery.

In general, in an aspect, enabling users of items of content to be exposed to content at two or more different selectable degrees of detail, the detail that is exposed to the users at the different degrees being determined based on recursive observations about items of content.

Implementations may include one or more of the following features. An item of content has a larger number of elements at one of the degrees of detail and a smaller number of elements at another of the degrees of detail. The recursive observations are associated with mindsets of the user. The two or more different selectable degrees of detail for a given item of content for one of the users differ from the different selectable degrees of detail for the given item of content for another one of the users. The selectable degrees of detail are based on a context in which a user is being exposed to an item of content. The selectable degrees of detail are based on a source of the item of content.

In general, in an aspect, an electronic facility enables users of items of content to share the items of content and recursive observations about the items of content and to receive payment for the sharing.

Implementations may include one or more of the following features. The sharing is with other users. The sharing by users is with other users who are social network contacts of the sharing users. The sharing by users is with other users unknown to the sharing users.

The sharing is with providers of content. The sharing includes providing access to copies of the items of content or the recursive observations that are stored in a repository.

In general, in an aspect, at a repository accepting and storing recursive observations received electronically from users about items of content that have been presented to users through independent content delivery platforms without limitation

Implementations may include one or more of the following features. The recursive observations are accepted and stored without limitation as to their volume. The recursive observations are accepted and stored without limitation as to their source. The recursive observations are accepted and stored without limitation as to the depth of the recursion. The recursive observations are accepted and stored without limitation as to the content delivery platform. The recursive observations represent mindsets of the users.

In general, in an aspect, for recursive observations about the items of content, the items of content and the recursive observations being stored at a repository, associating with respective items of content, information about contexts in which the observations were made.

Implementations may include one or more of the following features. The repository is under control of a single authority. The information about contexts include timestamps. The contexts include activities associated with use of the items of content or the observations. The contexts include identification of users who made the observations.

In general, in an aspect, a repository accepts and stores recursive observations that are made by users with respect to items of content that are presented to the users from any content sources on any content delivery platforms.

Implementations may include one or more of the following features. The repository is under the control of a single authority. The recursive observations are accepted from software running on the content delivery platforms at the times when the observations are made. The software is running as part of the content delivery platforms. The software is running in parallel with and independently of the content delivery platforms. Previously stored observations are presented to the users at the times when the users are making their observations. The software presents uniform user interfaces on the respective content delivery platforms. The observations represent mindsets.

In general, in an aspect, for items of content from independently controlled content sources that are presented on independently controlled content delivery platforms, unrelated users can make recursive observations about the items of content through similarly presented user interfaces while the items of content are being presented and to have the observations stored at a repository.

Implementations may include one or more of the following features. The similarly presented user interfaces include presentations of recursive observations for reference by the user while the items of content are being presented. The repository is controlled by a single authority. The observations represent mindsets. The observations include words or phrases. The user interfaces enable the users to select observations from lists of available observations. The user interfaces overlay portions of content being presented. The observations include highlighting of portions of the content.

In general, in an aspect, items of content are presented to users from content sources through content delivery platforms. Recursive observations about the items of content are inferred automatically in connection with the presentation.

Implementations may include one or more of the following features. The observations represent mindsets. The observations are inferred from information related to the users. The observations are inferred from contexts in which the inferences are made. The observations are inferred from the nature of the items of content. The observations are inferred without knowledge or involvement of the users.

In general, in an aspect, users can electronically provide recursive observations about items of content. At least some of the observations can be organized as a group of observations that expresses human meaning associated with the content. The group of observations are made available to users to enhance their use of items of content.

Implementations may include one or more of the following features. The observations are organized based on the contexts in which they were made. The observations are organized based on the users who made them. The observations are organized based on the nature of the items of content to which they refer.

In general, in an aspect, users can access stored recursive observations of other users of content from access facilities that are controlled independently of sources of the content or of content delivery platforms in which the content is presented.

Implementations may include one or more of the following features. Access to the observations is controlled based on choices of the users who made the observations. The observations represent mindsets of the other users.

In general, in an aspect, enabling users to have access through a user interface at independently controlled content presentation platforms to stored recursive observations about items of content, the observations being stored at a central content repository under control of a single authority.

Implementations may include one or more of the following features. The user interface operates as part of the independently controlled content presentation platforms. The user interface operates independently of and in parallel to the independently controlled content presentation platforms. The independently controlled content presentation platforms are incompatible and the user interface user interface provides a common user experience across the platforms.

In general, in an aspect, for a body of recursive observations about items of content that are stored digitally, sets of the observations can be managed, the observations that belong to respective sets being associated with respective mindsets.

Implementations may include one or more of the following features. The mindsets include mindsets of users. Observations can be selected to be included in the sets. The observations can be organized within the sets. The sets of the observations can be organized on a time basis. The sets of the observations can be organized based on subject matter. The sets of the observations can be organized based on a project or topic. The sets of observations can be organized based on categories of observations. The sets of observations can be organized based on preferences of users.

In general, in an aspect, a set of recursive observations about items of content can represent mindsets and users can manipulate the set of observations.

Implementations may include one or more of the following features. The users can review observations and sets. The users can sort observations within sets. The users can filter observations within sets. The users can order the observations within sets. The users can use the sets as guides for discovery of content. The users can use the sets to understand items of content.

In general, in an aspect, for sets of recursive observations about items of content, the observations that belong to respective sets being associated with mindsets of users of items of content, one of the sets of observations can be matched to another of the sets of observations based on attributes of the sets of observations.

Implementations may include one or more of the following features. The attributes include the observations that belong to the sets. The attributes include the identities of users who made the observations. The attributes include the context in which the observations were made.

In general, in an aspect, for sets of recursive observations about items of content, the observations that belong to respective sets being associated with mindsets, content providers can use the sets of observations in connection with creating content.

Implementations may include one or more of the following features. The content providers can do at least one of the following: select content based on the sets, organize content based on the sets, and format the content based on the sets. The content providers include at least one of content creators, content owners, content curators, content publishers, content syndicators, content marketplace operators, content exchange operators, or advertisers.

In general, in an aspect, based on stored sets of recursive observations about items of content, the observations being associated with mindsets of users of items of content, the use of content can be personalized based on the stored sets of observations.

Implementations may include one or more of the following features. Items of content can be selected for publication based on the mindsets. A user's discovery of content can be guided based on the mindsets.

In general, in an aspect, based on stored sets of recursive observations about items of content, the observations being associated with mindsets of users of items of content, two or more of the sets of observations can be analyzed with respect to mindsets of users, and the observations made available in connection with use of content.

Implementations may include one or more of the following features. The analyzing includes comparing the observations in two or more sets of observations. The analyzing includes identifying patterns in the observations that belong to two or more of the sets of observations. The analyzing includes grouping two or more of the sets of observations and groups based on comparisons of the sets.

In general, in an aspect, for stored sets of recursive observations about items of content, the observations being associated with mindsets of users of items of content, users can control a blending of sets of observations in connection with a use of the observations in their use of content.

Implementations may include one or more of the following features. A user interface control enables continuous blending between entirely one set of observations and entirely another set of observations. A producer or provider of content can continuously blend between entirely one set of observations and entirely another set of observations in connection with selecting, editing, and assembling items of content for delivery to users.

In general, in an aspect, for sets of recursive observations about items of content, the observations that belong to respective sets being associated with mindsets of users of items of content, content channel distributors can use the sets of observations in connection with managing content channels.

In general, in an aspect, for stored sets of observations about recursive observations about items of content, the observations being associated with mindsets of users of items of content, patterns among observation sets can be inferred and the inferred patterns used in connection with use of content.

In general, in an aspect, for sets of observations about recursive observations about items of content, the observations that belong to respective sets being associated with mindsets of users of items of content, users can use the observation sets to share their mindsets with others.

In general, in an aspect, for stored recursive observations about items of content, the observations being associated with users of items of content, users who are associated with the observations can control access by other users to each of the observations individually.

In general, in an aspect, for a body of items of content that have been stored in a content repository and for stored information that associates the items of content with respective users of the items of content, access can be permitted to the information that associates the users with respective items of content. Each of the users can control access by others to the information that associates the user with any item of content, the control being applicable to each item of content independently.

In general, in an aspect, source users can constrain access of other users to information that associates the source users with recursive observations about items of content. The observations are stored at a central repository of observations that is under the control of a single authority.

In general, in an aspect, features are electronically incorporated in a content source platform or a content presentation platform, that enable a user of the platform to indicate items of content to be stored at a central repository and to generate recursive observations about items of content to be stored at the central repository. The central repository is under control of a single authority.

In general, in an aspect, a developer of a content source platform or a content presentation platform is given access electronically to a software development kit that enables the developer to incorporate into the platform features that enable a user of the platform to indicate items of content to be stored at a central repository and to generate recursive observations about items of content to be stored at the central repository. The central repository is under control of a single authority.

In general, in an aspect, a central repository of digital copies of items of content and recursive observations about content is hosted. Users can have access to copies of items, content and observations subject to restrictions imposed by users on information that associates them with items of content and observations.

These and other aspects, features, implementations, and combinations of them, can be expressed as methods, methods of doing business, program products, systems, components, means for performing steps or functions, apparatus, and in other ways.

These and other aspects, features, implementations, and advantages will become apparent from the following description and from the claims.

### DESCRIPTION

FIG. 1 is a block diagram of a person using content.

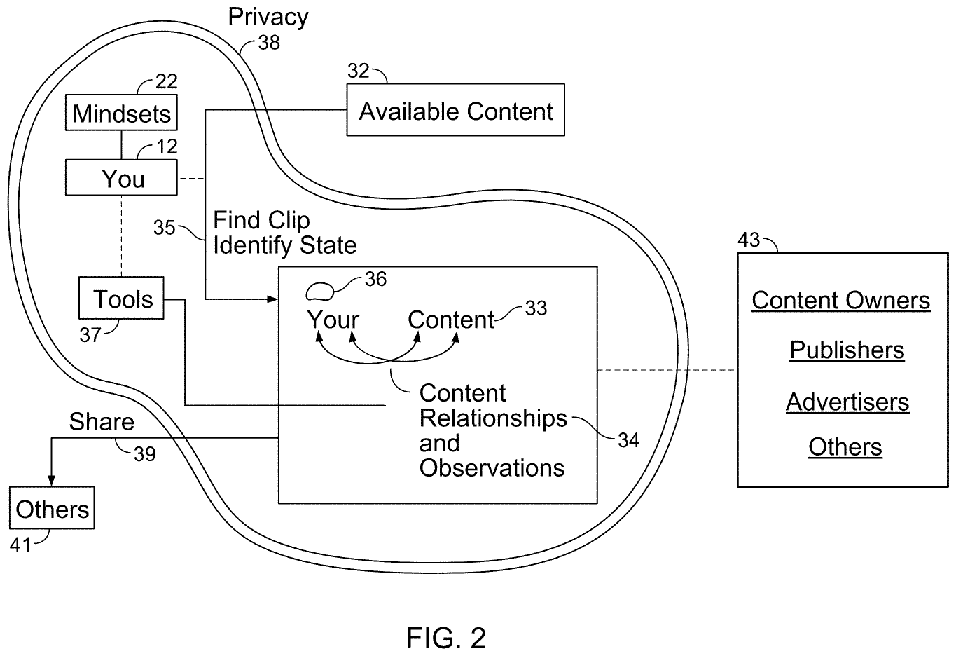

FIG. 2 is a block diagram of privacy protection.

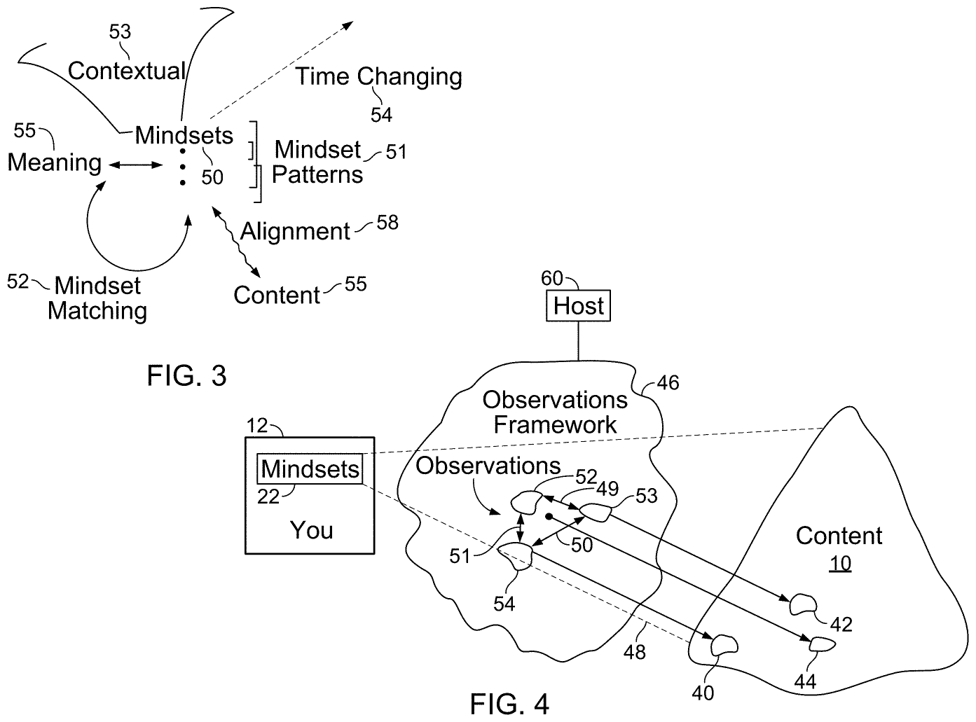

FIG. 3 is a schematic diagram of mindsets.

FIG. 4 is a schematic diagram of use of content.

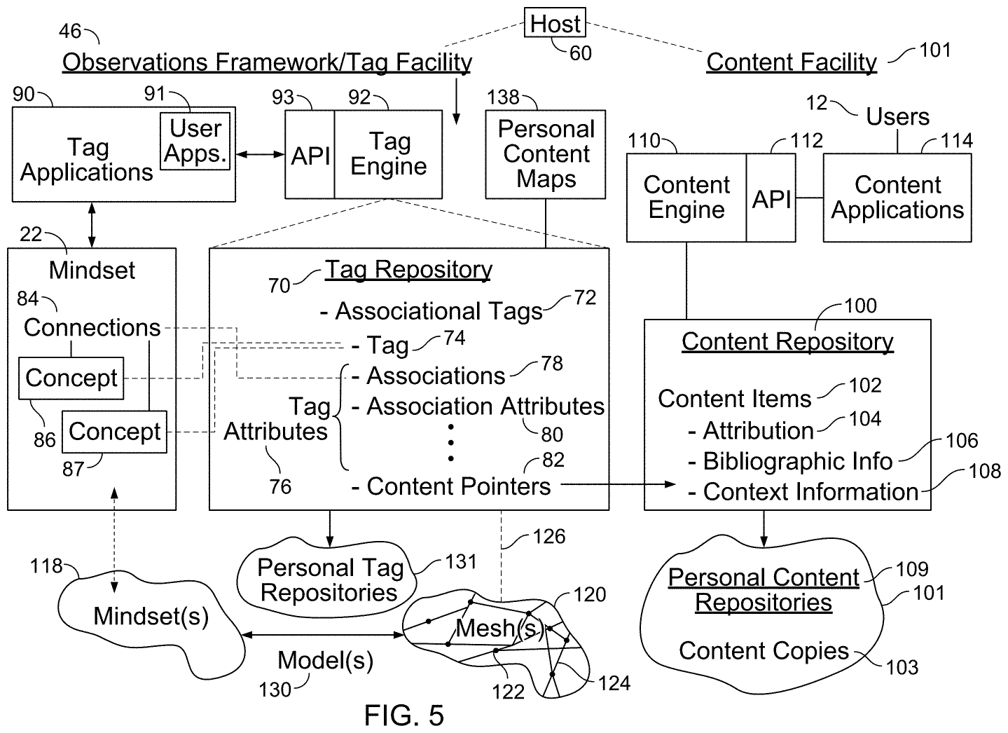

FIG. 5 is a block diagram of host facilities.

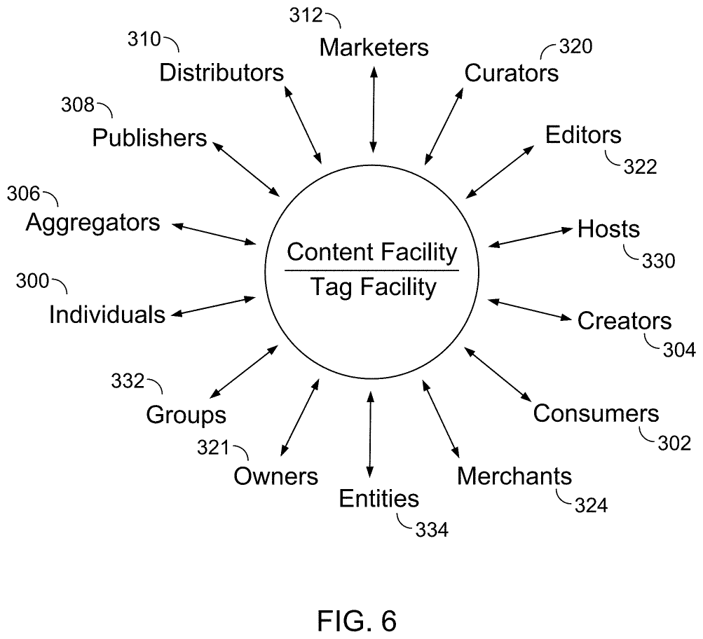

FIG. 6 is a diagram of facilities and participants.

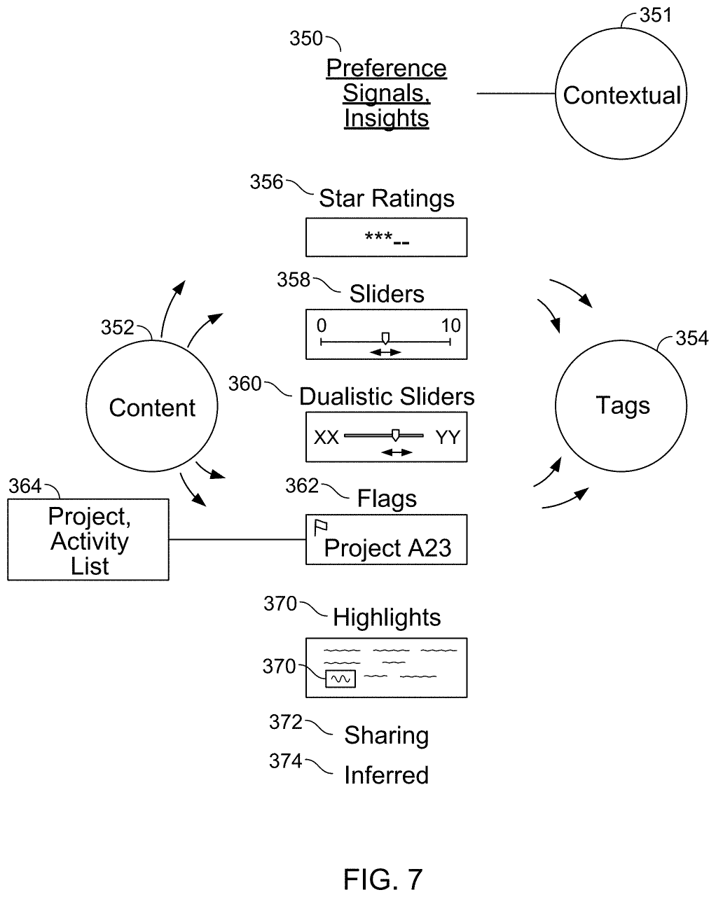

FIG. 7 is a schematic diagram of preference signals.

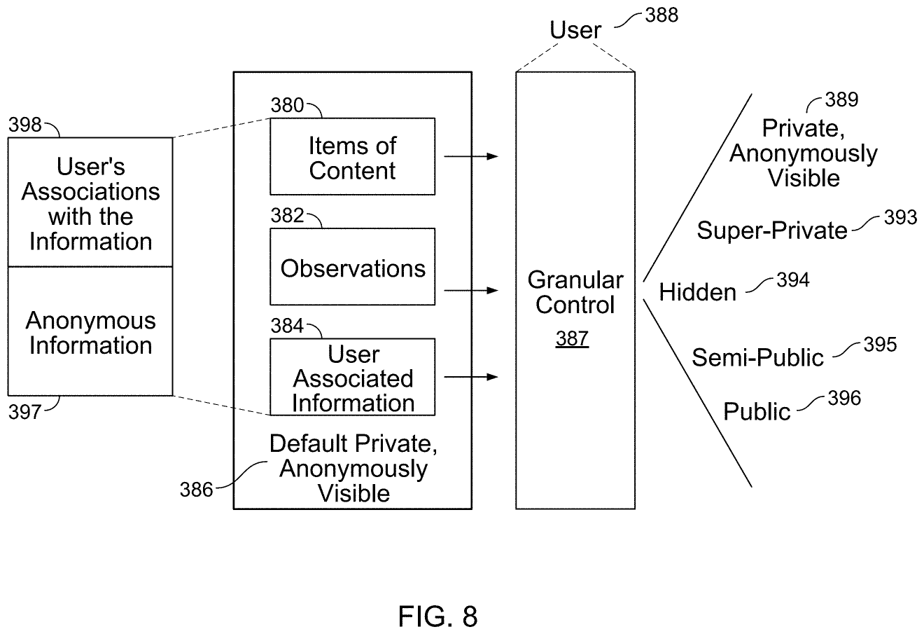

FIG. 8 is a block diagram of privacy protections.

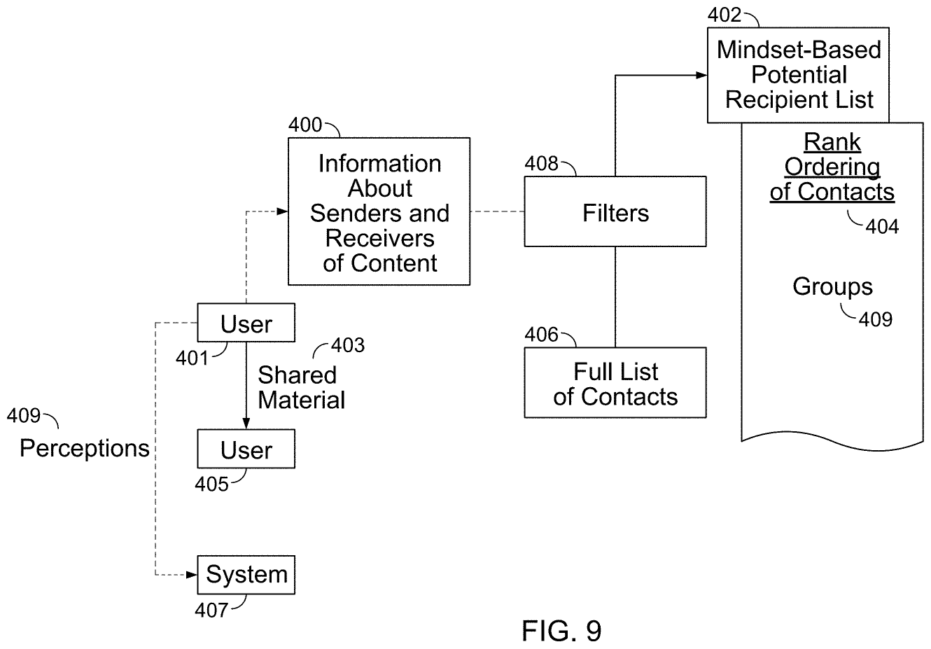

FIG. 9 is a block diagram of sharing.

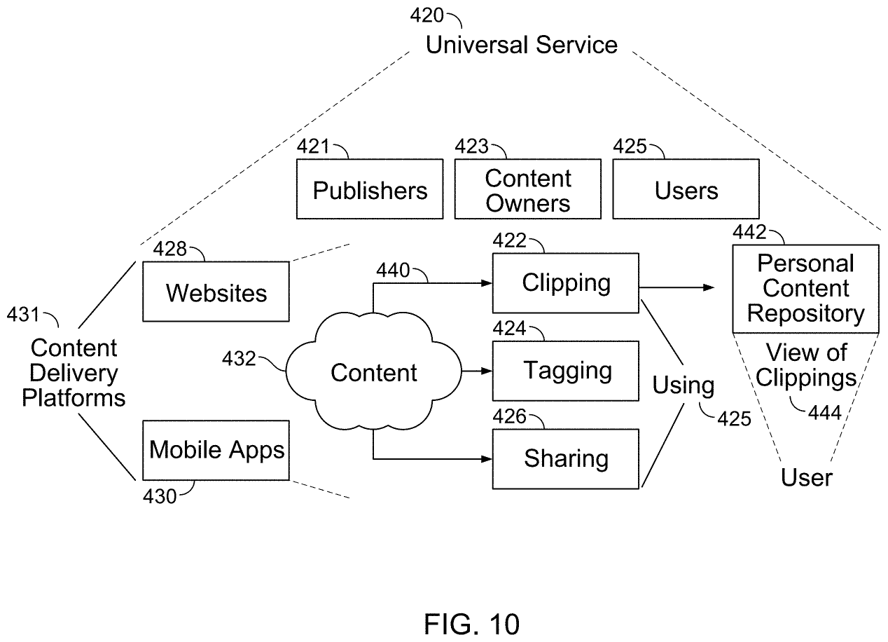

FIG. 10 is a block diagram of a universal service.

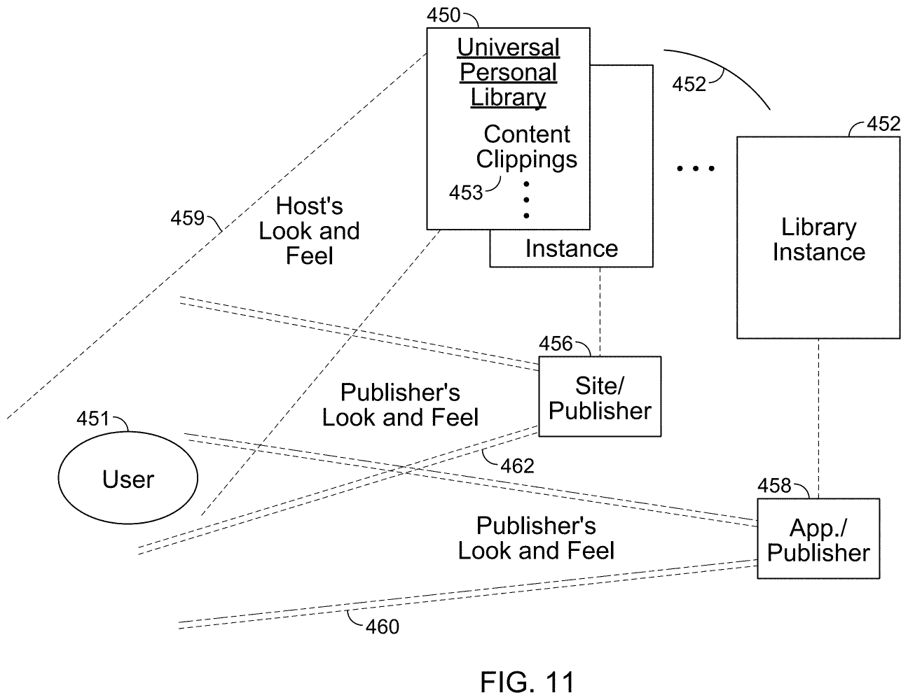

FIG. 11 of the schematic diagram of content publishing.

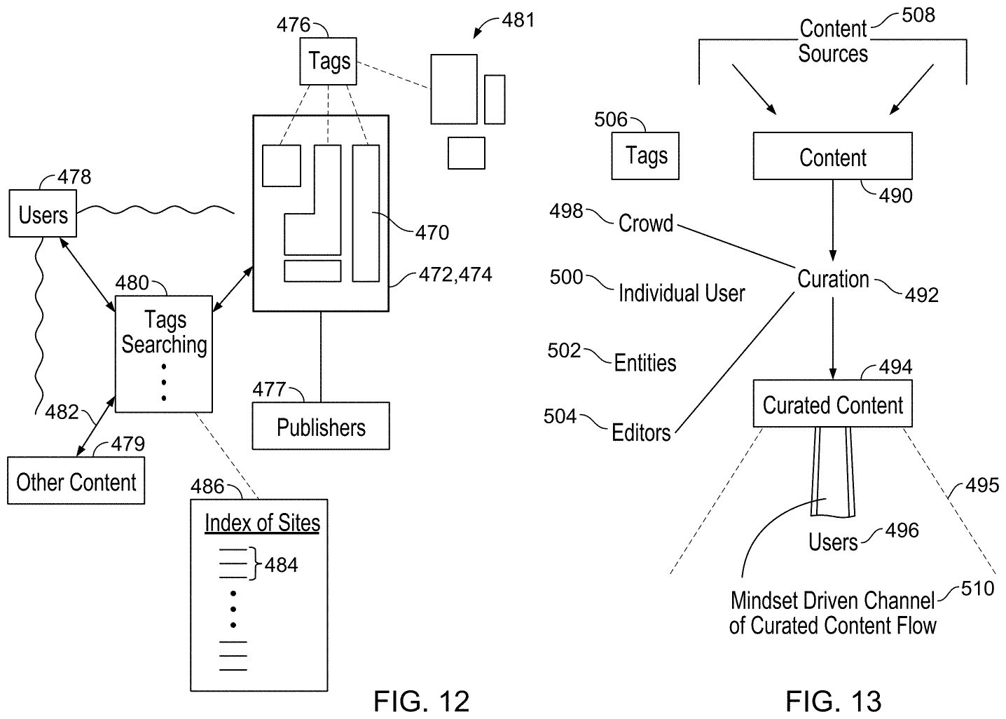

FIG. 12 is a block diagram of tag functions.

FIG. 13 is a block diagram of content curation.

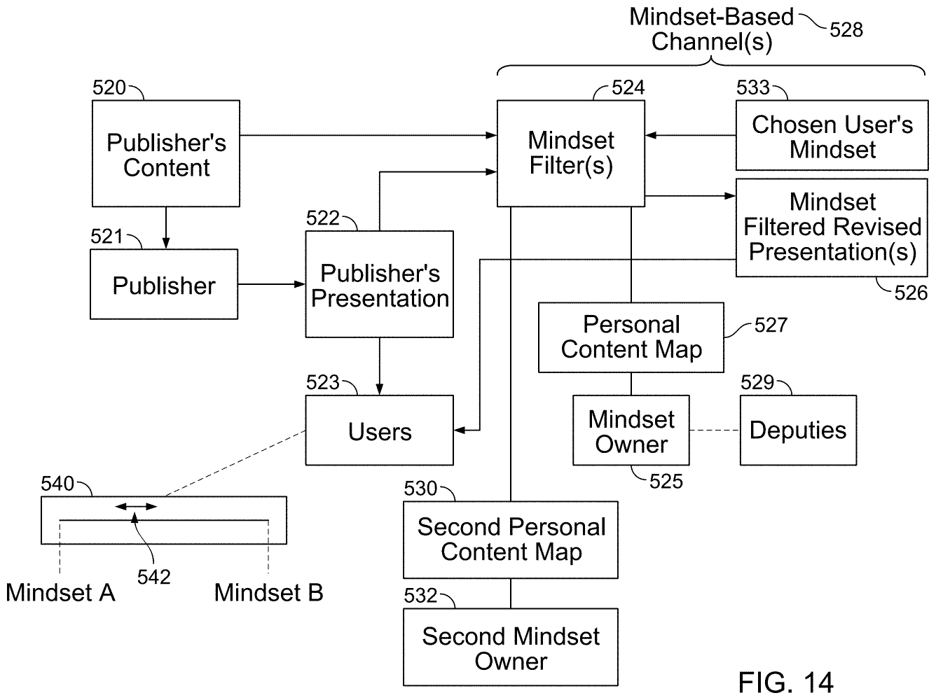

FIG. 14 of the block diagram of publication channels.

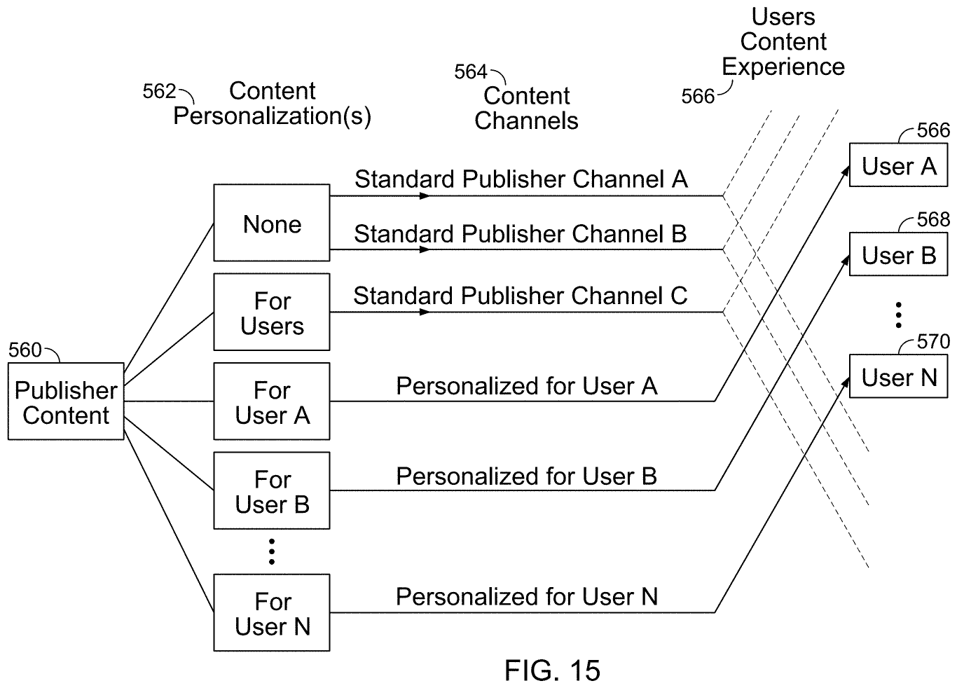

FIG. 15 is a block diagram of publication functions.

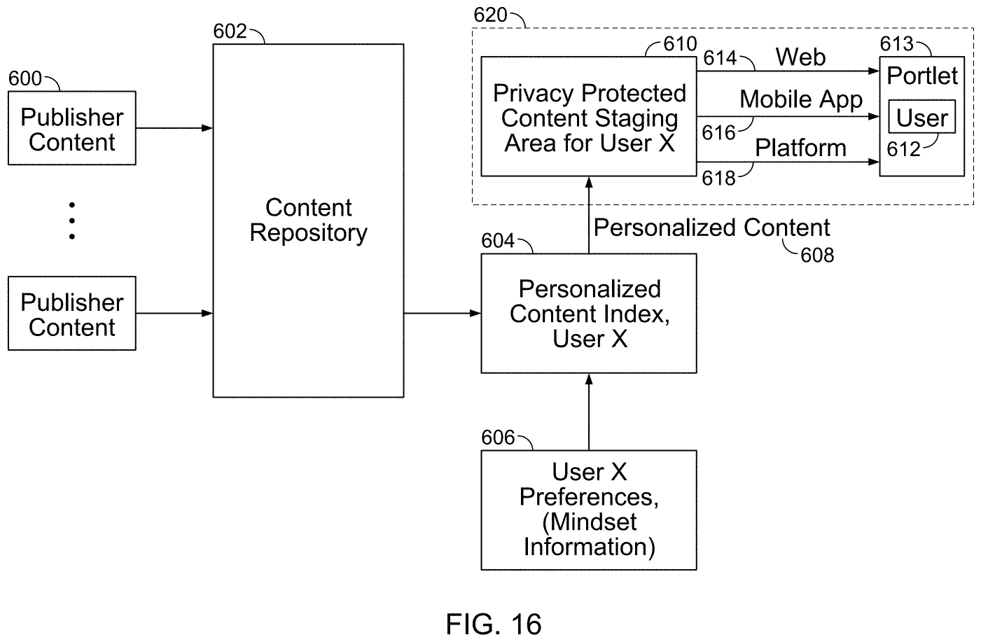

FIG. 16 is a block diagram of personalized content delivery.

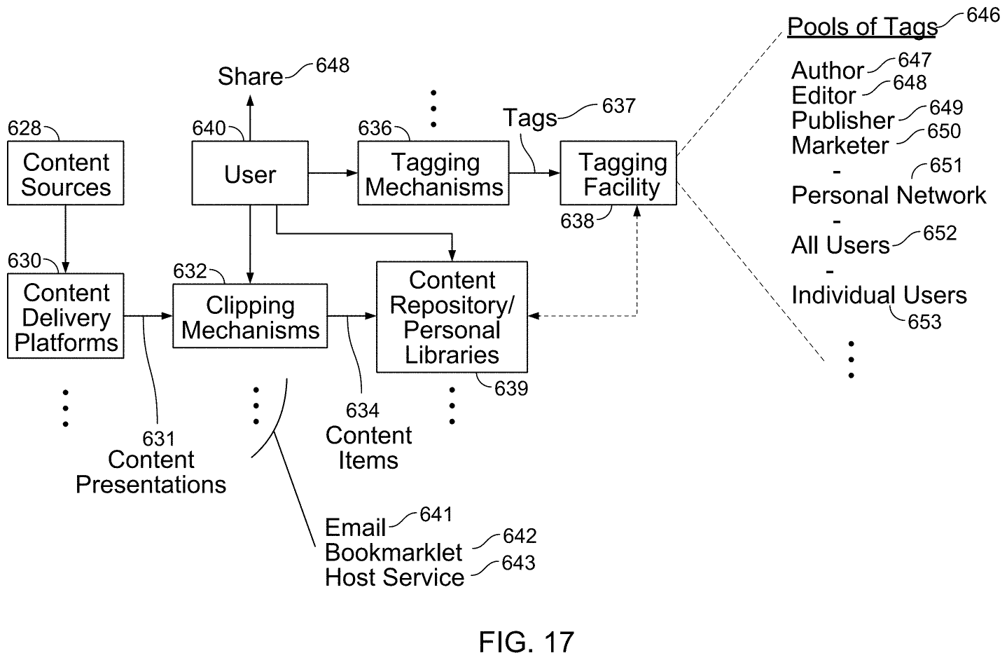

FIG. 17 is a block diagram of clipping and tagging.

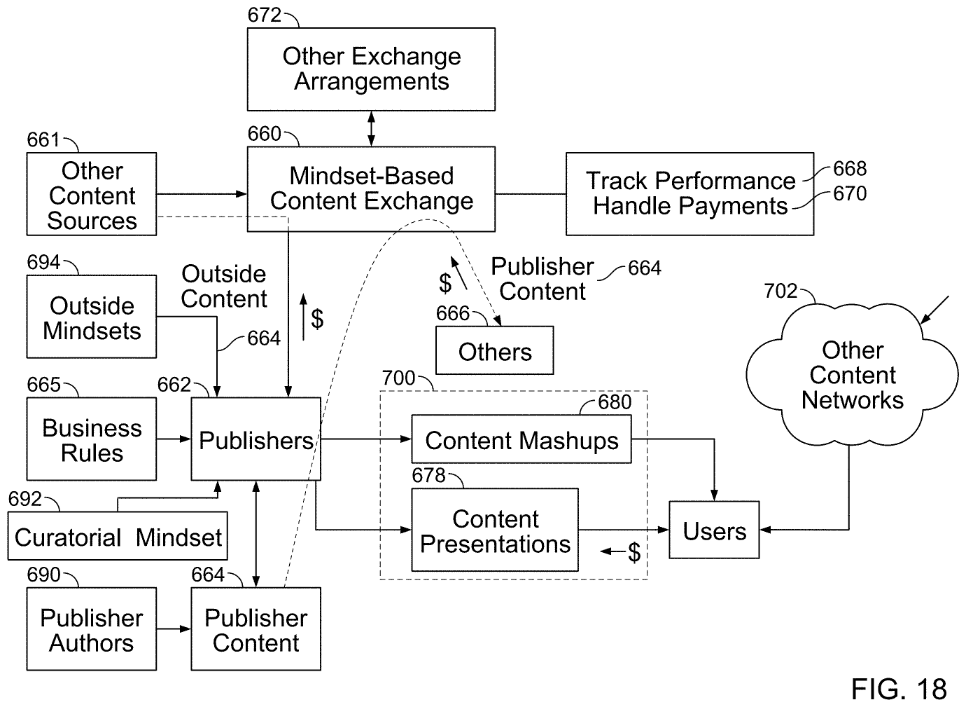

FIG. 18 of the block diagram of publication functions.

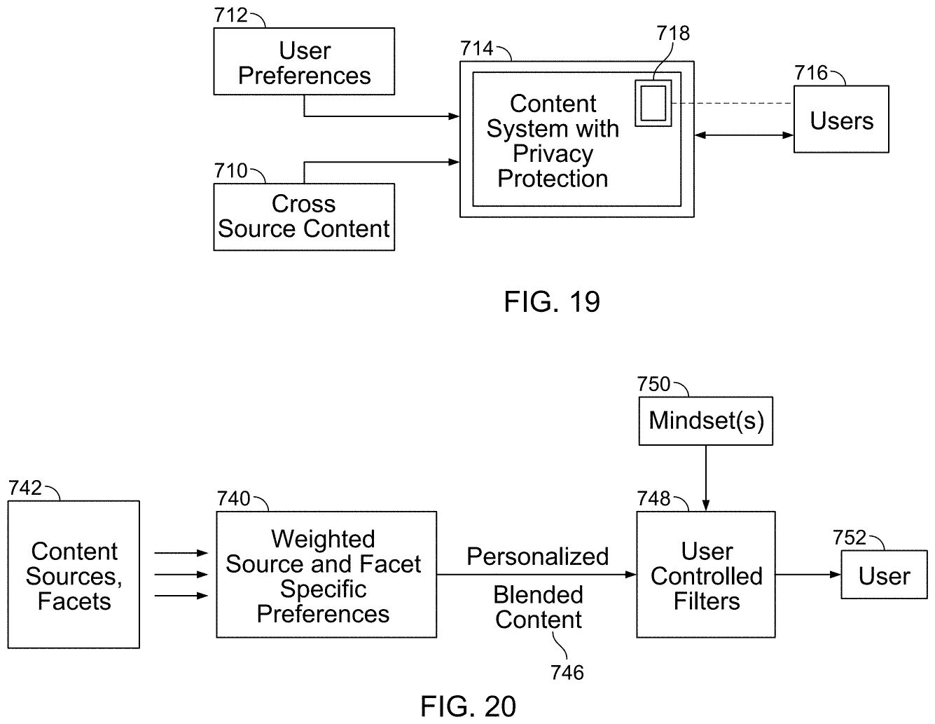

FIG. 19 is a block diagram of the contents of a content system.

FIG. 20 is a block diagram of blending and filtering content.

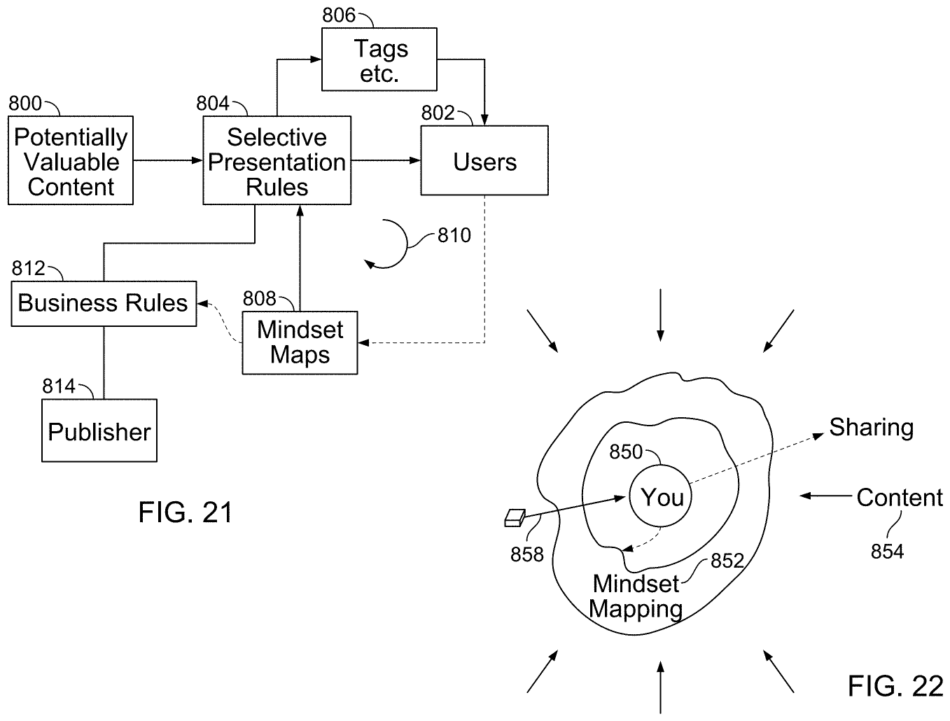

FIG. 21 is a block diagram of the use of presentation rules.

FIG. 22 is a schematic diagram of mindset mapping.

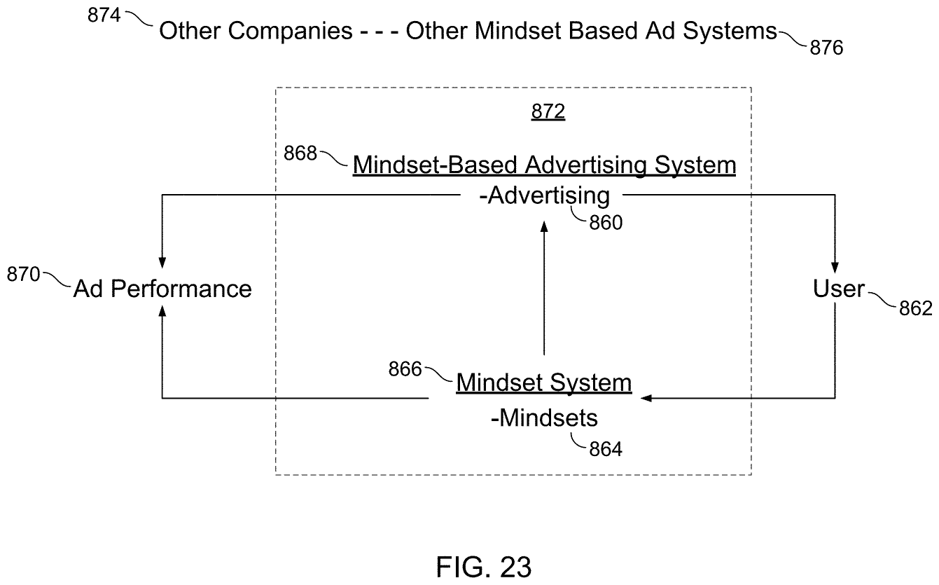

FIG. 23 is a block diagram of an advertising system.

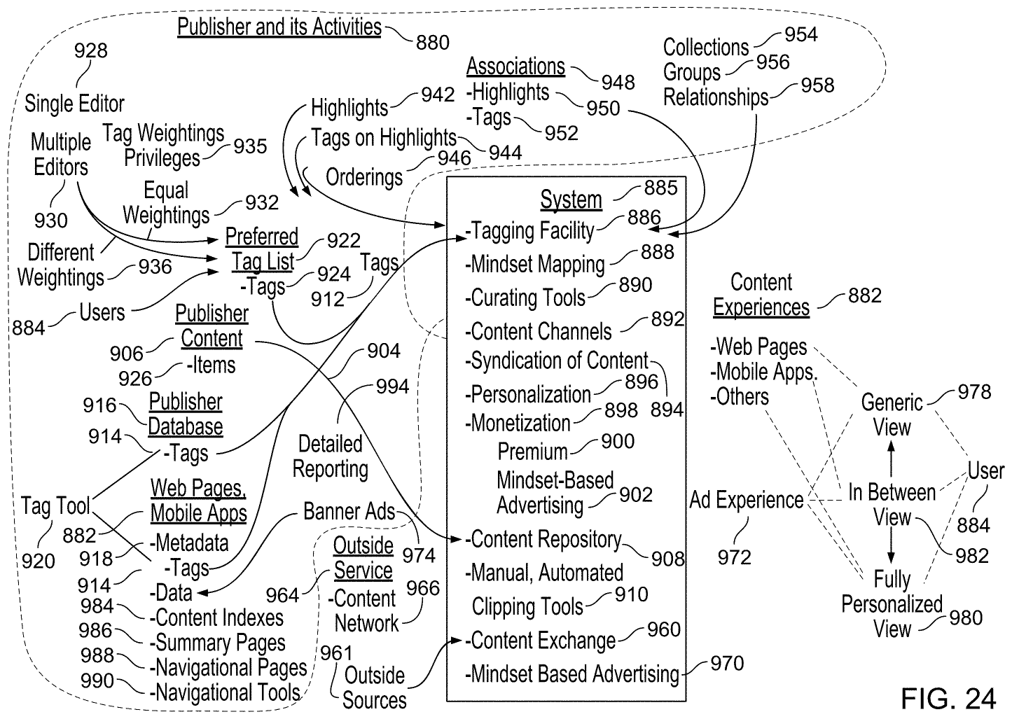

FIG. 24 is a block diagram of the tagging, clipping, publication, and sharing system.

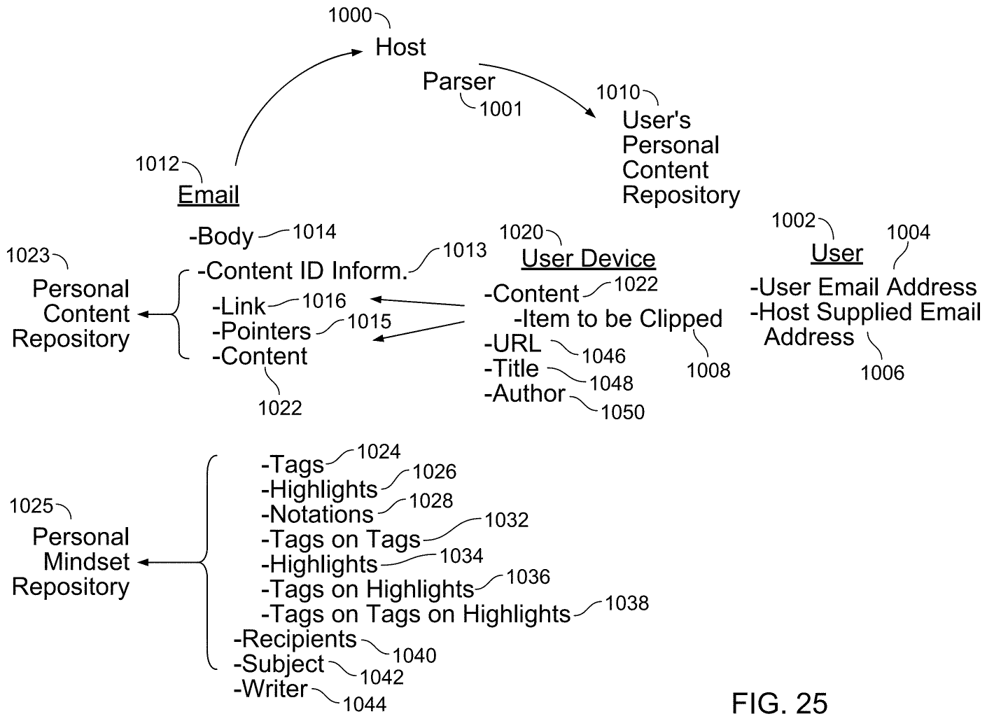

FIG. 25 is a schematic diagram of e-mail tagging.

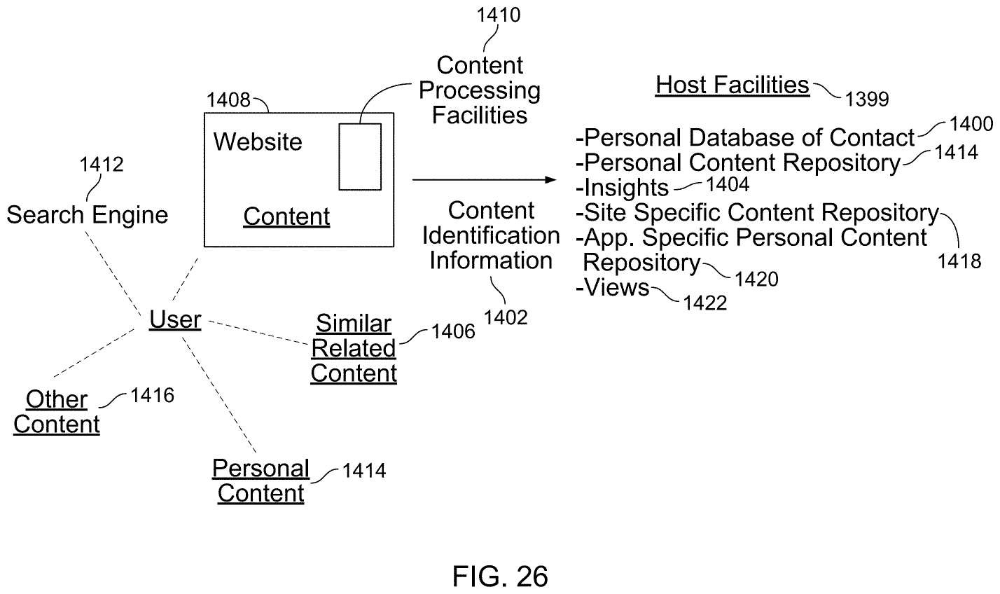

FIG. 26 is a block diagram of using content.

27 is a schematic diagram of a black box service.

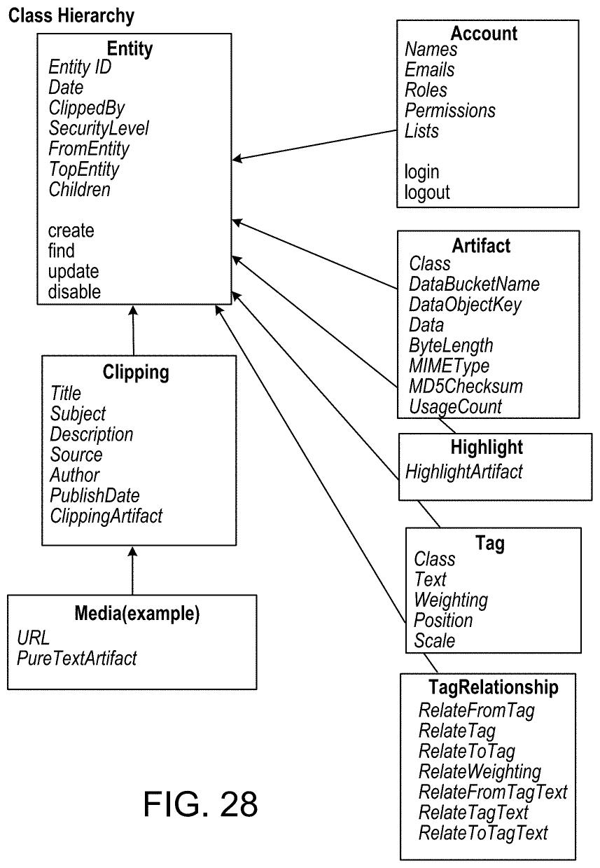

FIG. 28 is a schematic diagram of tag functions.

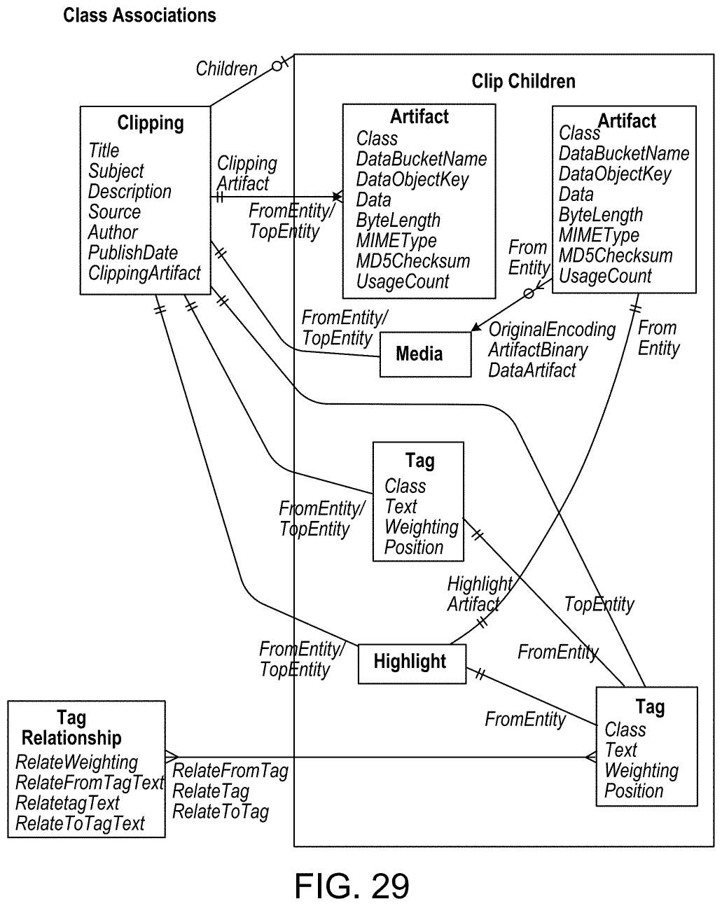

FIG. 29 is an overview of the content use system.

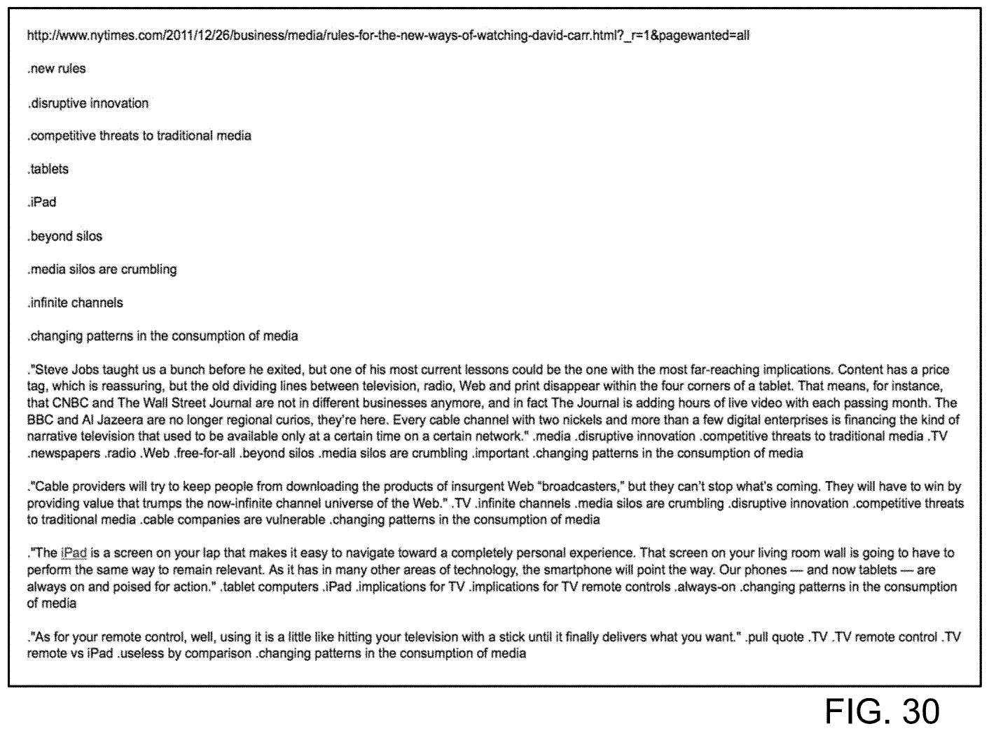

FIG. 30 is a marked up e-mail.

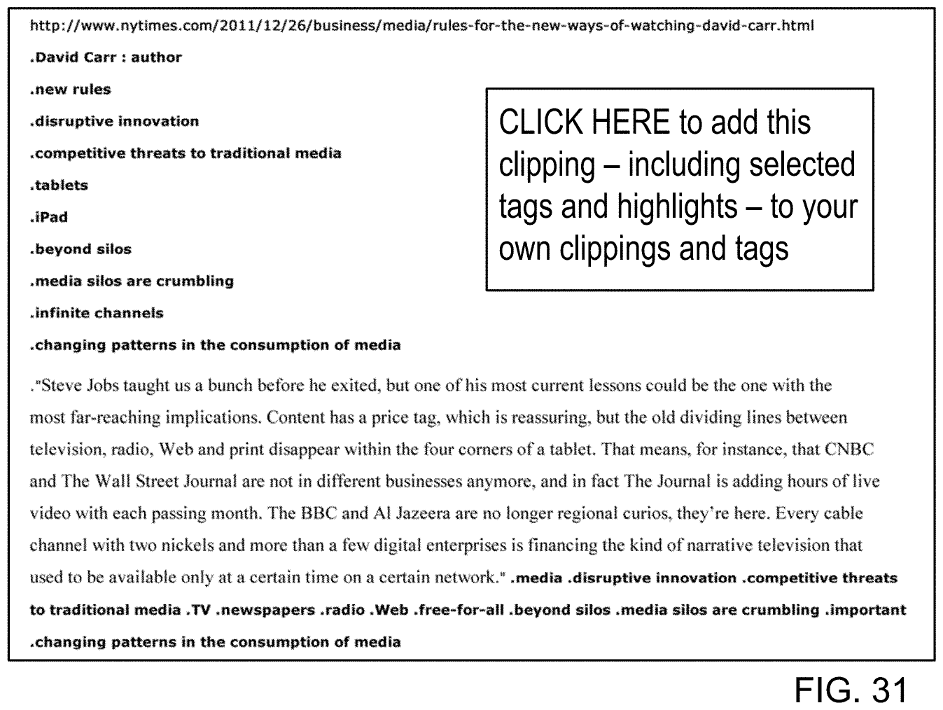

FIG. 31 is a reformatted copy of a mark-up e-mail.

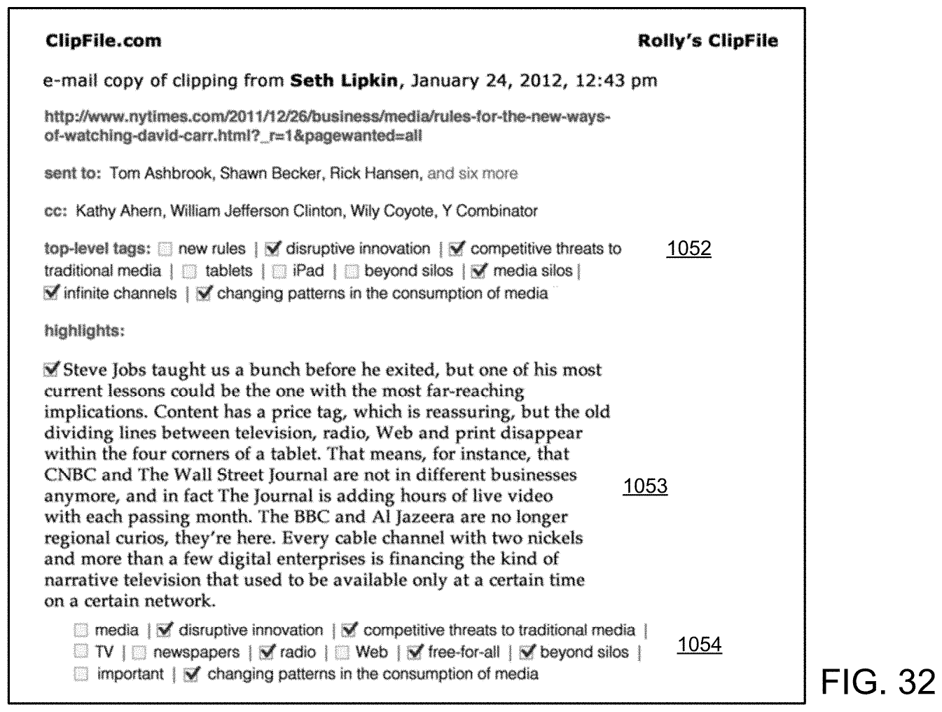

FIG. 32 is an interface for selecting shared tags and highlights and tags on highlights.

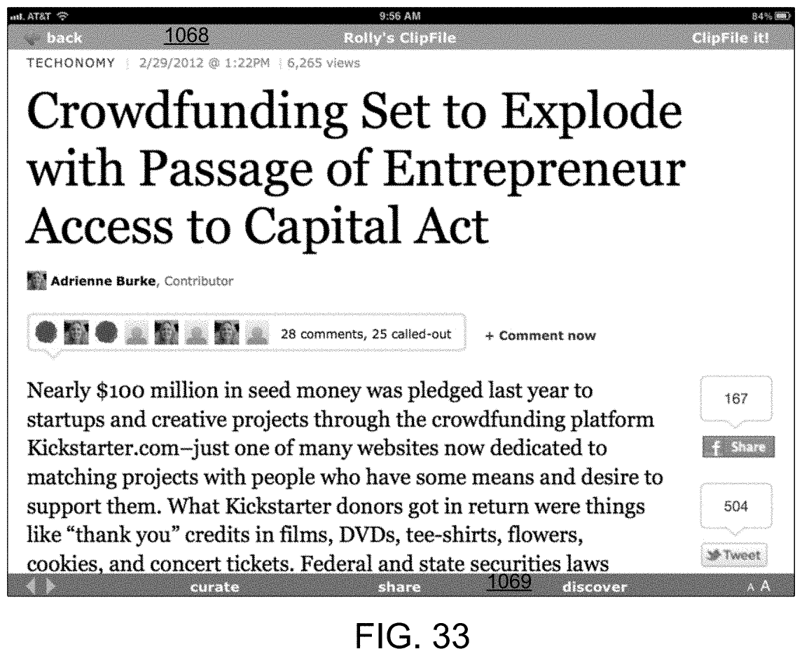

FIGS. 33 through 44 are screen shots.

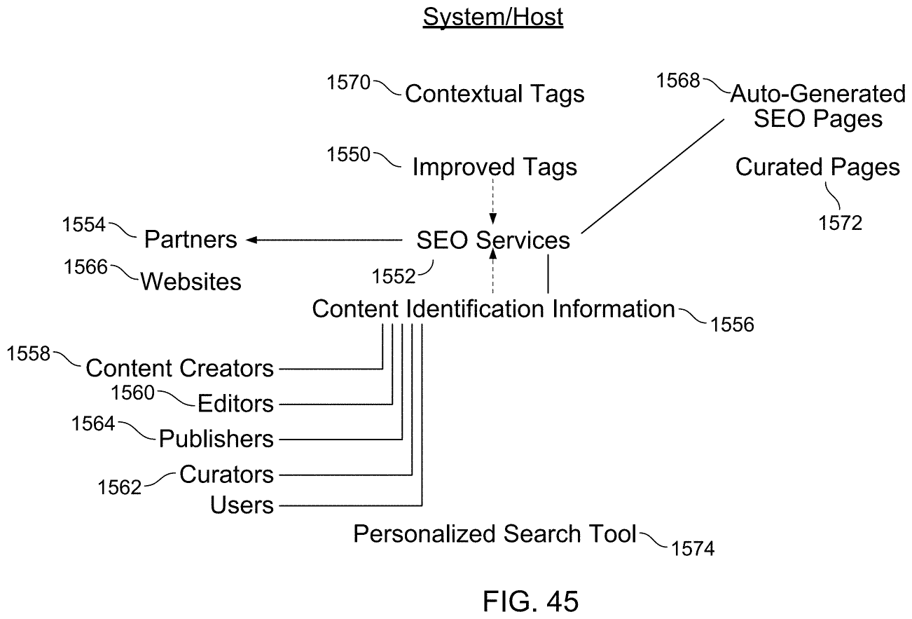

FIG. 45 is a schematic diagram of SEO services.

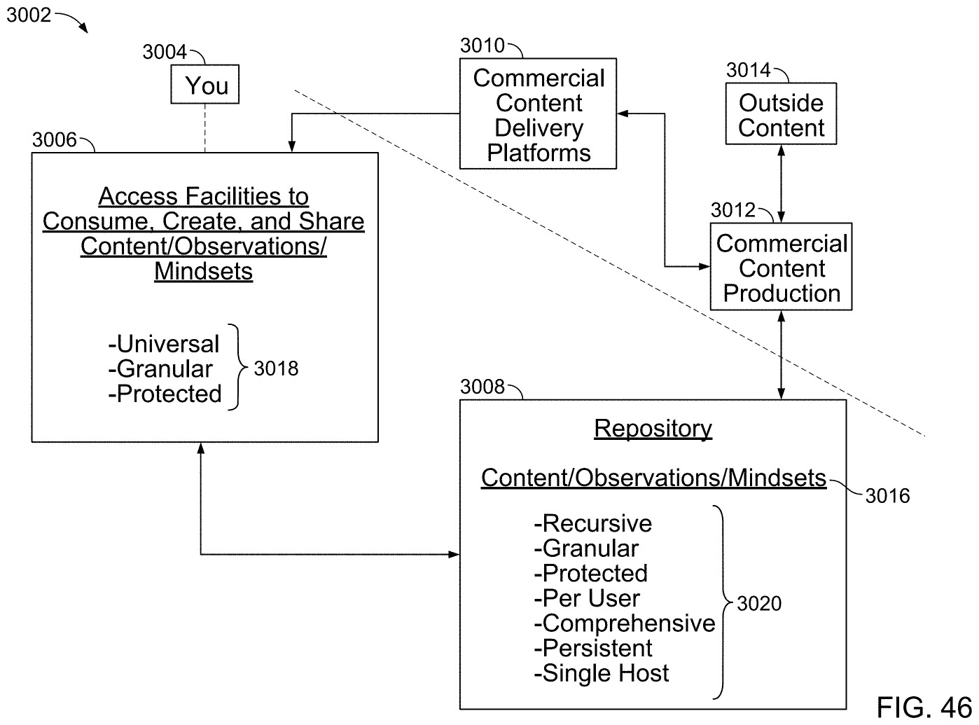

FIG. 46 a high level block diagram overview.

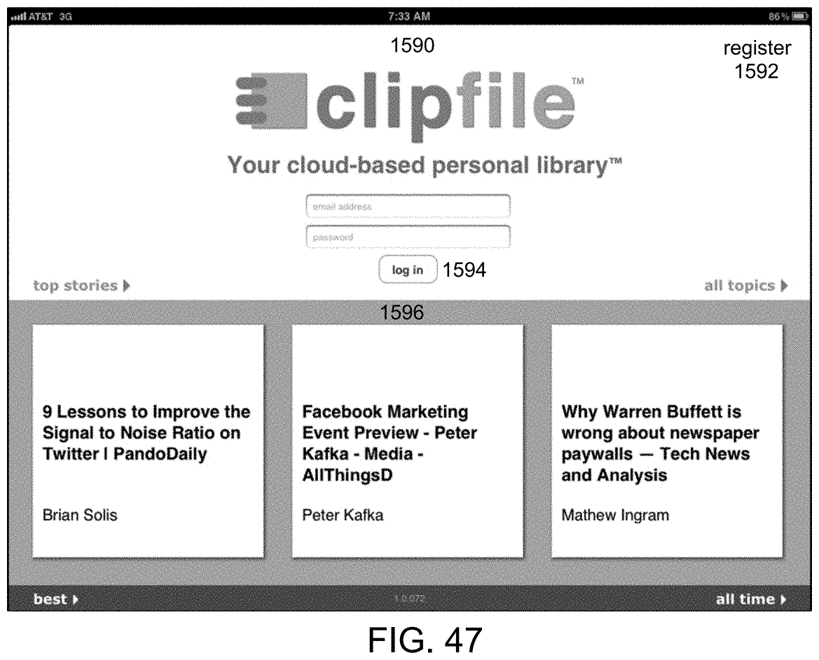

FIGS. 47 through 69 are screen shots.

Phrased in one way and as illustrated in FIG. 2, our ideas (described in greater detail below), among others, are that if we (a) make it easy for you 12 to find, clip, identify, and save 35 (among other activities) pieces 36 of available content 32 that interest you, (b) give you tools 37 to define, organize, update, review, analyze, and act on your recursive observations about and relationships among the items of content (and characteristics of those relationships) 34, (c) guarantee to protect your privacy 38 with respect to those and other activities, and (d) let you share 39 your stuff with others 41 in a privacy-protected way, you will (e) end up with a remarkable body of information (the content, the relationships, and your observations) 33, one that explicitly and implicitly represents your mindsets 22 about the world. The resulting body of information will have enormous value to you and—in combination with strict privacy protections (without which you might choose not to participate)—may be of considerable value to publishers and other content owners, as well as to advertisers 43. It promises to make content interoperable, to bridge information silos, and to make possible new forms of content networks—and networks of networks—that enhance economic results, monetize copyrights, and protect user privacy.

Our mindset-driven approach has the potential to transform (1) personalization, (2) privacy protection, (3) content discovery, (4) self-directed learning, (5) tagging, (6) sharing, (7) curation of content, (8) navigation of content options, (9) paid and unpaid syndication of content, (10) distributed personalization of content across Web sites and mobile applications, (11) contextual content discovery and filtering, and (12) the format, targeting, and timing of privacy-protected personalized advertising, whether Web-based, mobile, or in conventional media and physical settings.

We propose a radical new way for users to create, capture, find, save, organize, share, protect, and otherwise work with content (we sometimes apply the simple phrase “use content” to encompass all of these activities and others of users with respect to digital content). Our approach will put you in charge, enabling you to organize and use the content the way you want to without having to rely on or be frustrated by the tools that now lie between you and the content.

The digital content or, more simply, content that our notion addresses includes every possible kind of information that can be created, found, saved, captured, sorted, organized, shared, and protected electronically. The content can be anywhere. Although our ideas may apply to more conventional real world things, such as furniture or paintings or cars, we will—in our description here—focus on digital content.

The content we are discussing is potentially the entire global corpus of content in the world, including all that will exist in the future. Content is not limited to what is delivered through websites or mobile applications, although that content and those content delivery platforms are an important part of it.

Content can be text, numbers, images, video, and audio, to name a few, and be of any category and have any purpose. Although users often consume items of content in their complete original form, such as full webpages, articles, blog posts, scholarly papers, videos, images, songs, and catalogs, the content we are discussing can also be much more finely grained. For example, in the case of text, it could be a paragraph, a sentence, a phrase, or even a word or part of a word. We sometimes call each of these grains an item of content 20, 36. The complete original forms of content are also referred to as content items.

Users (for example, the you in FIG. 1) can include individuals, groups of any size and complexity, and companies, governments, and other entities of every kind. Users can have a wide variety of roles with respect to content including as observers, creators, authors, editors, curators, publishers, advertisers, syndicators, network operators, channel operators, content marketers, and as owners of content, among others. Users can also be gatekeepers controlling access to repositories of content and tags or observations about the content (which we discuss later) for use by others.

### Mindsets

Our concepts are mindset driven. By nature, every user (individual, group, or entity) carries internal frameworks or viewpoints (each a mindset 22, FIG. 1) that govern the way she thinks about herself and the world (including its content) and the way she organizes concepts and experiences. For convenience, we have shown one of your mindsets 22 as part of an inner you 18.

A mindset is complex and dynamic; it responds to changes in physiology and experiences and is a result of learning and thinking. Without presuming to understand how the mind works, we can imagine that the mind is able to create, store, and retrieve concepts, interconnect the concepts in a complex fabric based on the character and strengths of the relationships among them, and explore and alter the concepts and the relationships. The mind processes incoming information about the world in light of these concepts and relationships and adjusts the concepts and relationships accordingly.

Back in the day, when the bulk of your understanding about the world came through your senses 26 in response to real world things and events 24, there was no intermediate medium (other than a modest amount of written and printed materials) for a user to track and work with the concepts or define relationships of each of his mindsets to his real world experiences. His mindsets did that job directly. The connections between his mindsets and the real world were direct and unfiltered.

It was the best of times and the worst of times. Not much stood between him and the information to which he was exposed. But his access to information was severely limited.

Times have changed. Today, a large part of a person's information about that world comes indirectly 28 from reading, watching, or experiencing content. Content stands squarely between the world and a person's mindsets. A user's ability to maneuver in the world depends on being able to use content effectively. Yet the rapid growth of content and the absence of good tools or a universal organizing principle for using it promises to aggravate the degree of and discomfort implied by the disconnection between users' mindsets and the content.

A mindset-content disconnect can lead to frustration, even disaster, whereas a strong connection can produce efficiency, happiness, and success. The disconnection represents failure (if good tools for using content are not developed) or a golden opportunity (if they are).

It is worth noting that mindsets can be associated with individuals, but also with groups and entities, and in some cases need not be associated directly with any individual, group, or entity.

### Mindsets and Learning

As shown in FIG. 3, one focus of what we describe here is on using mindsets 50, mindset patterns 51, and mindset matching 52 to help users find, order, organize, annotate, create, structure, and share (in other words to use) content that's right for them, and to thereby accelerate their own uniquely personal process of self-directed learning.

Although our use of the word mindset will become clear from our discussion, by mindset we generally do not mean a “mind set in concrete.” In her research, and in her book—Mindset: The New Psychology of Success—Stanford Professor Carol S. Dweck described two kinds of mindset: “fixed mindsets” and “growth mindsets.” Our use of the term mindset is aligned more closely with growth mindsets.

The system we propose is designed, among other goals, to help users learn and grow and to do so efficiently and in a personal way. You can't learn quickly if you don't have access to the right information in the right form at the right time. Each of us needs better ways to find information that matches our own needs, interests, talents, life purpose, and moment-to-moment intentions.

Brain research shows that to learn something new we must—quite literally—change our minds. Our approach to mindsets is, among other things, about self-discovery and self-directed learning, not about inflexibility.

In some learning modes that we contemplate, our system will help each user assume responsibility for doing her own “homework” and for making up her own mind (that is, developing her own mindsets). We seek to give users access to—and control over the use and management of—content in a way that will help them to gain perspective and consider opposing views, as they develop their mindsets. Sometimes the most helpful information is, at first blush, contrary to one's existing mindset or to common beliefs or to a theory and may be inconvenient to one's use of content and to the development of one's mindset. Yet, finding a single data point that decisively refutes a theory can be far more efficient than sorting through millions of data points that support it.

### Mindsets are Contextual

Mindsets are contextual 53 and kaleidoscopic. Infinitely nuanced, they shift continually over time. Even people who appear to have “fixed mindsets” change their minds incessantly, at least with respect to some things.

In your view 14 (FIG. 1) of content, the content is always perceived in relation to the frame that surrounds it. Contextual frames 21 through which you view content may include people, circumstances, the information source, topics, topics within topics, the tasks at hand, the amount of time available to engage them, and others, and combinations of any two or more of these.

Mindsets change in response to people with whom you are interacting. Do you like or dislike them? Do you trust them or distrust them? Was your last conversation with them positive or negative? Are you excited to see them, or does an unresolved conflict weigh on you?

Given that conversations, even between two people, are unpredictable and path dependent, the introduction of a third collaborator can lead to considerable sharpening or loss of focus. Our mindsets are different in interactions with one person than in interactions with another, and still different with any group.

Mindsets shift based on changes in external factors. They shift in response to your physical setting, to new or surprising information, to changes in the weather. Do you find a particular external shift to be welcome, neutral, irritating, or disastrous?

Your mindset changes in response to the source of the information, and to your perception of its value and trustworthiness as a content source. Although the New York Times, The Wall Street Journal, and the Huffington Post all focus on news, an individual user's contextual frame of reference or context for interacting with the content (we sometimes use the terms context and frame of reference interchangeably) from these sources may be surprisingly different from one to the next. This might be true even if all three news providers were to publish an otherwise identical article. The context provided by the source shifts the user's perception of the content, the importance she attaches to it, the meaning she derives from it, and the conclusions she may reach. Such source-based contextual shifts are different for different users, and their impact may range from tiny to tectonic.

Mindsets shift with topic, and with topics within a topic. Politics, business, sports are all forms of competition. Nevertheless, you may love business and sports and hate politics, or love politics and business, but hate sports. Or you may say you hate competition, and nonetheless love politics (even though some consider politics to be the equivalent of war without guns).

Love or hate (which are aspects of mindsets) can extend through layers and layers of detail. I love the politician's personality but hate his policies. I think the CEO's new product strategy is brilliant but hate that it's likely to force me to reorganize my team. I love the Red Sox and hate the Yankees, but if the Red Sox are already out of the running, I may favor the Yankees in the World Series because I dislike the other team even more.

To the extent that these levels of affections for people or groups or topics (or any other potential locus of interest and attention) might be managed and acted upon using personalization techniques, the methods for personalization used by search engines, social networks, social bookmarking services, and others are not equipped to handle such layers of contextual nuance. They do not even attempt it.

### Mindset Patterns

Mindsets are not just about the people we engage, the physical or virtual settings we experience, the topics or projects that sustain our focus, or the amount of time we have available for the activity at hand. They are also expressions or embodiments of persistent underlying clusters of attributes, values, and beliefs, which is to say of mindset patterns 23, 51. These mindset patterns can span mindsets of a given user, and can span mindsets of multiple users or of the entire body of users.

Words and other kinds of content are perceived through personal, social, and organizational filters. It has been said that we see what we believe, rather than the other way around, and a growing body of research supports this notion. Beliefs apply to each of us as individuals, as well as to groups with which we affiliate or compete. We speak of “corporate mindset” in referring to the shared beliefs of some or all of the constituents of any sort of organization or group.

Another word sometimes used to describe these sorts of clusters of attributes, values, and beliefs is “identity.” We use the phrase “identity politics,” but we might just as well refer to “mindset politics.”

Mindset identities (we sometimes use the phrase mindset identities interchangeably with the phrase mindset patterns) are extraordinarily diverse. In terms of politics alone, self-descriptions include progressive, liberal democrat, classical liberal, libertarian, economic conservative, conservative, populist conservative, and populist, to name just a few.

People also sometimes describe types or patterns of mindsets of a person using the word “persona.” Most of us take on dramatically different “personas” in different circumstances. Business executive. Soccer mom. Caretaker to aging parents.

Personality is yet another type of mindset (or cluster of mindset patterns). Some of what we mean by personality is learned behavior. But an important part comes from our “nature,” which is to say our inborn temperament. Temperaments are not random. As any parent knows, siblings come out of the womb with entirely different personalities, and such traits are often enduring not transient. Thus, genetically, and in terms of underlying brain structure, chemistry and other factors, people's mindsets and their mindset patterns may exhibit clusters or patterns of attributes, and we have many terms to refer to such clusters or patterns.

The same is true with respect to our accumulated layers of education and work experience and the patterns of mindsets that may attend to them. Strauss and Howe have shown how generational patterns may affect perception, affiliation, and behavior (Generations). These layers—along with the influence of our parents, siblings, friends, teachers, mentors, and enemies or rivals—combine to form a set of underlying assumptions, biases, and habits that affect our perception, including our perception of content, so strongly as to call into question the veracity of our eyewitness accounts and the firmness, in general, of what we consider to be “facts.” As a consequence, in our system we often treat content not as the content itself but as contextual observation or opinion about the content. In the schematic view of FIG. 1, we say that a person's view 14 of content 10 is filtered by contextual frames 21.

If one were to judge them as too complex, one might simply ignore these mindset patterns (and layers of patterns) in considering how to provide tools for filtering and managing and otherwise using content. However, we believe that by deepening our understanding of the underlying structure of temperament, belief, habit, and affiliation—even if only a bit more clearly—it is possible to unlock significant improvements to the structure, organization, and use of content, and to methods of learning and collaboration based on content.

### Growth, Change, and Development of Mindsets

What is most scarce for people and businesses today is not bandwidth or processor power or storage. It's not even a technology. It's our time and attention. And our ability to find the content that's right for us at just the right moment. Conversely, for publishers it's about respecting our time and attention by helping us find what we need, when we need it.

To address this scarcity of time and attention, consumers, publishers, and advertisers require a new approach to content that better reflects individual preferences. A new approach to content that is tuned to match each user's unique mindsets at any given moment.

While the Internet and the World Wide Web have given us almost miraculous access to surging volumes of data—through search engines, from our friends on social networks, and from other sources—in many respects these existing structures for organizing information impede (and in some cases are designed to impede) our ability to have open, receptive mindsets. While superficially personalized, the content we encounter is—in a deeper sense—out of touch with our contextual, dynamically-changing needs and patterns of thought.

An increasing flood of content and a structure for content that fails to keep up with (and in some ways exacerbates) this deluge leaves us feeling overwhelmed. This is true in part because current methods often organize content in silos, lack common standards, or fail to allow content from multiple sources to interoperate. Whenever we feel flooded—whenever in engineering terms the signal-to-noise ratio is too low—we tend to think reflexively. We switch to habit and creativity goes out the window. We're in a rush to get through more content than we can productively use, or even process, and our perception narrows. We become efficiency minded, and there's less time for invention or innovation. Fixed thinking (a fixed mindset) wins out.

Excessive or unwanted information (for example, from content) can overload our mental circuits. It often kicks into gear our reflexive, tribal behavior. In this mode, we may stop listening or begin to operate on autopilot. Our mindsets may become less open and receptive. We may choose content that reinforces what we already think we know, slowing or even reversing the learning process. That is, when our mindsets are fixed, we are often doomed to repeat the same patterns and mistakes. When we are at our best and most creative, our mindsets are open to change and development 54. We sometimes refer to this situation as open mindsets. We are receptive to new information in the content to which we are exposed and in particular to the information that is most in tune with our purpose in life and our natural talents, (as well as with our more immediate goals and tasks at hand). Our capacity to achieve open mindsets can make it more likely that we will absorb and act on new information constructively. It can improve both personal outcomes, such as fulfillment and happiness, and professional ones, such as innovation and collaboration.

### Mindsets and Meaning

At today's content banquet, we are starving even though the table is set with cornucopian riches. The Internet makes the world's content much more accessible. But accessibility is not enough. Too much information (we sometimes use the word information interchangeably with the word content) is gluttony. And eating sugary information treats served by our friends, while entertaining, isn't necessarily a satisfactory meal. The content that today's tools help us consume, leave us feeling long on volume and short on meaning.

Don't get us wrong. Search engines and social networks are wonderful. Search engines help you find a needle in the haystack. Social networks help you connect and reconnect.

But search engines have limits. You may find yourself saying, “I'll know it when I see it,” which means that you can't yet describe what you want accurately and completely using words that come to mind. So how do you know what to type into the search box? And, once you get a set of search results, you must leave the search engine and visit a Web page to see the content. If your search is successful, and this page contains something you find helpful, it is difficult to sustain your search and use the information on that Web page—or within a mobile app—as a steppingstone to further useful information.

To find the content you want, you must instead return to the search engine. The process is akin to hub-and-spoke airline flights. However conceptually close your second search destination is to the first, you can only get there by returning—again and again—to the search engine hub. Out and back. Out and back. It's annoying, and it limits your ability to discover the content you want and need.

Social networks are imperfect, too. They are as their name says: social. And social interaction—while essential to our health and well-being—is not the sum total of who we are and what we seek. In a perfect world, much about our lives is kept private, sometimes intensely so. Indeed, a growing number of Web users bridle against a perceived pattern of intrusion on their privacy by social media hosts.

The part of your mindsets that may be most important isn't necessarily social. It's not about your tribal or group affiliations. It's about the essential you (what we call, in FIG. 1, the inner you). There is more to life than the modern equivalent of conversations in the public square or with your neighbor across the back fence.

The something more to life is often about meaning 55. When you strip things back to what's essential—perhaps even to the level of life or death—man's search for meaning trumps everything else (Frankl). Providing a meaning-based framework for content (along with personal context) is an important aspect of our unique approach to mapping and applying mindsets to content. Mindsets provide a framework for making the use of content productive as we search for meaning in our lives.

To be successful, any approach to mindsets must incorporate life passions not just interests. What's your reason for being? What's your purpose?

Through the system that we describe here, we seek among other things to bring to the surface questions about passion and purpose. Questions about personal desires and the thirst for knowledge.

And in a more mundane sense, we seek to offer you tools for managing and using content in ways that will help you discover, articulate, and track your goals and your personal growth. What did you want to accomplish, and what have you? What have you learned? What's the most important idea or theory or opinion you previously held dear, but for which new information and insight led you to change your mind?

At present, we have abundant access to information (through search engines) and to what our friends are doing and thinking (through social networks). But we lack unifying tools to help us connect this trove of information with our own mindsets, our own path of self-directed learning, our own goals and aspirations, our own pursuit of knowledge, wisdom, and truth.

Today's information structures (the structures for organizing content, creating it, and making it available) are a blessing and a curse. None of us would want to give up our ability to use search engines and social networks. But these services are two-edged swords. One dark side of our access to the world's information is the burden of excess, of clutter. One counterproductive facet of our tight connection to the daily musings of hundreds of “friends” is a growing focus on what's superficial, trivial, or unimportant.

This may seem innocuous, and often times it is. But every choice has consequences. Every shift in our attention takes attention away from something else. In the rush to social connection, we lose a bit of our personal space. Our capacity for introspection and self-knowledge is diminished, however slightly. In the rush to share and to trumpet our views in public, (or at least to broadcast them to all of our friends), we compromise our own privacy.

Social networks cheer on over-sharing as if it were good etiquette. We forget to respect our friends' precious time, and they return the favor.

Both trends—excess information and excessive sociability—suck up attention and crowd out our ability to identify and focus on the things that are most important in our lives. They increase the volume of communication and number of people with whom we are engaged. The need to sort through an excessive volume of information often leads us to rush. And because there is very little on the surface to distinguish between what's valuable and what's not, we often miss things that are important.

By exposing us to so much and to so many, these two trends may diminish our capacity to communicate effectively and to form deeper human connections. Despite considerable strengths, neither search engines nor social networks do what is needed and sufficient to help us discover and nurture what's best for us.

By adopting an approach that is more nuanced and personal (and transparent and within an individual user's control) we propose a system that helps users rise above the limitations of search engines and social networks in their use and management of content. We seek to enhance each individual user's capacity to learn and grow.

### Expressing Observations (Tagging)

A core notion that drives our ideas is that the more accurately a user's organization of (and implicitly her view into) content 55 can be aligned 58 with her mindsets, the better.

This ideal mindset-content alignment is not achieved by currently available tools: email systems, databases, computer desktops, file systems, Web portals, search engines, social networks, real time networks, bookmarks, social bookmarks, simple clipping applications, taste-based social networks, serendipitous content discovery systems, interest graphs, mobile applications, cloud-based file storage services, and others.

Take search engines. They select results for user searches based on unpublished statistical and algorithmic inferences about what content is expected to align with a person's interests. Yet the user's search request is only a spur-of-the-moment, simplistic expression of a tiny piece of her mindsets. While powerful and useful in a wide variety of circumstances, a search query is only a simple string of text, one that typically lacks context and nuance. Search engine efforts to personalize search results (for example by tracking all of the Web pages you visit) can improve somewhat the match between your mindsets and the content you discover and use. But search engines make inferences based on insufficient information. Statistical guesses, however educated, do not represent a full understanding of who you are and what you want.

As mentioned previously, once you have the search results (or the links to them), you are tethered to the search engine page if you want to explore additional results one after another. Your experience is neither unified nor well-integrated. It is not tuned to match your mindsets. It is not tuned to the context in which you are doing the searching. Indeed, while searching may match a simple list of your expressed or inferred interests, it is not tuned to match your mindsets, as we consider them, even in the most general sense.

In our concept (FIG. 4), a dynamic, universal, self-driven, user-controlled and user-created, organically-buildable observation framework 46 enables the capturing of richly expressed observations and recursively expressed observations about observations 52, 53, 54 about content items 40, 42, 44. We sometimes use the word recursive to refer to the relationships between any item of content and any observation that relate to one another. The recursion can be at any number of levels, one, two, three, four, and so on. When we refer to recursive observations we include content items, direct observations on content items, and observations on observations at all levels. The framework and the array of observations that it represents provides a new, easier to use, effective, adaptable, personalized viewpoint 48 into the content, a viewpoint that can be closely aligned with the user's mindsets 22.

We sometimes refer to observations as tags and vice versa, although our use of the word tags goes beyond the more conventional sense in which the word is often used. Observations as we describe them provide a much richer facility for representing relationships among items of content and other observations than simple tags alone. Similarly, we sometimes refer to the observations framework as a tagging facility though we do not mean tagging facility to be constrained to the more conventional and limited sense.

In some implementations of our concept, the user's observations about content items and the richly expressed associations among them (which we sometimes call observations on observations) are expressed as what we may call associational tags 72 (FIG. 3) maintained in a tag repository 70 that is part of the framework. (We sometimes refer to the framework as a tag facility.) The tag facility can be managed and exposed to users by a host 60, which is itself a user (but of a special kind). We sometimes refer to associational tags as observations or as observations on observations or as recursive observations or simply as tags. Observations can sometimes be thought of as tags, and observations on observations (tags on tags) can associate observations with other observations and with items of content.

In some implementations, each associational tag in the tag repository includes a tag 74 and can have a rich set of tag attributes 76 that characterize the tag and include associations 78 and association attributes 80 that characterize the tag, its associations with other tags, and associations with other information, such as context. Content pointers 82 to content items 102 to which the tag refers (for example addresses in electronic or digital storage of places where the content items can be found) may also part of the associational tag. If the associational tag is a direct observation on an item of content, the tag will contain such a content pointer. An associational tag that is an observation on another tag (observation) need not itself contain a content pointer.

Items of content are themselves observations, for example, because at a minimum they represent an act of capturing a copy of an item of content and storing it in a content repository 100 as part of the system that we are describing. And conversely, tags or observations at any level are items of content in the broad sense in which we view content. One possible way to think about how things may be divided for discussion between items of content 102 and tags or observations 74 is this: Items of content 102 are copied or derived from sources that can be thought of as sources of content (say a magazine publisher), while observations can be thought of as associated with consumers of content. Of course, this separation is artificial in that items of content can come from sources who are also consumers of content, and observations may be associated with sources of content.

Personal copies 103 of the items of content may be stored permanently and persistently in personal content repositories 109 and are not generally shared (except in certain cases). Each stored copy of an item of content, whether stored in the personal content repositories or otherwise in the broader content repository in our system is stored in a way that treats it as a snapshot of content at the time it is clipped (identified for storage and stored). This snapshot may include a screen grab, top to bottom, of the Web page or other content at the moment the item is clipped, as well as copies of the text, images, HTML, CSS, and other content and content presentation elements. That way, if the content later changes or disappears, the user still has access to the content that was selected for storage.

The broader content repository 100 of the system thus includes or encompasses or spans all of the personal content repositories of users. Personal content repositories can be associated with individuals, groups of individuals, and entities, and with both sources (producers) and consumers of content items.

A tag can be thought of as a token that represents a user's observation about one or more content items or about one or more other observations. Words, phrases, sentences, passages, images, audio files, videos, snapshots of content, and anything else and in any possible form that can represent a user's observation about a content item can be a tag, including the item of content itself, when identified and marked for storage. Because the volume of content items is huge and growing, and users' observations on them are varied, the number of associational tags (recursive observations) can be large for each user and enormous when considered across a large body of users.

An association can be, for example, a relationship between a tag and one or more other tags, such as a relationship that represents a connection 84 among concepts 86, 87, for example, a connection in a user's mindset (say, “in that photograph, Barack Obama looks like a typical politician” or, “Barack Obama sure looks presidential.”) In those instances, the tags are proxies for the observations, and the associations of the associational tags are proxies for the connections. Mindset connections are not simply connections; they are connections that have variable characteristics such as their type and their strength and their context. The association attributes are proxies for the mindset connections. In other words, in some implementations, the associational tags of the tag repository can be built by a user as a dynamic model or models of one or more of her mindsets. In that way, the associational tags provide a powerful viewpoint into the content and an effective way to align the user's mindsets with the content. Although up to this point, we have discussed the tag repository as if it were the creation and property of a single user, the notion of a tag facility can apply across many or even all users in powerful ways that we describe later.

The dynamic model of a user's mindset 118 can be thought of as a multi-dimensional associational mesh 120 of nodes 122 each representing one of the tags or recursive observations and fibers 124 representing the connections or relationships among tags or observations. The mesh extends between and among the points, each fiber representing one of the associations. In this analogy, the thickness, location, orientation, resilience, and other characteristics of the fibers square with respective association attributes of the associational tags in the tag repository. When the user adds or updates an associational tag, the fibers of the mesh are augmented and altered accordingly 126, which causes the contour and bunching of nodes in the mesh to shift.

This mesh is then a representation of a model 130 of the user's mindset. Careful user manipulation of associational tags (recursive observations) can drive the model to align as closely as desired to the user's internal mindset. The user (and in some examples other users) has as much control as she wants over how the associational tags form the mesh.

The alignment of the mesh with the mindset can be as perfect as the user's time, energy, and interest in doing the organizational work permits. In this analogy, there could be such a mesh associated with each of a user's dynamically developing mindsets, or a single mesh could represent multiple mindsets. The same analogy could also be used to describe one or more meshes that represent collective mindsets of groups of users or of all users of the system.

The tag repository keeps track of content items that the user has saved. The fact that the user has saved an item of content is an observation of the user about that item of content. The tag facility need not and typically would not also keep track of items that are merely viewed, although the mere viewing may be considered an observation and tracking those is possible and may be useful in some cases.

Portions of the tag facility can “belong” to a particular user in the sense that information that identifies the user as being associated with certain tags may be accessible only to that user. The user can protect that personal information from disclosure to others in ways that we describe later. Tags that belong to a user can be thought of as residing in a personal tag repository 131. On the other hand, anonymous information about the tags of groups of users and statistical information about them may be made available to other users, as discussed later.

Automatically maintaining a stable store of the content and history of content that the user has saved and tagged provides a powerful and rich platform for developing and preserving mindsets, one that is superior to search engines, social networks, interest graphs, and the like, which do not automatically store copies of content items or tags or the mindset models that the tag meshes represent. The platform becomes that much richer and more powerful in that it can also store and save observations on observations (associational tags) that enhance the detail and accuracy with which the tags represent user mindsets. The tag facility may also track as attributes of tags the context (and contextual potentialities) in which the content was viewed and saved (and possibly tagged) by the user.

Context may be inferred by the system based on the user's online activities and stored as tags on the content. Features of context thus represent observations. The user may also choose and create tags and relationships that make context, as they see it, explicit. Thus, the system can surface the applicable context or contexts, and may allow users to disambiguate, weight, or otherwise clarify which contexts are most appropriate in their view of content.

Even if the user adds no explicit tags, the matching (or alignment) between mindsets and content continues to improve with use of content by a user. Tags and observations are inferred automatically by the system (for example, by recording a date and time when the user clipped an item, or by recording the context in which the clipping occurred). Rich associations can be inferred by matching inferred tags against tags in the tag repository, matching inferred tags against the user's tags (if available), and matching tags against public or anonymously-visible tags from other users (to name just a few possibilities).

In contrast to current tools, the user is permitted and encouraged to see what has been inferred by the system in the form of such automatically generated tags and matching. And she can eliminate the inference, or change it, whenever and wherever she finds it lacking.

(Note that the system never creates a user's explicit tags for her. She creates and owns her own tags. The inferred tags exist as a supplement to her tags and are designed to help, at her option, with searching and with matching the tag set to her mindsets.)

An example of the modeling relationship between the tag meshes and the mindsets is illustrated at the bottom of FIG. 5. The modeling represents an alignment that can develop over time. Typically, the mindsets-content alignment (matching) is controlled personally and directly by the user (including with respect to inferences drawn by the system), not by a third party with motivations that may be mismatched with the user's.

A tag engine 92 can manage the body of associational tags in the repository and provide a programming interface 93 through which a wide variety of tag applications 90 can alter them, analyze them, read them, expose them to users, enable users to manipulate them, and in other ways use them for the benefit of users. The tag applications can include user applications that provide a view port into the tag repository to empower users to explore and use the body of tags, to create and alter tags and tag attributes, and to improve the alignment of their tags with their mindsets.

(As an aside, associating simple tags with digital content is a well-known technique. In typical simple tagging systems, a user can label whole items of content with tags that have been prearranged or added by the user. The goal is to label content for later retrieval. A user who tags items as “Brooklyn” because she is interested in Brooklyn can later retrieve the items easily by searching for and using the tag rather than having to retrace the searching or other steps that she originally used to find them. These systems are rudimentary in their ability to represent a user's mindsets.

In our system, every item of content that has been viewed or saved by any user has associated tags (both inferred and explicit). Every section, highlight, or grain of content of an item of content can have associated tags. Individual users may add whatever tags they wish to include, without limit, whenever they wish to add them. They may add tags to any item of content, and to any highlight, and to any tag, and to any tag on any tag recursively (without end).

In our system, tags generally are not conceived of as facts (although objectively a tag may be factually accurate). To create flexibility and avoid the formation of information silos, associational tags are structured as associations, as described above. A tag captures observations by an identified user at a specific time about an item of content. In many cases, the tags are words or phrases that represent the user's observations about items of content.

As described in more detail later, the body of tags in the tag repository and selected parts of that body can be temporarily organized according to a wide variety of organizational principles to allow them to be displayed to the user, manipulated by the user, supplemented by the user, and reorganized by the user as needed.

Building on this powerful, scalable tag structure, users are offered access—anywhere and everywhere they go—to a pool of potential tags for use in expressing their observations about items of content that they are experiencing. This pool can be large, and may be viewed from many perspectives. The tags may be ones created by the author of the item of content; tags created by you for similar content (where similarity may be inferred by the system according to its own standards or according to standards that you define); tags associated by you (or by the system or by others) with a particular topic; the “best” tags—using many potential definitions of best; tags added by people who shared the content with you—in aggregate or individually; tags from all users; associated tags inferred by algorithm; words and recognized phrases in the item's text; and others; and combinations of any two or more of these. These tags and portions of them can be exposed to users through user interfaces for use in selecting and creating tags for items of content and pieces of items of content.

As part of the rich variety of tag management features that can be exposed to a user through a user application, a user may view and select tag synonyms. He may view tags that “mean the same thing” as a selected tag (which is not exactly the same thing as being a synonym). He may view tags that, in the host's structure of data are strongly associated (by weighting) with a selected tag (in general, or within any defined context). And he may view tags that he or other users have previously associated strongly with the selected tag, or that other users, or a particular user, or types of user have previously associated strongly with the selected tag. Information about the strength of association and a wide variety of other qualities of the associations can be captured as association attributes (which are themselves tags) in the associational tags (which are a kind of tag). Technically speaking, within our system even items of content may be considered a kind of tag.

The variety of user applications that can take advantage of the tag engine and the tag repository is virtually endless. User applications (described in more detail later) can provide interactive tools that overlay electronically displayed content, for example, a clipping and tagging management widget overlaid on a news story on a webpage. These tools, among other things, enable users to clip all of, (or fine-grained parts of) whole pieces of content and to associate tags with the clipped materials (by typing in tags or by selecting tags from one of many views of potential tags). The user applications help a user to save, organize, and use content and associational tags or observations recursively (and context information) in ways that align as closely as the user wishes with his mindsets.

As suggested earlier, for the host 60 to support the tag facility, the host may also operate a comprehensive content repository 100 of content items 102 that is designed to make content more, not less, coherent. Each of the content items can include attribution information 104 that identifies, for example, the author or the publisher or the distributor or some combination of them. For content items that are clips (items) of less than all of original complete pieces of content, the attribution otherwise could be lost in the process of importing it. Attribution may be important to users of the content.

A wide variety of other bibliographic information 106 can also be stored. Context information 108 about the relationship of the content item to the full source content (“this item is the fourteenth paragraph of the source content”) can also be useful. In some implementations, a party unrelated to the host could operate the tag facility or the content facility 101, or both, or participate as a partner in the operation of the tag facility or the content facility, or both, under an appropriate arrangement among the host, the other party, and the users, that assures the effective operation of the system (and the protection of both user privacy and copyrights).

The nature, structure, and identity of content and items of it are often ambiguous. Authors create multiple versions of the same article or book, for example. Identical or highly similar content is sometimes syndicated to multiple Web sites and apps, as well as for other uses. The same content (or slightly modified versions of it) may be associated with dozens, hundreds, or even thousands of Web page URLs (or other pointers to resource locations). Our system is designed to handle this and to permit visible articulation—and clear disambiguation—of duplicate or otherwise similar content. Our system is designed to track (for example in bibliographic information 106) and manage and make use of the URLs or other pointers to identical or similar content, even if there are many duplicate or competing versions.

This approach offers new opportunities to warn users about the similarity of their content to others' content, as well as to help users understand how and where their content is repeated and how loosely or precisely. Our system will help writers, students, professors, and others avoid potential accidental use or repetition of copyrighted content. It will make it easy to check for such similar or plagiarized content. (Even if similarity is not technically plagiarism, it could be viewed as such.) Our system will help users avoid the perception that they have copied content without the right to do so. This approach will also offer benefits to copyright holders. The system will permit study and analysis of the frequency and nature of replication of content in online sources for a wide variety of purposes.

In some examples, the content facility 101 includes the content repository 100 and a content engine 110 to manage and use the content items in the content repository for the benefit of users. A programming interface 112 for content applications 114 makes this possible. The content applications can enable users to clip, store, and retrieve content items from the repository, among a wide variety of other features. The content engine can test content items to confirm their accuracy compared to the source content.

So far, we have emphasized the lone user. She can make whatever use she wants of the tools of the tag facility and the content facility, from the most banal or absurd to the most sophisticated. The tag repository can be organized by user and can wall off each user's associational tags from every other user's tags and provide an array of privacy mechanisms from strict to mild. Within this controlled context, the tag facility can enable controlled sharing of associational tags (observations) among users. Users will be able to share their sets of associational tags (and by implication information about the mesh that represents their mindsets) with other users, while controlling the privacy of the information.

The tag facility and the content facility allow and empower users to study and tune their mindsets and, through sharing, the mindsets of other users (friends, say) to the extent voluntarily shared with them. As a service, the host (or possibly a third party, with permission) can create for each user a personal content map 138 (and expose it to the user through one of the user apps, for example) that helps the user see inferred mindsets and mindset patterns. The user can also explicitly create and weight and order her preferences, as expressed in her preference profile, which is a summary of views into her mindsets. She can organize her preferences in general, and also within any specific context or combination of contexts. The tag facility thus enables a user to enhance her self-understanding and understanding of others. Behavior, emotions, and actions can and will change.

The tag facility also can foster privacy-protected aggregation (perhaps in a segregated part of the tag repository) and exposure to the world publicly of a body of aggregated associational tags (observations and recursive observations) derived from those generated by a large base of users (provided that such use respects the privacy protections selected by individual participants). The tag engine can analyze user-generated associational tags, alter and merge them, and apply sensible organizational principles to generate groups of aggregated associational tags that are universal (in applying to the entire user base) or that relate to subgroups of the whole body of users. These aggregations can then be used by anyone as representations of the mindsets and mindset patterns of the entire user body or subgroups of it.

Referring to FIG. 6, although we have used mostly individuals 300 and other consumers 302 of services offered from the content facility and the tag facility as our examples of users in the discussion to this point, the users of the tag facility can include many kinds of users that fall into several categories: producers of content; owners of content, providers of content; observers of content; consumers of content, and hosts of the system. A given user can belong to any number of the types of users and any number of the categories of types of users.

Among the types of users are creators 304, which may include authors and editors, for example. We lump these broadly into a category of producers of content. Users also include, in the category of providers of content, aggregators 306, publishers 308, distributors 310, and marketers 312 of content. We sometimes use the term publisher interchangeably with provider and intend both terms to include broadly, for example, any individual, group, or entity for which the distribution, or sale of content or of services that derive value from content is a part of their purpose, business model, or activity, among other things.

Although creators of content today have access only to rudimentary electronic information about the mindsets of users, the tag facility will be a rich publicly accessible resource for aggregate information about mindsets, subject to privacy controls as mentioned. And a universal body of items of content will be accessible (assuming copyright permission) from the content repository to be selected (through the medium of the publicly available part of the tag facility), assembled, and used in other content.

Over time, the distinction between content producers, providers, owners 321, observers, and consumers will become even more blurred than it is today, as will the difference in the mind of the user between inbound and outbound, consumption and creation. Producers and providers and owners will be observers and consumers, and observers and consumers will be producers, providers, and owners.

Our system will help make this shift more manageable and helpful for everyone. Publishers and other content owners will act variously as users, creators, curators 320, and editors 322, and also as merchants 324 selling goods and services—including content—through or from our content facility, i.e., acting as a content exchange (whether directly or as affiliates or through other relationships). Users of any type may act as publishers, or as content creators, or as merchants, or as advertisers 326. That is, in our system any type of user may behave as any type of user.

In some potential implementations, one or more hosts 330 and groups 332 and entities 334 also will use and provide content and tag information as discussed earlier and below.

Execution of our concept will include new ways to—and new players who will—create and give access (to others) to fine-grained items of tagged content, or references to such content. Copyrights for all parties, which is to say for all types of user, will be better protected and more easily tracked.

A wide range of revenue generating business models can be built around the use and maintenance of the tag facility and the content facility.

The system is intended to be comprehensive in its breadth, depth, and reach, potentially and aspirationally encompassing-at some point in the future-every item of content in the world, and a complete set of tags representing the mindsets of every user everywhere and over time.

### Mindset-Driven Personal Preference Profiles

Instead of letting search engine algorithms, or social networks and your friends, or other conventional tools managed by others, guess about your content preferences and make inferences about how content that you view relates to your mindsets, our system lets you accumulate preferences passively and automatically based on the items you choose to clip, the highlights (observations and recursive observations) you choose to add, and the tags (observations and recursive observations) you choose to employ. We use the term content preferences broadly to include, for example, any indication by you (explicitly or inferred) of the importance or relative importance of items of content or types of items of content. In some examples, such content preferences are captured in the tag facility either explicitly by the user indicating that relative preference as an association attribute, or implicitly by the system.

The mere act by a user of clipping an item of content can be considered a tag in that it represents a user's observation about the item (“this interests me enough to clip it”). The act of attaching a tag to the item is also a tag and the act of attaching a given tag to many different items of content over a period of time can implicitly represent a content preference of the user for items of that type relative to items of another type that are infrequently tagged by the same user.

In addition to implicitly determined content preferences, our system lets you actively curate your preferences, by changing their weightings as reflected in tag attributes and their fine-grained relative ordering (for example, which is more important to you, politics or sports?). In the course of clipping items of content and managing tags related to content, the user will accumulate signals (explicit or implicit observations) about preferences. A variety of approaches are possible for permitting explicit insights to be expressed by users. The preference signals can be stored as tags or as attributes of the tag repository. We sometimes use the words “preference signals” interchangeably with the word observations; a preference signal is a kind of observation.

As shown in FIG. 7, preference signals or insights 350 on content items 352 that can be stored in tags 354 can include star ratings 356. In that approach, preference signals are represented and accumulated based on, for example, conventional five-star ratings of items of content and of content highlights (in terms of how interesting they are to the user). By highlights, we mean, for example, selections made by the user of portions of items of content that are of particular interest to him. Content highlights are a form of observation.

Preference signals can also be accumulated using a wide variety of other non-scaled and scaled ratings, which include sliders 358 that may range, for example, from minus 10 to positive 10, but which can be applied using any other potential numerical or other scale. Scaled ratings allow a user to express graduated or dualistic feelings 360 about an item of content. Examples include love vs. hate, important vs. trivial, agree vs. disagree. The user may be given access to both standardized scaled ratings and to various scaled rating choices (0 to 10, −10 to +10, 1 to 5, log scale, and any other numerical scale) or to any type of dualistic scaled rating she chooses to define. Scaled ratings may apply to full items of content or to items that are portions of complete items. Note that a scaled rating may be applied to any tag and may be either dualistic (as in love vs hate), or unidirectional as in not at all or totally (as applied to love, or hate, or any other tag, or tag on a tag).

In some cases, preference signals can be accumulated based on which items and portions of items and highlights (observations) 370 of items you choose to tag. And on how you add nuance (attributes) to these tags, for example, by tagging them, or by associating their tags with other tags or with other highlights or with other portions of items or with other items.

Preference signals can be accumulated based on which items, or portions of items, or highlights you choose to share and with whom you choose to share them 372.

As noted earlier, preference signals—and by extension preferences—can be accumulated implicitly (at any appropriate level of generality or granularity). The system is designed to keep track of all of your activities with content and tags and in any other respect with the system. It does this to help you and does not share your activities with anyone else without your permission (although in some cases anonymous aggregate information across users may be shared). Patterns of clipping and highlighting and sharing may lead the system to infer 374 things about you and your preferences and insights. Such inferences are made for your benefit in order to help you reflect on your own thinking and preferences. They are visible to you. They are controlled by you.

You may, at any time, transform these inferred preferences into explicit preferences. You may use our system to express your explicit preferences any time you want and in however much detail you want. Nothing is cast in stone, however. You can change your preferences at any time, or give shape and nuance to them. You can make the inferred insight even stronger, make it weaker, or eliminate it.

Say the system infers based on what you clip and tag and share that you are a Liberal Democrat. You can say explicitly how much you feel at home being described as a Liberal Democrat (on a scale of “not at all” to “totally,” or on any other host-defined or user-defined numerical scale and based on any standard or customized words associated with each integer on each scale). You can also indicate how much you identify with related political labels: Progressive, Social Democrat, Moderate Democrat.

You can be as unusual as you are. You can be a Progressive who favors a strong military, or a Conservative who is an Isolationist. You can be an “environmentalist” who supports “nuclear power” or a “free market radical” who opposes it.

In short, you don't need to be either one thing or another. You can be both a Democrat and a Libertarian, and in whatever measure you prefer. You can be the complex “both-and” person you are, not the cardboard cutout, stereotyped, simplistic, siloed, predictable, cliched, black or white, “either-or” person that many of today's approaches and information (and ad targeting) systems pigeon-hole you as. Doing what existing approaches require may force you, (at least in terms of how you choose to interact with their content), to be someone you don't even recognize.

Your expression of preferences may be general or contextual 351. That is, you may choose to confine the preferences you have expressed to the Web site, or contact, or time period, or any other context within which you expressed it. Or you may choose to elevate any of your preferences to a higher level, including to the top level in which you explicitly identify it as one of your strongest and most important general preferences. Context of your preferences can be captured as observations on observations or as association attributes of tags.

We seek to work with you on your own terms—however difficult or complex they may be—and to support your ability to have content revolve around you and your mindsets. What we are creating is much more than an interest graph. Among other things, we facilitate self-discovery, personal growth, and the pursuit of deeper, more inspired levels of meaning and creativity.

This curating of personal preferences is primarily for the benefit of individual users. That is our priority. We facilitate private, self-directed learning by each individual user. We allow Web sites, mobile apps, and other content to revolve around you without compromising any of your confidential information. We protect you from experiencing the sort of unwelcome surprises that a lack of privacy can create. (Privacy is especially important when you are unearthing, and expressing in some detail, deeply personal preferences and opinions, which is precisely what our system is designed to help you do.)

Our system is geared toward self-discovery, self-knowledge, and personal development. It is intended to help unleash human potential.

Our system is designed, in part, to support private development of the individual through mindset-based personalization of content. It is also true, paradoxically, that the patterns that emerge from this enterprise will help elevate the quality of external sharing, collaboration, and publishing, and will benefit friends, groups, organizations, society, and humanity in general in ways today's social networks cannot. Our system will help users achieve these public goods precisely because our philosophy and the design of our mindset-based system is rooted in respect for individual liberty, freedom of choice, and privacy.

### A Framework for Protecting User Privacy

We believe that protection of user privacy is not only the right and moral thing to do in our system, but that it is important to the success of a system that proposes to understand users and to tune Web, mobile, and other experiences to an individual user's authentic needs, desires, goals, purposes, and personal search for meaning. Privacy protection is important to effective mindset-driven personalization.

In our system, your mindsets as expressed through your clippings, your tags, your highlights, your sharing, your lists, your network, and your personal profile—whether inferred or explicit—remain private unless and until you explicitly choose, for example, to make some portion of them public, or to make some portion of them visible to one of your semi-public collaborative work groups, or to otherwise share them selectively with other users.

Here's why privacy is so important. Your inferred and explicit preferences may show—potentially in considerable detail—any of the following and much more: (a) your politics, including which candidates you have supported in the past and which ones you are leaning toward supporting right now, (b) your current health conditions and your lifetime health history, (c) the health conditions that affect or afflict others you care about or who are under your care, (d) your investment interests, including the stocks you own or track, (e) your research on business competitors and your ideas for gaining competitive advantage, and (f) what you think about other people—friends, family members, colleagues, former employees, professors, public figures, anyone in fact—and their ideas and actions.

At their worst, many of today's social and mobile Internet services are a rough equivalent of a person with Tourette's Syndrome. Everything that's thought is said, and everything that is said is said publicly, to boot. (And often recorded for posterity.)

In the real world, publicizing or sharing everything is often counterproductive. Is it wise to publicize or share all of the thoughts that rattle around in your head? Is it always a good idea to tell your best friend that she's been behaving like a brat, even if it's true? Or to tell your husband you think the guy waiting on your table is “really attractive?” Or to tell your conservative Republican friends how much you love Keith Olbermann? Some things are better left unsaid and unknown by others.

While thoughts are often wonderful things—and a boon to our own well-being, to our families, our friends, our communities, and even humanity—they can just as easily cause pain, conflict, or even calamity. There's a fine line between honesty and cruelty, and this line is constantly moving. The line is different for different people, and it's different in different circumstances.

A bias toward public expression is embodied in many of today's most popular information structures. We are encouraged to overshare and overdisclose. To say everything that's on our minds. And to use a public (or largely public) megaphone to say it.

Do we want everybody to know our personal business? Or to know everyone else's? If nothing else, exposure to infinite mounds of unfiltered information about everyone and everything seems remarkably inefficient. How in the world will we have time to do anything else?

If you comment on a Wall Post by one of your social networking site “friends,” then her friends can often see the comment you posted. This intentional privacy leak means that a social networking site isn't fully private (in the typically understood social sense of sharing only with your friends).

Sometimes this intentional cross-pollination across groups of friends, and friends of friends, is wonderful. It leads to serendipitous connection and re-connection with people outside your chosen network of “friends.” But it can also lead to costly unintended consequences.

Social networks offer considerable strengths, but they cast an equally considerable shadow (as all strengths do). Even for the most outgoing and extroverted among us, some content should remain private. Social network privacy protections are porous, and privacy is not fully within the control of individual users (at least not if you select the social network's default settings, as most users do).

Because porous privacy is a feature of social networks, not a bug, and because it's not going away any time soon, sometimes it's best to view sharing something on a social networking site as the real-world equivalent of making it public. Perhaps not completely public, but public enough that your privacy is hardly assured.

The problem here is not necessarily that intentional privacy leaks have been designed into the social networking site. It's that people don't understand the privacy implications of sharing within such social systems and hence of their actions. As a consequence, users frequently make public (or are made public by) items they didn't mean to share publicly.

Consider social networking site photos. If you're tagged in a photo, then your friends can see that photo, even if you didn't choose to post it. Perhaps it's a photo of you doing something indiscrete back when you were a teenager. Perhaps it's a photo that shows the location of your home wall safe or jewelry box or finest artwork. Sharing of this sort compromises privacy, and it does so in ways that are unintended and unexpected (by you, and by the friend who is doing the sharing). The sharing seems innocuous. But in the process you may potentially set the stage for personal embarrassment, or for a transfer of wealth to local criminals.

Economic incentives shape behavior, whether of individuals or of organizations. It's in a social networking site's interest to make less-than-discriminate sharing broadly available and to encourage most users to adopt it. Sharing may grow their traffic, their revenues, their profits, and their market valuation. But is this what's best for you, or for your friends and colleagues?

Current approaches to privacy don't scale. For example, as the number of photos on a social networking site grows, it becomes less and less possible to keep tabs on your level of personal exposure. You simply don't have enough time—let alone the inclination—to vet so many photos. That means you're not keeping track. You're not in control.

As shown in FIG. 8, in some implementations, every item 380 of content in our system is, by default, private 386. Every highlight is, by default, private. Every tag is, by default, private. Every observation and recursive observation 382 is, by default, private. Any information 384 that a user creates or is associated with the user is, by default, private. Building on this foundation of privacy, we give users granular control over the privacy and visibility of every item of the content they clip or create.

In some implementations, the content items and observations themselves, or at least some of them, need not be private. Instead, it is the user's relationship to those items of content that is private, by default, and protection of privacy is completely under the user's control. For example, an observation that “George Bush was successful, not ineffective.” might be presented to the public, but the association of a particular user as the source of this observation might not.

Any level of privacy can be applied to any item of content, to any section of content, to any content highlight, or to any tag or tag on a tag on any of these. Users 388 have extraordinarily granular control 387 over privacy.

Our default (private, anonymously visible) keeps content and tags private, but gives access to a public pool of anonymous data that benefits all users. If no action is taken, items, highlights, and tags are all automatically marked as private, anonymously visible. A private, anonymously visible setting balances individual and community interests. Private, anonymously visible means private but with the information visible to others without being tied in any way to you.

At this default level, the individual user has confidence that her clippings, tags, observations, highlights, sharing, curated lists, preferences, and other activities (or fruits of activities), or her relationship to any of them, won't be learned by others or used against her and that she won't have to waste time and energy keeping track of whether or not she has been indiscreet or politically incorrect or has in any other way hurt her current—or future—personal or career prospects. And yet, users in general benefit from the social and informational and preference pattern data associated with her clipping, tagging, highlighting, sharing, and other engagement with the content. That is, users in general benefit from her thinking and her work, even though they cannot know that she is the source.

Thus, information kept in the system and controlled as to its disclosure to others can be divided between anonymous information 397 and information about the users' associations with the anonymous information 398. Controls can be provided that govern the privacy or availability to others of either or both of the anonymous information or the users' associations with the information.

In some implementations, the privacy controls in our system can include five levels: 1) super-private 293, 2) hidden 294, 3) private, anonymously visible 389; 4) semi-public 395, and 5) public 396. Others may also be included. Furthermore, many different names may be used to describe these various levels. In some examples, these different levels could be characterized as follows.

Private, anonymously visible: You clip and tag the content for your own use. Nobody knows that you've clipped or tagged it. But other users in general benefit from your choice to clip an item of content and from the work you put into creating tags (and highlights and other mark-ups) for it. This is true whether you tagged items for your own personal benefit (for example, to deepen your understanding or to facilitate later retrieval that's fast and easy), or to help others, or for any other reason. You, in turn, benefit from the efforts of other users, whether you know them or not. When you share an item or tag information that's marked private, and then you change the item or tag information, the people with whom you previously shared the item do not see changes you make after that point. Unless, that is, you explicitly choose to share them.

If you'd like an item and all of its highlights and tags (or any portion of them) to be even more private, you can mark the item—or a portion of the item—as hidden or super-private.

Hidden: Suppose you are clipping something and are happy having it show up in the top level of your personal repository of saved content and tags. However, you don't want it to be part of the crowd-created repository of content and tags from anonymous sources that may be viewed by others. For example, you're adding tags that suggest how one of your key competitors might fight back against your own company more effectively. You'd want to see this yourself, but you wouldn't want this competitor (or others) to see it, not even without personal attribution. Which is to say, you don't want users in general to see it, not even anonymously.

Super-private: Suppose you clip something that you don't want to be visible, not even within your password-protected repository of saved content and tags. Access to this content is protected by a second level password or any other means of authentication. You must use this password, or other authentication, to gain access to this deeper layer of more private content.

For example, your wife often sees the content you have saved and tagged, and you are planning a surprise birthday party for her. You keep this content super-private to ensure that no accidental discovery occurs and spoils the surprise.

The second level, super-private authentication can be a repeat of your top-level password (which can be the default setting), or it may be an entirely different password (creating greater security), or any other means—or multi-factor means—of authentication.

Semi-public: Our semi-public privacy setting allows users to form collaborative work groups. A workgroup can be created by a founder or by multiple founders. Any form of group governance is possible. One, or two, or any number of people in the group (or even outside it) may control inclusion in or expulsion from a group.

Changes to governance rights can be controlled any number of ways, including by the vote of one controlling member, or by the vote of any particular pre-defined or continually redefined group of members. The votes of different group members may have different weights. The intent is to mimic all the control structures by which groups and organizations are governed in the real world. Dictatorships, benevolent or otherwise. Boards of Directors. Democracies. Direct voting. Indirect voting.

Public: As the word says.

The names of our five levels of privacy may change over time. Furthermore, desirable patterns that involve combinations of settings may emerge. For example, a user may choose a default setting of private, anonymously visible for entire items clipped, but hidden for tags and highlights and for tags on highlights. The user could establish settings that would automatically treat items within selected categories of protection based on the content of the items, the context, observations, and a wide variety of other information.

To recap, our system is designed to protect user privacy. Users can do whatever they want, can do so in any combination, and can change their minds at any time (in general, or for a specific clipping or highlight or tag or tag on a tag, or for any other content). Different items of content can have different levels of privacy. One grain (or many grains) of content within a larger item of content that's otherwise public can have a different privacy setting. One grain (or many grains) of content within a larger item of content that's otherwise super-private can have a different privacy setting. This works in any combination across all of our levels of privacy.

### Sharing

We permit users to make their content and observations and other information available to other users. We sometimes refer to this as sharing, by which we mean very broadly, for example, any act that causes or permits content and observations or other information (such as mindsets associated with the content and observations) in the system that is associated with a user to be sent to, exposed to, or accessible to one or more other users. We sometimes refer to the other user as a recipient. The other user can be a consumer of content or a producer or provider of content, for example.

Our intent is to promote and encourage greater respect for any recipient's limited time and attention. In our view, all else being equal, content that's shared in a way that's considerate and personal is better than the alternative. When it comes to sharing we believe that less is often more. In some cases, when we use the term sharing we mean it in the general sense, for example, of a user intentionally or deliberately arranging for another user to have access to the shared material.

What you share, how you share it, and with whom you share it says something about you, your preferences, and your relationships. It says how much you care. Or suggests you don't.

Excessive sharing, like all unwanted information, is a form of pollution. Too much sharing suggests disrespect to the recipient. In the early days of e-mail, some people would carbon copy the entire office on everything. Sometimes that was a good thing, but sometimes not.

As the volume of online content grows, and as our digital networks expand, the barrage of information can become relentless and overwhelming. Something has to give.

Mark Zuckerberg has a rule of thumb about the sharing of content, which some called “Zuckerberg's Law.” This law holds that that amount of content that an average Facebook user shares per day with friends is doubling annually. If you have 100 Facebook friends (the median is 130), continued application of this law suggests that you'll received 500,000 shared items per day in 2022.

It's not that the existence of the content is bad. One can argue, as we do, in favor of a further expansion of the volume of content. We just believe that a different approach and different tools are required. As social sharing continues to explode, sharing that's thoughtful will gain attention as a more socially desirable behavior.

In our view, the world would be a better place if sharing with friends and colleagues were a bit less promiscuous. And if the content shared were structured to be more easily digestible. And if the person sharing took care to show why (and how, and what, and in what context, and with what caveats) the shared content (we sometimes refer to shared material including content, observations, and mindsets, for example, as simply shared content) was thought to be valuable to the recipient.

Thoughtful sharing encourages reciprocal behavior. It may take a little extra time of the user doing the sharing, but thoughtful sharing unleashes genuine benefits for the recipient and the sharer alike (we sometimes refer to the user who is sharing as the sharer). The recipient can more quickly decide if the information, as shared, is valuable to her. And she can let the sender know. Or she can further elaborate on the points raised, enhancing the quality of communication between the sender and the recipient.

The sender's actions set a standard for communication that the recipient may choose to emulate, in which case the sender benefits by receiving more useful, digestible information in return.

As shown in FIG. 9, in some implementations, an element of our content facility and tagging facility is to keep track of the senders and recipients of content 400. By sending a fellow user 405 content and tags or other shared material 403, you 401 are telling the system 407, among other things, about your own perceptions 409 of that recipient. You are also telling the recipient 405, the tag repository of the system, and your personal content map of the system, about yourself and your own preferences. The system may use this information 400 to help you decide with whom to share. While you may, at any time, view your entire (alphabetical) list of contacts 406, as a default you are shown the list of recipients most likely to be interested in a particular piece of content.

This mindset-driven list of potential recipients 402, which you are then encouraged to check one-by-one to build your actual list of recipients, is rank ordered 404. (We also offer users the ability to define and use groups 409, but we intentionally make this functionality less prominent, as use of groups tends to lead to sharing that is less conscientious and considerate.) The rank ordering can be based on a wide variety of measures and factors, for example, on how likely they have been to send you content like this, or how likely you have been to send them content like this, or any combination of the two and others (which you can control). Or you may apply any other kind of appropriate filtering 408 to create useful lists of potential recipients. This type of “tuned” sharing can itself be viewed a form of contextual, privacy-protected mindset matching.

### Clipping, Tagging, and Sharing

Today's Web and mobile platforms lack a common set of interoperable tools for clipping, tagging, and sharing content. There are plenty of tools, of course. Bookmarks and social bookmarks. E-mail folders, desktop file folders, cloud-based file systems. Visually-oriented clipping services, text-oriented clipping services, note-saving services, and proprietary clipping services specific to individual Web sites and mobile apps (e.g. one for The New York Times and another for The Wall Street Journal). Many of these tools have tagging options, sharing options, and discovery options. But none of these is universal, and none supports interoperability of content.

As shown in FIG. 10, in some instances, we offer publishers 421, content owners 423, and every other possible kind of user 425 a universal service 420 for the clipping 422, tagging 424, sharing 426 and otherwise using 425 content 432 (and related observations and other information) presented on Web sites 428, within mobile applications 430, and through every other imaginable class or type of content delivery platform 431.

When you clip an item 440 of content from a Web site or mobile app, for example, it goes into your overall personal content repository 442 (the one that spans everything you clip). It's also visible within your view 444 of clippings just for that site or other content delivery platforms (when we refer to a website or a mobile app, we intend to refer broadly to any possible kind of content delivery platform).

When we refer to clipping an item, we mean clipping in a very broad sense, including, for example, pointing to, marking, indicating, or in any other way identifying a complete item of content (such as a full newspaper article, a complete video, or a full resolution complete image) or identifying only one or more grains or pieces of an item of content, such as a low resolution photograph that appears as part of the news story on a mobile device, or a paragraph of a news article, or short phrase in a sentence of a scholarly article, or a five-second clip from a movie, or any combination of them. Anything that can be identified or selected or indicated or cropped or pointed to, for example, can be clipped. We sometimes refer to anything that is clipped as a clip or clipping.

As shown in FIG. 11, imagine a universal personal content repository 450 of a user 451, and instances 452 of that personal content repository, each of which is a selection of clippings 453 in the repository that are specific to a corresponding site 456 or app 458 or other content delivery platform. Imagine that the look and feel for your views 459 into the universal repository and into all instances of it are consistent at least in some respects among them, and are consistent with publisher-specific views 460, 462 into the corresponding sites or apps.

When we say that the views are consistent we mean, for example, that they have the same or similar looks and feels, or that they are usable in the same or similar way without needing to relearn the interface, or that they offer the same or similar features or presentation, or that they are recognizable as related in the way that they appear or are used, or any combination of those.

We sometimes use the term universal in our discussion. In some cases, we use the term to refer broadly to the fact that a feature or system or element or device is usable across a wide variety of platforms, for example, websites, applications, or other content delivery platforms.

### Curation of Content

Content creators and owners and other users may use our system to curate how they present their own content (thereby expressing publisher mindsets). By curation, we broadly mean any activity in which content is, for example, selected, organized, described, modified, or supplemented for presentation to users through content delivery platforms. Curation may be based on explicit choices, on inferences made using algorithms (that build on top of and make use of mindset patterns), or on any mix of the two. The host of the system can make clear to the curator, as well as to other users, which content is presented based on explicit curatorial choice, and which content is presented based on inferences.

As shown in FIG. 12, for example, content items 470 presented within individual sites 472 and mobile apps 474 or other content delivery platforms can be organized and presented using tags 476 (observations or recursive observations) associated with the content items and with a wide variety of other content items 481 that are not presented originally in the sites or apps. Publishers are not forced to use rigid conventional information structures to organize and present their content. They can adopt an approach that is much more fluid and responsive to overall and specific user needs. For example, for any item of content 470, publishers 476 can help users 478 search for similar pieces of content 479 using individual tags or combinations of tags 480. The search results 482 can be for that site's content only, or for a pre-defined set 484 of preferred sites, or globally for all sites in an index 486 of sites.

Through the tags, a publisher or other producer or provider or owner of content gains new control over searches of users by author and by topic, for example, without the need for the user to leave the publisher's site or app. Topical searches may be further explored using lists of related topics. Topics (and categories) are themselves tags. Topics (and to a lesser degree, categories) are often expressed in somewhat longer form than other tags, and may in some cases be framed as questions. Selections among related topics may be further refined using tags. (For a publisher to be able to include outside content within his Web site or app, he needs to secure the rights to do so, for example, using our content exchange as described below.)

As shown in FIG. 13, in some instances, our system makes possible new kinds of curation 492 of content 490 to prepare it 494 for presentation 495 to others 496. Curation can be done by a crowd of users 498 collectively, by you as a user 500, and by organizations 502 and their editors 504. By rising above or avoiding the strictures of conventional information structures, the use of tags 506 makes it possible to bridge current information silos in which entities define the presentation of their content and control that presentation tightly in accordance a rigid information hierarchy (as doing so creates silos).

In some implementations of our system, items of content from an endless variety of content sources 508 can be handled together, organized fluidly, and presented seamlessly to users. This creates new levels of content interoperability and makes possible (and manageable) mash-ups of content from many different sources and the creation of an essentially infinite number of mindset-driven channels 510 to be carried on an endless variety of content delivery platforms.

When we use the word channel, we mean the term broadly to include, for example, any flow or availability at one time or from time to time of content or items of content, for example curated content, from a party such as a publisher who can deliver the content, to any kind of user of the content. In the process of curation, and of delivery of the channels, the publisher or other party who provides a channel to a user may create blended mash ups of mindsets and content from multiple sources and may efficiently assemble and control the structure and presentation of their own content network (and networks of networks).

As shown in FIG. 14, the publisher (or content owner, or content distributor, or any other user) may use our system in other ways. For example, he could use the mindset of a particular author (as expressed publicly or privately within our system) as an automated filter 524 on the publisher's own content 520. For example, imagine if The New York Times 521 permitted you 523 to see a re-ordered view 526 of their content (for that hour, day, week, month, year, or any other time period), as an alternative to or in addition to their own content presentation 522, based on a mindset filter 524 that is based on NYT economics and political contributor Paul Krugman's mindset 533. To adopt the parlance of cable television, this would amount to the creation of a “Krugman channel” 528 within The New York Times. Much of this could be done automatically.

Krugman 525 also might use this automated, mindset-based filtering 524 as a kind of first cut at his own content preferences. He could fine-tune this presentation by altering his explicitly expressed personal content map 527. He—or his deputies 529—could invest additional time and choose to elevate, demote, delete, annotate, tag, or write about particular items in the automated filtered list (of the relevant The New York Times content).

The resulting presentation 526 (a filtered version of the The New York Times) would be a seamlessly interoperable mix of explicitly selected choices and automatically inferred choices, minus any items that have been demoted or deleted. Or, at the publisher's option, of explicitly-selected choices only.

David Brooks 532 (another columnist for The New York Times) might do the same, using his own personal content map 530 to create a second mindset filter 524 through which the The New York Times content 520 and the The New York Times presentation 522 could be filtered to create a revised presentation 526. The result would be a “David Brooks channel” 528 delivered, for example, within The New York Times Web site or mobile app.

Now imagine that one of the mindset-based channels 528 were a somewhat antiphonal “blended channel” based on the combined preferences 527, 530 of Krugman and Brooks, called the “Krugman-Brooks channel.” In this case, the user would see which content was implicitly “in tune with” Krugman or with Brooks, and which content might resonate for both. For each piece of content, it would be clear to the user which pieces of content provided in the presentation delivered through the blended channel were inferred based on mindset matching (mindset filtering) and which pieces of content were explicitly selected (by elevation, or tagging, or both). The user could select any desired blend of the two (90% Krugman, 10% Brooks; 50/50; 10% Krugman, 90% Brooks). For example, a user could move the slider 542 back and forth along a continuum 540 between a mindset A and a mindset B.

### Personalization of Content for Content Delivery Platforms

Our novel approach makes it possible for Web sites, mobile apps, and any other content experiences to revolve around you and—in any appropriate combination—your moment-to-moment, contextual, and deep, enduring interests, while protecting your privacy in ways that current technologies and services do not, and in ways we believe are desirable if you, in expressing and adjusting your mindsets, are going to open up about your talents, experience, aspirations, goals, love interests, health conditions, financial holdings, investment strategies, start-up plans, competitive strategies, political affiliations, charitable causes, and product needs, for example.

Thus, in addition to creating and developing your own body of content and recursive observations about content as a way to express your mindsets, users can make use of the resulting meshes of recursive observations (theirs and those of other users) as a tool and mechanism for exploring other content in a very personal and custom way that is constantly adaptable and changing and “in tune” with changes in the users's mindsets.

By respecting users' time and attention, our mindset-based approach to content structure, distribution, discovery, annotation, sharing, privacy, copyright protection, and monetization has the potential to make users' Web and mobile experiences more exciting, effective, and focused. And in doing so, to help publishers and advertisers be more successful, valued, and profitable.

As shown in FIG. 15, publishers and other content owners, producers, and providers can personalize, user-by-user and content item by content item, the presentation of their content 560 through channels 564, and personalize each individual user's 566, 568, 570 content experience, based on their content libraries, their observations, and their mindsets. The mindsets chosen for this purpose can be her mindsets (a) in general, (b) based on the project she is currently undertaking, (c) based on her preference profile, or any portion thereof, that is associated with that publisher, (d) based on her preference profile, or any portion thereof, that is associated with a particular author, (e) based on her preference profile, or any portion thereof, that is associated with a topic or sub-topic, or with any level of fine topical nuance, or (f) based on other factors or any appropriate mix of factors.

An individual user A, B, or N may choose to view the publisher's content in one or another or a combination of standard publisher channels A or B, or any other mindset-driven content channel or combination of them that the publisher offers, such as a standard publisher channel C, with no personalization at all. That is, to see what everyone else sees.

She may choose to view the content in a manner that is personalized based on her preferences. Or she may choose to view the content based on any desired mix of the standard channels or personalized channels (e.g. 10 percent personalized, 50% personalized, 90% personalized). The user can combine channels on an even more complex basis to view content based on a combination of three or more channels, including any combination of standard ones or personalized ones or both.

The publishers can have access to personal content, recursive observations, mindsets, and other information in providing the custom channels. When a publisher uses our mindset and other services for this purpose, the privacy of the user is protected. We do not share the user's mindsets or other information with the publisher without the user's permission. A user may choose to share a small portion of her own mindset explicitly at certain times, e.g. when she visits the kitchen showroom and wants them to have a clearer picture of what's she's looking for. But sharing is at the user's option and is designed to be transparent and within her control.

As shown in FIG. 16, mindset information 606 (we sometimes refer to all of the content, observations, mindsets, and other information associated with a user by the system as mindset information) for an individual user X 612 is not normally sent to publishers at all, not even anonymously. Instead, the publisher's content 600 flows into our content repository 602 and is selected and delivered in a manner that is based on the user's preferences 606—as needed—to create the personalized content 608 that is served to her.

That personalized content 608 then flows into a protected area 610 within the publisher's Web site 614, or app 616, or mobile app 617, or other content presentation medium of delivery 618. For example, when the content delivery platform is the Web, the mindset-filtered content may flow into a page or frame or portlet 613 or other content container or interface for the user. Many other implementations are possible.

To help protect confidentiality of information, the content may be served in a format that makes it difficult or impossible for the publisher to snoop on users (terms of use will also prohibit snooping). In some implementations, confidentiality of information can be protected using a sort of invisibility cloak 620. Techniques for cloaking include encrypting the content, serving the content as images, and including decoy content, and any combination of them, among others. Mindset-indexed content then flows into this invisibility cloak. The user can see it, but the publisher (or advertiser) cannot. Other approaches to presenting the content are also possible.

### Cross-Platform Clipping, Tagging, and Sharing

Our system also lets users move beyond the silos created by narrow or proprietary tools for clipping. Tools used today include bookmarks, social bookmarks, and clipping through e-mail (and moving such e-mails into folders). They also include clipping using tools offered by individual Web sites and mobile apps. For example, you can clip items at The New York Times web site or app, and you can clip items at The Wall Street Journal Web site or app. Each of these individual content storage schemes, however powerful it may be in its own right, is a silo in that it is controlled and operated by an entity and is not interoperable with content storage schemes offered by other entities.

The fact that the content is trapped in such a silo diminishes its value to the user. Silos impede discovery, learning, and growth, and users know it. Most users would prefer to be able to see their The New York Times and The Wall Street Journal and e-mail clippings and bookmarked content, and other clippings, together. Viewing items separately will remain valuable, and will be more so once you can view clipped content any way you wants (by source, by topic, by author, or any combination of these or others, for example), from any of your views of the clippings.

Our system makes it possible for you to clip, tag, organize, annotate, share, and protect content wherever you go. Your personal preferences follow you across Web sites, publishers or other sources. Everything you clip works with everything else you have clipped.

That is, with our system, clipping features or mechanisms 632, as shown in FIG. 17, are designed to be universally applicable anywhere that content exists or is delivered 630; and you 640 have an integrated experience of your clippings 639 across any and all of the systems and across any potential range of systems and approaches. (In some cases, applicability will—of necessity—be less than 100 percent.) At any Web site or mobile app or other content delivery platform 630 you visit and where content presentations 631 are available, you may clip 632 content items of interest 634. In some implementations, you may use one of three clipping mechanisms 632, for example, and potentially many more, and combinations of them. First, e-mail it 641 to your personal content repository of content items. Second, clip it using a bookmarklet or browser plug-in or other tool 642 that is usable with but has not been integrated into a site or mobile app. Third, use host services 643 that partners have directly integrated into their own Web sites, mobile apps, and other content presentations (more on this later). Regardless of the techniques that you use, the clipped items, or references or pointers, are all stored in the content repository and in your personal content repository of content items 639 in a uniform way so that they can be managed and used consistently and easily.

As you clip items, you may tag them using a variety of tagging mechanisms 636. In tagging an item of content, you may call on existing pools 646 of tags 637 maintained by the tag facility 638 that you have used in the past for similar content, or pools of tags that you have not used before. The pools of tags may be your own, or those of other users, or combinations of users, or groups of users. They can be chosen for your use based on a wide variety of criteria. For example, you may call on the pool of tags that you have used with respect to the author(s) 647, or the editor(s) 648, or the publisher(s) 649, or the marketer(s) 649 or of other users or combinations of them for a specific item of content that you are observing at a particular time. You may call on the pool of tags that are from your personal network 651 (the people with whom you share clipped content, for example, but only for tags they have openly shared with you). You may call on the pool of all tags created by all users 652, anonymously. You may call on the tags of individual users by name 653, provided they clipped and tagged the content publicly, or are members with you of a semi-public collaborative group, or otherwise chose to share those tags with you. You may clip entire items of content, or any portions of items. You may tag any portion of any item (e.g. a photo detail, an audio snippet, a video clip, a text highlight). You may tag any tag. And you may share 648 any of this, in part or in whole, with anyone you have added to your list of contacts.

We provide this ability to clip and tag and share content as a service that works uniformly, seamlessly, and transparently across Web sites and mobile applications and any other kind of content delivery platform. This permits you to extend your learning, and the language of tags—and tag associations—that you have developed for yourself and that represent your mindsets, across every site, every app, and every other content delivery platform that you visit. This makes it possible for you to integrate experiences that are currently separate.

We bridge these divides and unify the current artificial silos that separate content from your understanding of it. In short, our system overcomes many current limitations to online learning.

We do all of this for the user. We do it whether or not an individual publisher chooses to participate. When publishers, do choose to participate—and to integrate our services into their Web sites or mobile apps or other services—even more value creation (for users, for content creators, for advertisers, and for themselves) is possible.

Suffice to say, the value of a universal cross-site, cross-silo clipping system—to users, to publishers, to advertisers—far exceeds the sum of any individual approaches.

### Bridging Silos and Making Content Interoperable

Information silos are all around us. Organizations and divisions of organizations are silos. Web sites and Web pages are silos. Proprietary databases are silos. So are libraries and the contents of the books and periodicals they hold. The recent explosion of mobile apps and mobile databases and delivery platforms offers great value and has even greater potential. But at the moment, the content contained within mobile apps and other content delivery mechanisms is often even more siloed than the content contained within Web pages.

At every turn, the siloed organization of content seems designed to slow us down, to leave us stuck, to force us to throw up our hands in exasperation and then give up. As the old New England saying goes, “You can't get there from here.”

Thanks to siloed information structures, (whether hierarchical, or proprietary, or both), the flow of information discovery is often inflexible and confining. Silos block creative connections and the sparks of inspiration. While the publishers that create them undoubtedly mean well, the information structures they own and operate are often traps.

Silos exist for at least two reasons.

First, content is not connected to other content in useful ways, often not even by rudimentary links. Creating such links, or other connections, requires considerable effort. And many publishers (and users) dislike the clutter, and the visual intrusiveness, of inline links within text, or even of separate links.

Second, each body of content was created based on the needs, motivations, and intentions of specific individuals, companies, or organizations. Those needs—and the assumptions that underlie them—create boundaries and distinctions that may, at least to a specific user, seem arbitrary or counterproductive.

Whether intentionally or by accident, in electing to use proprietary approaches publishers and other users keep their content segregated. It's unavoidable. Proprietary semantic structures create silos.

Put differently, today's content is rarely interoperable or usable seamlessly across multiple sources, delivery mechanisms, or other silos. That is, what works well in one place won't work well in another. This is often, but not exclusively, due to a lack of common standards. And while many efforts have been made to bridge this divide (XML, document type definitions, and many more), nothing has fully solved the underlying problem. None of the proposed solutions is truly scalable across everything, which is what is needed.

The difficulty of achieving common standards rarely has much to do with the nature or structure of the content itself. It is, rather, due to the assumptions and systems on top of which each individual siloed content edifice (Web site, Web page, mobile app, publisher, content owner, etc. created by a publisher, or content owner, or other entity, for example) has been erected. Put differently, it is often the competing content systems (and the competing viewpoints that underlie them and the competing entities that create and maintain them) that are complicit in creating the silos, not the nature of the content itself.

The evolution of HTML and of Web browsers offer a cautionary tale with respect to committees and negotiated standards for content and content mark-up. Over the years, it has proven to be difficult to get the affected parties to reach consensus. Fragmentation continues to this day. Even HTML5, (which we hope will ultimately turn out to be an exception that proves the rule), is still hardly a tool for universal interoperability.

To overcome these problems of information silos and incompatible standards, we take a completely different approach. Use of our system does not requiring explicit agreement or explicit understanding of how content should be embodied, tagged, described, organized, or used. Instead, we provide a unified, seamless, transparent, universally applicable medium for characterizing and storing content that does not require any agreement regarding standards or practices or delivery mechanisms by the content sources or publishers, and does not even require their participation. As a consequence, content sources and publishers need not modify their content or the underlying technology they use in order to benefit from our system.

One way to think of this is that our uniform approach is so flexible that it plays nice with any existing mechanisms. Our approach works on the content as created, published, or used. And without any need to change those technologies or techniques.

We let publishers, content owners, and other users do whatever they want to do. This fits with our observations of how people and organizations behave.

People can work together on content without requiring that they agree on any underlying structure that each must use for their own content. They may do whatever they want, and the content from these multiple kinds of structure still flows together.

Naturally, by curating content in mutually advantageous ways using our universal system, users and collaborators will be creating new semantic structure and new standards. But the process of curation operates by the parallel conduct of independent actors acting individually or choosing to come together. It never forces or requires any rigid or formal agreement among participants in order for the system to work.

To the extent that one desires to modify the content for the purpose of a universal system, or to make it more useful or navigable (or any other desired result), modification of the content within our system is not through changes to how it is structured in private databases, or in Web pages, or in mobile apps, or in others applications. Instead, we maintain our own repository of all of the content that is clipped, and we make modifications for the purpose of unification only when content is clipped and stored in our repository. This is one aspect of how we avoid the need for common standards and common content technologies. And it is why we never require anyone to change their own content structure to participate. Users add their content to our system and then use our system as a service. Flexible, interoperable structure is added using our system (in many cases, through a kind of service layer on top of existing content and content delivery systems).

Think how useful it is to sidestep completely the need for people to agree. Even people within a company or a division of a company or a team within a division can and do differ in their views of which content semantics and standards should apply. They disagree on why. They disagree on where. They disagree on when. They disagree on how.

With our system, participants and partners (whether within a single organization or across many) can differ in as many dimensions as they like, and yet the content will still flow and have universal usability. The more such participants and partners and others agree on words and relationships among them, for example, the better the content will flow. But many different patterns of agreement—and of disagreement—can proceed simultaneously.

Think about how helpful it is to avoid the battles over semantics and standards and tools and information architecture and operational processes.

We're creating a system in which anyone and everyone can express their opinions in whatever way they want to express them. And yet, everything anyone does can still work together everything else in a unified way.

All users need to do is to choose to use this system in the ordinary course of their use of content. Not as a substitute for their existing systems, but in addition to them and as a kind of parallel universe. They don't need to agree on how or how intensely or how cooperatively they will use our system. It's enough just to use it.

Moreover, people can use our system to build their own specialized systems and semantics, for example for a particular market vertical (finance, construction, daycare, or any other). Any number of people or companies or both can create such services on top of our service. They can compete—or collaborate—with one another to serve these vertical markets, without limit.

For example, different players may offer competing systems for specialized tagging of any desired level of granularity or tuned to any particular language or dialect or industry (which often seems like a dialect). For example, they can create a dictionary of specialized tags for the healthcare industry in general, for doctors, for cardiologists, or for neonatal heart surgeons.

And yet everything they do separately will work together. Our system is a kind of universal glue for content and the use of content.

At the most basic level, interoperability is about a system of tags that works across Web sites and mobile apps. But despite years of talk about “the semantic Web,” relatively little progress has been made. Where there are attempts at unifying languages, multiple competitors—or competing standards—are often at war with one another.

On one end of the spectrum the languages are rigid and hierarchical. Top-down control creates greater order, but such systems are inflexible, even brittle. On the other end of the spectrum tags are fully democratic, even anarchic, and anyone can tag anything any way they want, provided the tags are freestanding and disconnected. Such lightweight tagging systems are flat and flexible, but the lack of structure limits their utility.

Both approaches create silos. Rigid vertical (or horizontal silos) in the first case. And the silos of isolation in the second. When deeper structure is missing, related content is not connected. While it would be desirable to bridge these two worlds, and to adopt the strengths and avoid the weakness of each, a genuinely unifying structure does not yet exist.

Our structure of content, and especially of tags, bridges the divide between rigid ontologies and folksonomies. And between Web sites and mobile apps. It makes interoperability of content possible.

### Moving Beyond the “Link Economy”

Much has been written about the essential importance of the “link economy” and the threat posed to it by mobile apps, which generally do not offer links from one item to the next. Indeed, mobile apps are not necessarily even organized around “pages” to which one can logically link.

Links, however, are just a tool. A means to an end. Their purpose is, one would hope, to help users have a richer, more dynamic, more networked content experience. Their purpose is presumably not tied inextricably to the existence of the links themselves.

Many business models on the Web, including the models for most search engines, rely on the existence of links. Links are used algorithmically. They are also a sort of economic glue and a reciprocal reward system. So for many Web companies, attachment to links is likely to remain strong. Such attachment is also strong among those who fear that a loss of links preordains a loss of the “open Web,” and this argument may have merit in many cases.

It is by creating connections among networks of relevant and potentially useful content that links create value. In short, links are valuable because of the user experience they facilitate, not necessarily in their own right.

So why not offer technology and tools that embody all the benefits of links, but also offer something dramatically more useful? Something that does everything that links do, but also does many things for which links are simply not up to the task. For example, what if a link were instead a connection to a repository or library or user-facing index of well-structured mindset-based possibilities. That is, what if a link were a connection to a system of dynamically-tunable ways—rather than simply one way—to dig deeper. What if, thanks to our re-imagined approach to links as a mindset-based system, it were easy for users at any moment to choose to move up a level, or move sideways, or make their exploration more personal, or make it more general, or connect their exploration to the mindsets of other users, individually and in aggregate, (subject as always to strict privacy and copyright protections)?

Wouldn't such an approach be more valuable than traditional links? It would most certainly be more flexible and more dynamic. So why not embrace both approaches? Use links where links are the best solution. Use mindset-driven networks of recursive observations about and connections among items of content when such a system improves the user experience. Or use any combination of the two.

### Moving Beyond Rigid “Paywalls”

Content creators and publishers and other producers and providers of content need a way to create value and to earn compensation in some proportion to the value they create. If one values content (and we do), then helping them do so seems a worthy cause.

One challenge for digital content and for Internet distribution is that content is easy to copy and easy to steal. Furthermore, with many current approaches the act of seeking to protect content tends to be self-limiting or even counterproductive. For example, a newspaper paywall may get some who wouldn't pay to fork over. However, if the paywall is not sufficiently porous, the publisher will see a substantial reduction in traffic. That is, if the paywall is tight, the people who used to come and read for free won't be able to. But these “free” riders are in fact paying their own way—at least in part—by giving the publisher public attention, which the publisher monetizes through advertising. Paywalls may increase paid subscriptions, but they also turn away free users, reducing ad revenues in many cases.

Publishers must choose their poison. A paywall that's too tight turns off visitors and shrinks ad revenues. A paywall that's too loose is no paywall at all. There must be a better approach, one that simultaneously respects the interests of a range of users including content creators, publishers (and other content owners), content distributors, and advertisers.

Paywalls are a two-edged sword. They give and they take away. The proportion of giving and taking is unpredictable and varies over time. It is, as a consequence, injudicious to assume that paywalls will be everywhere and perpetually effective. Scenarios abound in which paywalls take more than they give.

It's time to move beyond paywalls to a more flexible, dynamic, integrated model of content distribution. Users should be offered multiple attractive paths to purchase the content they want, when they want it. Purchase offers should be contextual and personalized. The user should be able to buy content a la carte or in bundles. A la carte offers should be helpful, not intrusive. Bundles should come in a variety of shapes and sizes.

Here's one example of why such dynamism is important. Publishers who succeed in attracting readers (or viewers, or listeners) who are professionals typically command higher advertising CPMs (cost per thousand readers or viewers or listeners). If the value of a reader is high enough, it may cause the publisher to decide that charging for content is unnecessary, even counterproductive. Indeed, the more effective the publisher's monetization of user attention, the less payment for content will be required (although paradoxically, the reader may be willing to pay more). In some cases, users could—in theory—be so valuable that a publisher (or indirectly its advertisers or other partners) would pay the user to consume the content. (Pay might be direct, or indirect.) This will be different for different types of user. It will also vary based on individual user preferences and on how individual users actually respond to the content, and based on what actions they take after consuming the content.

Our point is not that content should be free. Instead, we believe that the structure of content should be such that it flows to where it is most valued, and such that the content owner has the opportunity and flexibility to pursue a wide range of approaches to monetizing this value. The value of content flows primarily from its ability to attract and sustain user attention and its ability to do that flows from how well the content matches or is of interest to a mindset of a user. This is why tuning content and commerce and advertising opportunities to match what's best for that user (that is, that best matches her mindset or mindsets or any specific portion while protecting her privacy), is important.

There's nothing wrong with charging for content. Some content wants to be free and freely available, while other content wants to be expensive and exclusive. It's just that the structure of paywalls makes content consumption inflexible and unfriendly. Paywalls may work in some cases, but a scalable, widely applicable long-term solution based on mindsets could work much better for everyone.

Our system offers a coherent, economically desirable way for publishers to improve their profitability by moving beyond paywalls.

### Sharing and Monetization of Content

Our unique approach to content clipping and tagging—and to bridging information silos—makes possible new, highly desirable kinds of commercial relationships among content owners.

In some implementations, for example, publishers 662 in FIG. 18 can use our mindset-based content exchange 660 to incorporate content 664 from other sources 661 into their own presentation 678 of content, or to sell use of their own content to others. We use the phrase content exchange broadly to include every possible mode, mechanism, or device by which transactions for value can be conducted with respect to items of content. Our system serves as a trusted intermediary, an honest and fair broker for content exchange, and can track performance 668 and handle payments 670. Other content exchanges can be built on top of our content exchange. And still others on top of those, or on top of a combination of those and ours, or on any possible other combination of exchange arrangements 672 based on host-enabled sources of content. And all of it works together because, in some implementations, all of it is built using one thing: the system that we host. (That is, everything that publishers and others choose to build on top of our system is a fractal instance of our universal approach to content and tags.)

Publishers may elect to pay for the use of outside content, or they can decide to let others pay to use their content, or both. A price point of zero means that the two parties have agreed to share the content.

The content that is shared may be limited or comprehensive. The price and other terms can be different for different pieces of content (e.g. different for different authors, different for arts content than it is for technology reporting, and different depending on whether the content is fresh or archival, and on many other dimensions or any combinations thereof). Payment may be structured on a performance basis using cost per thousand, cost per click, or cost per action, or using any other appropriate metric or metrics. The price and other terms can be different at different times, and they can be different for different types of users.

Publishers can establish and manage detailed, highly contextual business rules 665 for the use and display of this content. For example, they may choose to purchase use of content only when the associated increase in advertising revenues exceeds the cost for the content. Or they may select a minimum return in net advertising proceeds above content costs, (using absolute or percentage terms, or any other desired approach).

Or publishers can establish rules are quite simple. For example, their logic might be, “We earn two cents per page view from display advertising, so we'll pay you a penny for every page view worth of exposure you content gets on our Web site.”

Publishers may choose to present outside content from the content exchange only when users pay for it, or to show specific content to users they perceive to be valuable. Publishers may tune their offering to reward loyal users or any other kind of user they wish to favor (but without knowing their identity unless the user specifically agrees to share it). Filters may be based on any desired anonymous patterns of attributes such as age, gender, income, educational achievement, professional affiliation, project status, celebrity, and in any combination and with any mix of weightings. Which is to say, publishers may tune their offering any way they want, provided it respects the privacy of users and the copyrights of content owners.

Publishers may present outside content (or particular outside content) only on pages for which they serve banner ads, or only on pages that have advertising served by host (more on this later). They may choose to exclude content from certain parties on specific pages, or types of pages, for example where inclusion of such content might cause friction between two or more parties (e.g. other publishers, advertisers, competitors).

### Content that Revolves Around the Needs of Individual Users

We all want the world to revolve around us. So why is it necessary to get the content we want by visiting individual silos (publications, organizations, etc.)? That is, why does the Internet work such that users revolve around the silos, rather than the content revolving around the mindsets of individual users? The Internet is a network, but it is still remarkably lacking in terms of rich, useful interconnectedness, integration, and interoperability of information and services and content.

Where should one Web site or mobile app stop and another start? Why can't the sites and apps and other content we visit be more responsive to our real world needs and to the way our minds actually work?

Shouldn't the content you find, wherever you go, work with the other content you find? Shouldn't your experience of say The New York Times extend out to all of the content in the world, provided your experience of it is better than if you had to leave The New York Times, (provided that outside content owners agree and are appropriately compensated)?

Let's get more concrete. Many users spend the majority of their time at just a handful of Web sites or apps. Imagine you are interested in sculpture and that The New York Times is one of the top handful of Web sites or mobile apps you use. Why should information on sculpture be stuck in dozens, hundreds, or thousands of individual silos? Why can't your experience of the available choices be integrated?

(Tangentially, note that throughout this document when we refer to websites or mobile apps, we are describing any kind of content delivery platform or mechanism that might exist, including future ones.)

Why shouldn't you be able to experience a view of what's going on with sculpture from within your The New York Times experience. Why shouldn't you be able to discover what major museum shows are running or about to open, or learn about recent posts from the best blogs on sculpture, without needing to leave The New York Times. Existing notions of the “link economy” and of “content syndication” don't fully address such needs.

While you may wish to go to an individual Web site or app (for example, once you get focused on visiting a particular gallery), why should you need to leave The New York Times to see a coherent overview of options? Why can't The New York Times be a key node in a mindset-driven “network of networks,” in this case for sculpture?

There are several key obstacles to such an approach. First, copyright holders—quite understandably—don't want to have The New York Times appropriating their content. Second, unless these copyright holders are willing to share their content with The New York Times for free, they will need to be compensated (either directly or indirectly). And even if the copyright holders choose to share their content with The New York Times for free, they'll need the ability to exercise control over the timing and extent of the sharing. They'll want to see data on benefits and costs (increased Web traffic, lost Web traffic, advertising revenues, product or service sales, foot traffic, etc.). Third, The New York Times may wish to be compensated for the traffic they drive to the copyright holder and to the advertising, product purchases, and other economic activity that may ensue.

Accomplishing this sort of structure requires something new. We call it a content exchange, but what we describe here is unlike any content exchange that has existed at any time in the past. To really sing, the kind of content exchange we envision will be implemented by technology that permits (a) ongoing dynamic tuning of the content to contextual mindset patterns of content owners, publishers, galleries, museums, and many other users (including the economic interests of such participants), (b) tuning to general topical or subject area mindsets, (c) tuning to narrower mindset patterns within these more general mindsets (e.g., contemporary sculpture), (d) a way for all content items to be connected (whether through 1 or 100 degrees of separation) with everything else, and (e) a way to make navigation of this n-dimensional mesh of possibilities easy and contextually useful and timely, giving the user just the information she needs at just the right time.

These sorts of mindset-driven content networks (we use the term content network in a broad sense to include, for example, any curated network of content from two or more sources) need not focus on a single medium or media type. Imagine a user-defined channel that combines Charlie Rose's content from PBS (television), with The New York Times newspaper content (print), with Tom Ashbrook's content from NPR (radio talk show). This would break free of the siloed organization of content by media type. Next, imagine being able to apply Charlie Rose's public mindset, as expressed through the public version of his personal content map, to content from The New York Times, such that you see clearly both the items that he has selected explicitly and the kinds of things he might choose.

One can imagine that consumers, publishers, and advertisers—or any combination of the three—might pay for such automated and explicit mindset-tuned curated content.

Topics and categories and tags (and tag combinations) are kinds of mindsets, too. They are after all—in our system anyway—created and curated by people. A publisher might use our system to curate and support—explicitly, algorithmically, or both—content tuned to match a “Liberal mindset,” a “Conservative mindset,” an “Environmental mindset,” a “Freemason mindset,” a “Catholic mindset,” a “Fortune 500 mindset,” or a “Tech start-up mindset.” Or they might curate content that is likely to resonate with flavors of any of these mindsets, for example, by articulating types of content relevant to tech start-ups (Internet, iPad, biotech, green energy, big data, or any mix of these and others).

With our system, much of this tuning to general mindset types can be automated. A publisher might use mindset maps already available through our system, or mindset maps built on top of our system and made available by others (either for free or as a paid service). Or weighted, blended combinations of these.

All of this will save you time, and it will reduce your level of frustration (as a user). The time you currently waste navigating a bewildering array of Web sites and mobile apps and other content sources might be better spent engaging more deeply with the content itself. Or perhaps you can, by consuming content more efficiently, free up time to grab an espresso with a friend, play with your kids, ride a bike, go for a walk, listen to music, hit the mall, or whatever else you'd like to do out in the “real” world.

### User Experience of Content Networks

Mindsets can be used in the creation, delivery, and use of content networks. We use the term content network broadly to include, for example, any aggregation, assembly, combination, or collection of content from more than one producer, provider, owner, publisher, or source of content that can be presented to a user for any purpose. The process of building a content network takes account not only of mindsets but also of economic and copyright arrangements, business rules, curatorial choices, and personal preferences. As shown in FIG. 18, the system that we describe here makes it possible for publishers 662, for example, to use our mindset technology and our content exchange 660 to build, control, and curate dynamic content networks 700. This lets publishers blend content that is based on the content generated by their own authors 690 and curatorial mindsets 692 with outside content 664 (from sources other than the publisher) and outside mindsets 694 (of users other than the publisher, for example), and to present this mashed-up content 680 to users in a form that is coherent and easy-to-navigate. The mashed-up content then can appear in the publisher's Web site or mobile app or other content experience 700 (that is, it can appear in the publisher's content network 700 as if the publisher were serving it). (We sometimes use the phrases content experience and content delivery platform interchangeably.)

The mindset-driven content network 700 can be only one of many such networks made available to the users by an endless number of publishers, producers, and providers of content. The user interface experience of the users within each of the networks 700 can be integrated, seamless, and uniform even though the content in the network is drawn from multiple unrelated sources. In addition, the user interface experience of users with respect to the multiple networks 702 can also be integrated, seamless, and uniform . In many cases, our approach makes it unnecessary for the user to move outside the convenience and efficiency of a given publisher's content network (or networks). However, when going elsewhere becomes necessary or desirable, we make reaching and navigating outside networks more coherent, as well.

This approach offers the benefits of a “walled garden” but without the walls. The walled garden 703 to which we refer includes the content networks that make use of our mindset technology. Within the walled garden, there is a coherent set of tools for a user to clip, tag, and use content. The set of tools is universally available and operates seamlessly across all of the content networks, in an open fashion. The walled garden offers the benefits of the “open Web” and even makes open Web principles (such as linking and attribution) work within apps and other content silos. (Apps are often a kind of walled garden.) Content flows into the garden from other sources, even as copyrights are protected.

The user can leave the garden freely (for example, to visit other Web sites and mobile apps and other content delivery platforms 705, including content that does not offer some or all of the features of the mindset technology), but this is a choice, not a requirement. She stays when staying is most convenient for her. She leaves when leaving is most convenient for her. Indeed our focus is on her convenience, rather than on convenience for the publisher or editor or writer or advertiser. We help her engage in whatever process of self-directed learning she finds to be most effective for her at any given moment, which is something that only she can know.

In short, publishers can create content experiences (content delivery platforms) for which, thanks to our tags and our tag facility, their own content is better organized and easier to navigate than is currently the case. Publishers also may incorporate outside content (while protecting copyrights under mutually agreeable terms), and they may organize this content to flow together beautifully and seamlessly with their own content, or to be an extension of it. Publishers may organize this outside content so that it is mixed evenly with their own content, or they may give priority to their own content, or they may give priority to outside content when it comes from particular sources or is especially timely or noteworthy, or when the content's impact will be particularly favorable for the publisher's revenues or profits. They may, in short, do whatever they want with content. The use of mindsets to guide the organization and delivery of the content makes this easy for the publisher to achieve on an ongoing basis and according to its own (and other users') views of what content and what organization makes sense.

The user, likewise, may take advantage of observations and mindsets (her own and those of others) to do whatever she wants within the context of the integrated content experience a publisher offers through a content network. Her view of available content is better organized. It is easier for her to find things quickly or to change her mind and move in a different direction without getting lost.

Instead of facing an all or nothing choice in which she needs to read entire articles or books, watch entire videos, or listen to entire radio programs to know if they contain information she needs and wants, she can discover and preview the sections (items of content at any level of granularity) that speak to her and her immediate needs. Making use of her mindset and of our tagging system, and their immediate availability through user interfaces presented at the time of and in the place where she is experiencing content, she may view the content topically. For example, she may ask to see only the content about start-ups, or Internet start-ups, or location-based Internet start-ups, or location-based Internet start-ups backed by Andreessen Horowitz. She may view the content in a way that focuses on particular people (e.g. out of this 18-page article, please only show the parts about Meg Whitman). She may request only the information that refers to both a person and a topic (or subtopic).

This ability to expand or collapse views of content is an important feature of our system. It applies to a single article or book or video or any other type of content. It applies across all of an author's work, for example, or across any possible defined cluster of content. Collapsible content clusters may be created based on any possible combination of attributes including the source, author, media type, and topics selected. A collapsed view may be a list of whole items, or a list of highlights, or a list of topics, or of tags, or any combination of these.

Imagine if you, as a college student, could view a collapsed view of War and Peace that showed only the “best” passages referring to “love” for a paper you are writing on “War and Peace and the Unpredictability of Love.” Image that you could easily read and highlight and tag (and make tags on observations) on that particular collapsed version of the book (while further condensing or expanding it as needed). Imagine that you could then view and reorder the quotations you've highlighted. Imagine that you could use our system and interstitial text (a kind of tag or highlight) ordered between these quotations to write your papers. Imagine that the citations would be handled automatically. Our system enables these activities.

This approach, as applied to any desired array of sources and authors and topics and contexts (and any other filters) will tend to make content more accessible, useful, and valuable. It is a service for which users may be willing to pay.

In short, our system provides a platform in which users can individually and cooperatively create a new kind of human curated index (represented by the body of associational tags or observations and recursive observations) of all of the world's information, and one in which the process of creating the index will add substantially to the volume, value, structure, utility, and clarity of available information. This index is not only available through us, but may be incorporated and improved by any content creator, or publisher, or advertiser, or other user in connection with their own content and any content networks they create by building on top of our system. (We sometimes use the word index interchangeably with the phrase observation repository or the phrase tag repository.)

Incorporation of outside content with their own content will help publishers improve customer service, satisfaction, and loyalty. Publishers will use our tools to improve the user experience, in general and for specific users. Effective integration and curation of outside content will become an important competitive lever. Over time, publishers that do an outstanding job of serving individual user needs (including by delivering content that matches or serves their mindsets) will gain competitive advantage over other publishers.

Publishers may incorporate, integrate, and organize outside content in ways that make it unnecessary and perhaps undesirable (in the user's mind) for users to leave the publisher's Web site or mobile app or other content delivery platform. Leaving is a form of transaction cost and a source of lost efficiency for both the publisher and the user. Leaving causes users to take extra time (and to lose focus) in order to consume desired content. Encouraging (or forcing) users to leave prematurely reduces a publisher's potential “share of customer,” undermining potential profitability and competitive advantage.

Publishers may, of course, still give users an opportunity and a simple mechanism to leave at any point, for example, to view the content at a source Web site or source mobile app or at another related content source or delivery platform. We will encourage (and will likely in many cases require) publishers to do so if that is the user's preference and if leaving improves that content experience. Naturally, the better job publishers do in serving user needs within their content networks (for example, by purchasing use of outside content), the more often users will choose to stay, rather than leave. When a user leaves a publisher's network, the user may carry along to the target content delivery platform for immediate direct use there (through a user interface) all of the observations and mindsets that may be useful to him, whether as a layer on top or in the form of a more complete integration of our system into a destination (site, mobile, or other) at which the user arrives.

The publisher may offer each user the ability to experience all of this content—from the publisher and from others—in a way that revolves around that user's personal preferences (mindsets) and project needs and other needs, but without the publisher knowing anything about her preferences and project needs and other needs (except in the form of general aggregate information that is not personally identifiable, or even presented at the level of individual users, however anonymous). This provides the publisher a powerful tool to serve the user without permitting the publisher to invade the privacy of the user.

### Protection of Privacy Across Content Networks

Recent data suggests that a substantial and growing portion of the population is concerned about privacy, and trends in terms of content and sharing and information overload suggest that something has to give. The deeper you dig, and the more specific your mindset gets, the more important privacy becomes. And yet, to be responsive to user needs, publishers must become better attuned to the nuanced thoughts, preferences, beliefs, and needs of individual users. So this issue is not likely to go away. Indeed, problems with privacy, and with the lack of adequate privacy protections in existing systems, are almost certain to grow.

We address these privacy considerations in new ways that current systems don't. Our mindset maps and content networks and cross-network, universally, uniformly, and openly applied privacy protections are designed to work with any existing system or content delivery platform, and we can help any publisher do a better job protecting user privacy (and copyrights). That is, any site or mobile app or other content service can use our mindset-based system to tag and curate their own content, to efficiently tag and curate outside content, to request permission (paid or unpaid) to use outside content, and to control the presentation of content from other sources within their own content experiences. This structure makes it possible for publishers to create new kinds of content networks, and networks of content networks, and to personalize any and all of these experiences while protecting user privacy.

As shown in FIG. 19, one reason that privacy can be protected is that the cross-source content 710 (or references or pointers to content from one source to another) and detailed user preferences 712 flow together though our system 714. Publishers and marketers and other users of any kind would typically not be given direct access to or control over hosting (as this would pose a risk to privacy (and to copyrights). (We sometimes use the phrase content source interchangeably with the phrase content delivery platform.)

With our system, the user 716 has a better, more useful, more efficient, more personally tuned content experience, and—unlike most current approaches—her privacy is protected. The maps of her mindsets 718 are created and maintained for her benefit and are subject to her control. We help publishers serve her better and we help her be more effective as she navigates universes of relevant information.

She can have comfort that publishers and advertisers are not, individually or collectively, allowed to use our system to snoop on her or to invade her private space in our system or to undermine her trust.

As an aside, we (we sometimes use the term we interchangeably with the term host or the phrase single authority) do not intend to be in the business of providing personal information to publishers or service providers or advertisers or any other type of user for the targeting of conventional display ads or for other commercial purposes. In our view, this is the wrong approach. It also is likely to undermine the high level of user trust we seek to earn. We believe that a high level of trust will contribute to our success, and that the success of our system will benefit users. Publishers and advertisers will still be able to reach consumers using conventional behavioral targeting of banner ads and other methods, provided these are outside of the pages, frames, portlets and other regions of content presentation into which we serve content on behalf of publishers.

As personal information gets more nuanced, and as the risks from unintended invasions of privacy grow, we believe that the demand for privacy-protected Web services will grow. Our system will give users (of all types) an opportunity to begin to choose a different path that mitigates these risks from conventional user tracking and targeting.

### Contextualizing and Personalizing Experiences Across Content Networks

Here's how our mindset-based system and our content exchange make possible privacy-protected contextualization and personalization of content experiences on content delivery platforms and privacy-protected, personalized use of content across content platforms (Web, mobile, other) and across content networks (and networks of networks).

As shown in FIG. 20, contextualization and personalization of sophisticated, multifaceted content networks (and of any content) can include numerical weightings for mindset attributes and clusters of mindset attributes (that is, of patterns of information and of user preferences) 740 for each site, app, or other content source or platform or delivery mode in each facet of the content from each source 742, such as each author, each topic and subtopic, and for combinations of these and others when encountered within a specific context. For example, in some implementations, the user will be able to specify (explicitly, implicitly, or any combination of the two): the weighted or unweighted preferences with respect to each source of content, author of content (or any other person associated with content), content topic, content category, content tag, content highlight, generic mindset cluster, and any other attribute of content, and for any potential combination of these.

Our algorithms handle the calculation of relative importance or value based potential combinations of value (contextually) across key dimensions. Key dimensions include (among many others):

Generic value

Personal value

Contextual value

We calculate a rank (which we sometimes call a clip rank) for any clipping. The clip rank for that clipping can be generic only, or generic and contextual, or personal, or personal and contextual, or any blended combination of these values.

The clip rank builds on top of a tag rank for each of the tags within that clipping, among other factors. The tag rank can be generic only, or generic and contextual or personal, or personal and contextual, or any blended combination of these.

In some implementations, the math for performing the calculations may be an additive or multiplicative or exponential or polynomial function of multi-weighted values of tags and other factors associated with a clipping. (In many cases, approximate values are pre-calculated and weightings are recalculated in response to deltas.)

Examples of contextualized generic ratings (e.g., rankings) might include such things as the value of a clipping (or a tag, or a defined cluster of tags) to neurosurgeons in the greater Boston area. Examples of contextualized and personalized ratings might include the value a clipping to me if I'm a neurosurgeon in the greater Boston area and if it's highly relevant to a case I'm working on right now, or isn't relevant right now.

Specific flavors of tag ranks include people ranks (and author ranks which are associated with people ranks), source ranks (and site ranks and application ranks, which are associated with source ranks), and many others.

The generic, contextual, and personal importance and value of a clipping (whether an entire item or a highlight) may be evaluated based on any combination of its star-ratings, ratings, flags, tags (including which tags, the number of tags, the order of tags), tag clusters, matching of patterns of tags or tag clusters to mindsets, the frequency of sharing, and many other metrics.

The generic, contextual, and personal importance and value of tags (and categories and topics, which are types of tags) may be evaluated based on any combination of the calculated utility of the content with which the tags are associated, the order of the tags, the weightings placed on the tags, on which tags or tag clusters or mindsets are related to the tags, and on any other appropriate factors.

Other key concepts include mindset ranks (which are contextual and personal and generally vary across users, groups of users, sites, etc.), attention ranks (which predict attention and measure how effectively attention is sustained), and clip life ranks. Clip life ranks range from a nanosecond to essentially forever. They quantify the predicted (and the actual measured) utility of the content over time. Does the value of the content decline quickly, or decline slowly, or stay flat, or grow over time?

The blend of content from many sources may be filtered 744 in terms of general relevance, in terms of personal relevance (based on an individual user's contextual mindset), or contextual relevance, or any mix of the three. General relevance may include, for example “best” or “popular.” General relevance may be applied across all content and contexts, or may apply only to a defined media type or types, or to a defined topic or topics, or to defined general mindset cluster or clusters, or to a defined time range. Personalization may be turned on and off (e.g. using a check box or other method), or it may be gradated (e.g. using a slider or other method).

That is, the user may choose to view the content 100% as a generic user might see it (representing a generic mindset), or 100% tuned to his own personal preferences (representing his mindsets in general, or at that moment), or a mix of the two. The user may also use a slider or other tool or device to select any desired mix of generic and personal, for example 90% generic and 10% personal or 50% generic and 50% personal or 10% generic and 90% personal or any other desired mix.

The personalized mix of content based on mindsets may also be tuned in more specific ways. For example, it might be generic for topics, but personal for preferred authors or sources. Or it might be generic for sources, but personal for preferred topics or authors.

Note that a topic is itself a kind of mindset and that the content associated with a topic may be filtered, weighted, and prioritized in many ways. Context comes in many forms. For example, if the topic is “Should banking and investment banking be separated?” then “best” or “popular” content might be filtered based on the anonymously-expressed preferences of users globally, users nationally, and users by state or even locally. It might be further contextualized to match the opinions (or distribution of opinions) of hedge fund traders in New York City or of banking regulators in Washington D.C. Such context filters may be further restricted to preferences expressed during specific time periods.

The preferences used by our system to personalize content may be explicit, or inferred, or a mix of both. The user may adjust her preferences such that they are specific to the site or app or other source she is currently visiting. Or she may give priority to her preferences associated with the site or app or other source from which syndicated content comes. Or she may give priority to any curator of content. Or she may choose other priorities, or any combination of priorities, which is to say of filters, or combinations of filters, for content.

That is, we are making possible a new kind of contextually-focused, user-centric integration, filtering, tuning, and personalization of content experiences, whether they involve Web sites, mobile apps, or any other kind of content or content delivery platform, including content that comes from multiple sources or from multiple multi-source content networks (that is, networks of networks).

The user may, in combination with the above, filter content to match the project or task on which she is currently working, and to match any other particular needs she may have at any given point in time. Example: personalized application of mindset mapping to politics

Let's look at this from a more specific angle. It's 2012 and we're in the middle of the political primary season. Imagine if the content to which you have ready access could be tuned to match your political affiliations and the projects on which you were working, but without compromising your privacy. Imagine an Internet experience in which you could effectively explore this content in a continuous sequence, without interruption, starting wherever you preferred: The New York Times, The Wall Street Journal, The Huffington Post, National Public Radio, and ending wherever you wished Imagine that you could more easily compare candidates and candidate positions, and use this information to dig into competing ideas (and articles, and video, and forecasts, and data) from innumerable sources regarding tax reform, entitlement spending, health care, education, and national defense. Image that you could find information, and see it in ways that were more effectively organized. Imagine that content from many sources flowed together for presentation to you such that you didn't need to leave your preferred starting point site or app or other content delivery platform so often, (perhaps reducing your need and desire to leave and visit other sites and apps by 50%).

Such a process might save you time and improve your focus, and it would speed your learning. Now imagine that your experience of this content could be even more focused because your starting point Web site or app (or Web sites and apps) could respond to you based on your preferences (without ever letting the publisher of the content see them).

Imagine that you have the power to tune your experience of their content (and of the outside content they serve through our content exchange).

Now, within this privacy-protected context, imagine being able to express for your own purposes (and, if you choose, for sharing purposes) what you love and hate about specific candidates, in general. And about their tax policies or entitlement reform proposals, in particular. Imagine that you are Progressive and your boss is a Republican. Or vice versa. Imagine being able to collect and curate your own thinking about the 2012 presidential election, in detail, without any risk of disclosing your preferences to your boss or to any of the pollsters who might like to bug you. Wouldn't that be a better world?

We believe this approach will create new possibilities for deep, accurate polling—and for all kinds of market research. Unlike today's fixed, one-size-fits-all polls, questions could be served to you dynamically in direct, immediate response to your level of interest, attention, and passion. Standard lists of questions are also possible.

Dynamically-served questions could get more and more fine-tuned based on each individual user's preferences and responses at any given time. Users are more likely to participate enthusiastically when asked about things they care about deeply, and when they can learn useful information from the polling or questionnaires or questions. With our approach, users are likely to be more fully engaged and more fully attentive. This promises to improve the value, and perhaps even the statistical significance, of polling and other results.

Such an approach might be applicable to health care, to education, to finance, to real estate, to product development, and to many other fields or areas of activity, as well as to politics. It might also be applicable to training, recruiting, and career development (to test for knowledge, comprehension, recall, depth of understanding, perspective, and other measures of learning).

Back to politics and political market research and polling. Many people hesitate to express their political views in public. If your boss or your spouse or your best friends or your clients (or even a few individuals among these groups) strongly disagree with you, then the truth about your political views can be remarkably inconvenient (and damaging in some cases). Privacy matters, and a lack of privacy about deeply help political beliefs can have negative effects on employment, on marriages, and on friendships, to name just a few.

For people who are super self-confident, or extroverts, or both, (people who wear political and other potentially controversial views on their sleeve), this sort of privacy may not matter. Such people trumpet their opinions on Facebook and on Twitter and elsewhere. You know who they are.

But a significant portion of the population is more reserved and does care about privacy. In fact, if you dig deep enough, even extreme extroverts care about privacy, at least for some content (start-up ideas, competitive strategies, patent plans, or trade secrets, for example).

Our approach promises to be so trustworthy in terms of privacy that users won't fear organizing their political thinking online or responding to polls or receiving or interacting with political advertising delivered digitally. One key reason why our privacy will be so trustworthy is that the information that connects you to content, to observations about content, and to mindsets will be held by a single authority, a host, an honest broker whose business is built on the protection of that information and who is not in the business of selling, or selling access to, personal data or the use of personal data.

To protect each user's personal data, we plan to use both conventional and unconventional security techniques. In addition to use of HTTPS, firewalls, password protection, and other standard encryption techniques, we are working on new technology that will couple our concept of mindsets, and patterns of hyper-granular structuring of information, with the concept of “need to know access to information” to further increase security. For example, each “security hop” between clusters (or micro-clusters) of information may eventually, in our system, require its own authentication. The security may be different for different information clusters or partitions. It may be affected by what's going to be done with the information and who is going to do it.

We expect that increasing bandwidth, coupled with faster processing time and the increasing cost-effectiveness of massive storage will make such new security innovations (including implementation of a growing number of secure information clusters and a growing number of security checks to read these clusters or associate them or connect them and the information they contain) both workable and fast.

### Increasing Publisher Profits

Publishers can improve their profitability by cutting costs and by increasing revenues, and we help them do both.

Publishers can cut costs by acquiring content for less money using our content exchange. Publishers can cut costs by improving the efficiency of the reporting process by using our tools for clipping, tagging, and sharing content; organizing lists; and grabbing and using and tagging highlights. The task of assembling the content for a content network will be faster, cheaper, and better quality.

Publishers can cut costs by using our system to improve the clarity and effectiveness of their thinking, communication, collaboration, and decision-making (choices). Such clarity and improved effectiveness applies to individuals and groups involved in any of their content creation, curation, and distribution processes. Or any of these, or others, in combination.

Put differently, our tools for clipping, tagging, and curating content will help journalists be more efficient and effective. Our tools for sharing, especially using a privacy setting of semi-public (to create work groups) will help journalists (and publishers and editors and citizen journalists and others) collaborate more successfully. Our content exchange will make it easier for publishers to purchase use of outside content (for less than it would cost them to create it) and for content creators and publishers to be compensated when others use their work (amortizing costs over a broader revenue base).

Publishers can increase profits by increasing revenues, for example by raising prices, provided higher prices don't reduce long-term demand by an amount that negates the price increase. Publishers can introduce new services that consumers value, which can make possible higher prices or increased sales volume at the same price. That is by improving the quality of the user experience, publishers can increase traffic.

By purchasing use of content exchange content, publishers will be able to increase their traffic (and the ad revenues from it) by more than the incremental cost for purchased content. When users discover more useful content than would otherwise be the case (whether at a publisher's site or app, or within a publisher's content network) traffic is likely to increase.

Publishers can use our system to increase the value of content by making organization and navigation, among other things, more convenient for users. Convenience is often the most important, and most underappreciated, motivator of consumer behavior. Making content more attractive, easier to consume, readily sharable, understandable, connected, and memorable are some other potential conveniences. Making content more personal, customized, and responsive, while respecting privacy, can be an enormous source of convenience and of added value to users. Making it easier to clip, tag, organize, share, and retrieve content is also a key form of convenience for users. We make it easy and inexpensive for publishers to offer their users these benefits.

Tags (observations) also make possible an entirely new kind of search and discovery, without the need for users to leave a publisher's site. In many cases, not leaving will be more convenient for users. As a result, some portion of revenues that currently accrue to search engines may instead serve to bolster publisher profits.

One problem with current Web approaches to cutting costs and growing revenues is that they often rest on assumptions that no longer hold. Current approaches (especially efforts to use paywalls to defend print revenues) may prove to be akin to Kodak betting that film won't ever go away. In a technical sense, this may be true. Decades from now, there will still be a market for film, however small. But the profits from film, in absolute terms, have already evaporated.

Today, some publishers are betting that paywalls will help them resurrect the past. In doing so, they may be fighting the tide. Consumers are addicted to free content, and it's understandable that publishers find this irritating. But the way to solve this problem of consumer expectations is by offering more attractive conveniences (supported by direct revenues, or indirect revenues, or both). Punishing users-for example by offering content that's cheap (in the bad sense of the word), or by displaying advertising that's intrusive and off-putting, or by putting up inflexible paywalls—is not the answer.

In some implementations of our system, publishers might offer consumers the ability to purchase premium content. Consumers already pay $0.99 for songs and $2.99 for 30-minute TV episodes. Why wouldn't they willingly pay $0.05, or even $5.00 for valuable content that's tuned to their needs and that helps them solve a pressing problem (for example, saving them an hour of precious time or helping them win a contract worth thousands of dollars)?

In our view, the real challenge isn't that consumers won't pay. It's tuning the mechanics of asking consumers to pay such that “the ask” matches their needs (and their mindsets). You have to ask consumers for their money (for premium content, that is) at a moment when they can already feel the pain of living without the content they might choose to purchase (whether it's owned directly by the publisher or is available through the publisher's content network). Success is more likely if a publisher adopts a sophisticated freemium approach rather than a rigid paywall.

Our system, and the architecture of our content exchange, make it possible for consumers to discover and value and choose to pay for premium content. As shown in FIG. 21, by surfacing potentially valuable content 800 and by doing so (through mindset matching 808) if and only if a specific consumer is likely to welcome it, we increase the chances that exposure to samples of premium content will turn into transactions. Tags, highlights, summaries 806 (and other approaches to organizing content such that it is more responsive to user needs) will make it much easier for consumers 802 to quickly decide. Simply by choosing (and knowing how to choose) not to bother them most of the time 804, we'll help publishers avoid having premium content that's perceived to be a nuisance.

Our system will offer each user a wide variety of observations, including tags, highlights, pull quotes, samples, excerpts, and summaries of content. Even if they don't choose to pay for premium content, users are likely to find this sample content valuable in its own right (and to be grateful for their exposure to it).

In effect, publishers will be paying users (in kind) for their attention to the premium content offer. A feedback loop 810 is also created in which the users provide information about their interest in the premium content, and a user's level of interest is embodied in mindset maps. Publishers can use mindset maps to tune their presentation of content, and users can adjust their mindsets in response to the content, permitting further tuning. Bear in mind that most of this will happen automatically based on a combination of mindset mapping and pre-defined business rules 812 that govern how content will be presented in response to what the mindsets look like. Once it's set up, there's often no need for special effort on the publisher's part 814.

In some cases, the appropriate price for premium content may be five cents per article or other item of content or less. In other cases, premium content will be quite expensive (for example, a digital textbook might cost $15, $50, or more). It is not possible to determine in advance what the appropriate price will be. Publishers will decide.

What conveniences do consumers want? Users want content discovery that works like magic. Integration of content from many sources. Views into the content based on relevance, timing, sources, people, and their individual mindsets, organizational or group mindsets, immediate project-related needs, and many others.

Users want privacy-protected personalization they can pull on when they want to. And that they can easily ignore when they don't. (Sometimes it's nice to read the same paper as everyone else.) Or any combination of these.

What do consumers want to avoid? Having their privacy compromised. Being told what they'll like and having it pushed at them (the so-called “Daily Me”). Going out and back from search results to content (rinse and repeat), and having no easy way to use valuable content they discover as a steppingstone to further content discoveries, (and to have no easy way to refine or filter such potential discoveries). Spending an hour trying to find something they know they saw recently, but can't find again. Complex interfaces and navigational tools that lead to dead ends (for example, because of stale or broken web links). Repeatedly seeing duplicate content, or content that is of no interest to them, or content that they like but have already read. Banner ads.

Our system will improve the ability of providers of content to deliver content in the context of the conveniences that consumers and other users of content favor while reducing the features of content delivery that the consumers and other users want to avoid.

To improve their profitability, we (and the system that we describe here) make it possible for publishers to purchase use of content on a performance basis, thus matching costs and revenues. Publishers, large and small, can pour money in and have more money pour right back out. This approach aligns interests and can take a publisher's risk essentially to zero. The publisher pays for use of outside content, but can tune spending such that incremental ad revenues (or revenue from the sale of content, or both, or other revenues) are greater than incremental costs for content. (Note that publishers can, at their option, continue to serve conventional behaviorally-targeted banner ads or other display ads against host-intermediated content.)

Publishers can also sell use of their content to other publishers (or to users). They can do so on a performance basis or using other commercial terms they prefer.

And publishers can get paid a share of revenues from mindset-based personalized advertising that's powered by our system (for example, within pages or frames or portlets of mindset-driven generic or personalized content that we enable providers of content and other users to serve—in general, by serving it for them). This kind of advertising (more on this below) is designed to enhance, rather than diminish, the content experience publishers offer their users.

Publishers can sell or rent to individual users permanent or temporary access to their content (or to other content), achieving the same or greater revenues than they might get using paywalls, but without damaging the user experience and without reducing ad revenues. Publishers can sell such access on a one-off basis (e.g., by charging per article or other content item for premium content), or by selling bundles of content items, or by selling subscriptions, or by any others means, or by any combination of means.

Enabling providers of content to tune content delivery to individual user needs and preferences (rather than targeting users and pushing content of the publisher's choice to them) will lead to increased attention and will permit better monetization of that attention.

In the future, better monetization of attention will be a key competitive lever in revitalizing publishing. In the future, organizations that respect users' precious time and attention by assembling easy-to-navigate networks of content (not just their own) and by offering privacy-protected personalization of these integrated content experiences will be the big winners.

### Moving Beyond Social and Real-Time Networks

In presenting our approach, so far we've focused on content that a user discovers when she explores Web sites and mobile apps (or that's thoughtfully and considerately shared by a friend or colleague).

There's another kind of content that's perhaps even more daunting to organize. It used to be called RSS feeds. More recently, it's been called following (on Twitter and elsewhere). Increasingly, it's becoming stuff that comes at you thanks to apps on Facebook, for example, and through hundreds of smaller, vertically-focused social Web sites and mobile apps (Tumbr, Pinterest, Flipboard, etc.).

In the beginning, such tools helped you manage content down to a trickle or a stream and to direct this stream effectively. Such tools often made the interfaces for consuming such content simpler and more user-friendly. This created a breakthrough, and it has been of enormous benefit to many users. As a consequence of these benefits, usage of these services has soared, and so has their traffic.

But, as has been the case with search engines and social networks, the success of such approaches (real-time access to content by “following” people or topics) will eventually run into limits, and in many cases it already has. For you, perhaps the information stream from RSS and social sharing has already turned into a brook or even a river. For many of us, it will soon be a flood.

How you deal with a flood is different from how you deal with a stream. As a result, we may soon outstrip the useful capacity of existing tools.

Our exposure to sharing is expected to grow by three orders of magnitude (1,000×) over the next decade. As a consequence, we as users will need proportionally powerful (1,000×) leaps in the technology for efficiently navigating content choices. We will need tools that will help us channel the excess water (information). We will need a new paradigm for clipping, tagging, organizing, curating, sharing, discovering and otherwise using content that makes such improvements in navigation possible. We'll also need innovations in content syndication and advertising that make this new paradigm economically attractive to publishers and content creators.

At a growth rate of 50% per year or so, the total volume of digital content—at least as currently counted—is growing considerably more slowly. Digital content is rising roughly 400-fold every decade. But what matters most to your perception of content volume is the amount of content you encounter, and sharing has come to dominate that metric. Also, standard definitions of digital content may not count the surging volume of metadata, so current measures may understate both perceived and absolute digital content growth.

As of 2011, people were complaining to us that at best 20% of the information they received through sharing, Facebook, Twitter, and others was valuable and useful. Reporting supports this view that information overload is now widespread.

If information sharing is doubling annually (Zuckerberg's Law), then the percentage of shared content that's actually helpful to users might logically drop to 10% in 2012. And to 5% in 2013. And to 2.5% in 2014. And to 1.25% in 2015. And to less than 1% in 2016. And to 1/10^{th} of 1% in 2022 (which is about the same as banner ads today, at least as measured by click through rates). That is, without any compensating changes, the signal to noise ratio for many users may get much, much worse, (not better as is needed).

New ways to improve the filtering of this content will be developed, allowing the rate of degradation in the user experience social networks offer to occur more slowly.

Nevertheless, the die seems cast. Our experience of this growing flood of data is likely to become more and more overwhelming as time passes.

We've already witnessed several shifts in digital information models, in the organizational structures needed to support them, and in online market leadership in recent years. Yahoo's wildly successful portal model for organizing information on the Web peaked around the year 2000. Yahoo started to run out of gas because human editors couldn't keep up with the flood of information.

This created an opening for Google, which substituted algorithms for editors and quickly became a phenomenal success. Today, Google is worth roughly 10 times Yahoo. In early 2000, Yahoo was worth at least 100 times Google. So we've experienced a 1,000 fold comparative reversal of fortunes in little more than a decade.

Now we're experiencing competition between Facebook and Google, between Google and Twitter, and between Facebook and Twitter. One theory behind this competition for social attention (and to accumulate “social signals” and build a “social graph”) is that the company with the best-targeted advertising—including targeting using social “interest graph” data—may “win” and dominate the market for online advertising (or at least some valuable portion of it).

Unfortunately, in addition to generating new exciting features that benefit users, these competitions to win the contest (over social network traffic, information on user interests, and advertising) often have the unintended consequence of creating more content silos, further fragmenting the social network landscape (and—in some cases—undermining somewhat the coherence and utility of user experiences).

Consider the impact of Twitter's model of real-time public sharing of content, which has taken the world by storm and which has now been adopted, at least in part, by others. Unfortunately, it's not always easy to find, collect, and curate what's best for you by “following” people. The level of noise is considerable, and the bias in this approach is heavily toward information that's hot and fleeting. Despite considerable strengths, Twitter can be a bit of an echo chamber.

Twitter and Twitter-like public sharing may also lead to high levels of repetition of the same or similar content. This further amplifies a well-established pattern, especially among blogs, of duplicate (or ambiguously differentiated) content and duplicate mentions of ambiguously differentiated content. Thus, with Twitter you may end up seeing the same article as shared by many different people. And you may see dozens of different articles about essentially the same topic.

One might attempt to solve this problem by reducing this list of duplicative articles to one (the best one, presumably). But that might be a mistake. Many of these seemingly similar articles have different angles. One or several of the angles they present (which are in fact differentiated content) may be valuable to you. That is, there's often valuable content buried in the nuances of these duplicative blog posts on the same subject. But with today's information tools, it's too hard to find and compare the essential points of distinction and to decide which ones matter to you. It's too hard to focus on just that portion of the content that's differentiated, or important to you, or both.

Once again, current technologies force you to choose your poison. Do you read all of these similar articles, and in doing so waste precious time? Or do you pick just one (or none) of them and risk missing something of pressing importance?

Mindset mapping—in contrast—makes it possible for us to look at differences, as well as similarities, making navigation of such options much more efficient.

Processor power, bandwidth, and data storage capacities are growing by leaps and bounds. But the real information challenge here cannot be solved using faster computers or faster connections or cloud storage, although each of these is helpful.

The volume of available content is soaring, as is the volume of content that's shared each day. But the number of hours per day has not. As George Gilder predicted in 1990 in his book, Life After Television, the defining scarcity of our era is time and attention.

If your time is soaked up reading or watching or listening to things that aren't important, what is lost? Your focus for one thing. And your ability to tune to your own muse.

You can read all the content that floods your Twitter feed and lose your life. Or you may choose not to read all of this growing flood of content, in which case you risk missing something essential. Either way, you lose.

Properly addressing scarce time and attention will be served by a new approach to content and content discovery. A new approach that is more granular and integrated, more nuanced, and less coarse in its applicability. A new approach that is genuinely personal, and is not just superficially geared toward user “interests.” A new approach that's in-depth, and that helps individual users dig deeper. A new approach that protects privacy and that permits more thoughtful, considerate sharing and collaboration. A new approach that moves beyond algorithms to the experience and wisdom of human curators, and that supports curators in this enterprise by offering them access to powerful mindset-based algorithms (which are themselves created and tuned by human curators). A new approach in which content that's potentially useful (but which you won't have time to look at right away) is retained and organized on your behalf.

With our mindset-based approach to the organization and personalization of content, you'll be able to take your time. When using Twitter or other real-time social services, you'll no longer feel compelled to rush through available content now, just to make sure you don't miss out. Whatever may be interesting to you will be saved and organized and waiting for you whenever you are ready. Your reservoir of potentially useful content will be available in many useful forms and formats, and you will be able to sort it (or portions of it) easily using innumerable filters and combinations of filters.

As an aside, while this may sound complex (and under the hood, it may be), our mindset-based approach is radically simple. Users don't need to do anything special or difficult. You simply clip items that interest you. And allow the system to queue up organized repositories of clippings, highlights, topics, and tags that may interest you. This information isn't pushed at you, but it's there if you need it.

If you don't want to bother, you can never even add a single tag or observation. But because the items you choose to clip (or share) say a lot about your mindsets, you'll still reap rich benefits. Even with this simplest of views into your content preferences, our understanding of the content based on tags added by others (including by our system), will be enough to organize the flood of content (from Twitter and elsewhere) on your behalf. Put differently, our system will work for anyone. It will work for novice Web users. It will also work for students writing papers, journalists writing articles, authors writing books, academics conducting research, editors curating content, librarians cataloging books, scientists contributing to peer-reviewed journals, start-up entrepreneurs studying market opportunities, and many others who might be considered “power users.”

The focus will shift away from what is hot (except, of course, when that's what you want) and back to what's most valuable, useful, and relevant for you right now, or at any other time and in any context. If the content is 2 days old, or two weeks, or 200 years, in our system that's OK. Even though it's not a “trending topic,” you'll find what you want.

### Mindset-Based Content Filters: Personal Levees

In the future, we'll all have to figure out how to sift through an increasingly overwhelming body of information, some of which is doubtless important and much of which is not.

In the 1970s, information was like a water fountain. Easy to manage, but barely enough to slake your thirst. In the 1980s, information was like a garden hose. It was starting to feel more substantial, but the flow was still something even the kids could handle. By the 1990s, the Internet turned the garden hose into a fire hose. It was new and exciting and pretty wild, but not yet completely out of control. You just didn't want to let go of the nozzle.

Then, in the 2000s the fire hose began to seem more like a burst water main. The flow of content became enormous, exciting, unwieldy, and a bit scary. The volume, while workable at times, was increasingly disruptive and overwhelming.

Throughout all of these phases in which the volume of content expanded, the flow could still be regulated. If there was too much information, you could (metaphorically) simply turn off a valve to stop the flow.

Now, the game is changing again. The volume of information continues to soar, and social sharing is exploding. If you are “average” and have 100 Facebook friends, Zuckerberg's Law suggests that you will receive 500,000 shared items a day in 2022, up from 500 a day in 2012.

This is no longer a burst water main. It's a flood. It's like the mighty Mississippi River overflowing its banks. And you can't shut the Mississippi down by closing a valve somewhere.

One potential metaphor for a radically different approach to information control is “personal levees.” During the floods and controlled releases of 2011, the Army Corps of Engineers couldn't and wouldn't provide top-down protection from flooding for some homeowners. Indeed, through controlled releases of water the Corps flooded some areas intentionally. Property owners were forced to take bottom-up action and some of them created their own personal levees. That is, they bulldozed into place huge rings of earth around their homes. In some cases, these personal levees were as tall as the houses themselves. The alternative was to abandon their homes and let them be inundated.

Perhaps that's what we all need today in the digital content world. Protective levees that keep the flood of information at bay. Levees that help us accumulate potentially useful information—keeping it at a safe distance until it is needed. Levees that create our own lake, or lakes, of potentially useful content. While the water (information) is sitting there, our levees can—thanks to mindset maps and personal preferences—organize it, catalogue it, and make it more useful (both in general and just for us). Then, if and when we decide that we want to skim this content, or explore it, or deeply consume it, or simply use it as a valuable, time-saving steppingstone toward discovery of other valuable content, the content is ready and waiting for us.

We can drill a tap, slap on a spigot, and get whatever water (content) we want, whenever we want it. With trillions of potential content spigots, and even more potential spigot combinations, we can follow our imagination wherever it takes us.

### Mindset-Based Content Filters: Personally-Indexed Information

We could go further metaphorically and turn the water into something more magical and less physical, while retaining the capacity to return it to physical form whenever and however we want. Using our mindset-based system, the flood of information (water) can be transformed automatically, creating for each of us a Harry Potteresque self-organizing library. The water that might otherwise drown us could be transmuted into books and periodicals and photos and videos, or into useful combinations and presentations of mashed up content in new forms that do not currently exist in physical or electronic form.

What you need could come to you when you need it. Whatever you think of, whatever thread you pull on, whatever question you pose, with what whatever nuance you shift your thinking, the library could reorganize itself in response. Magically, everything you need could be within reach. And if you imagined something that seemed out of reach, it no longer would be.

How might it be possible? We propose to use our mindset-mapping system 852 (FIG. 22) to transform the ever-expanding universe of electronic information 854 (content) so it revolves around you 850 and your needs. Everything you need will come to you when you need it (including access to physical copies 858 of content).

Our approach is not based on pushing the content at you, although in some cases users may elect to have this happen. It works primarily based on attraction (pull). Information responds intelligently based on your mindsets and your actions. You shape the information by constantly adjusting your mindsets and by calling for content and by pulling on it. The shape of your information experience keeps shifting in response to your dynamically changing mindsets and your moment-to-moment choices. The process can be two-fold. In one aspect, your constantly changing mindsets operate as filters and tools that automatically affect the quantity and nature of the content that appears for your consideration. In another aspect, you can constantly be picking and choosing the content to suit your needs at a given time.

In this enterprise, we use the actions of individuals (whether explicit or implicit). These actions are sharpened by our tools and by users' desire to help themselves, to build valuable tags and other structure for content. Individual efforts, coupled with collaboration among groups, makes the universe of available content deeper, richer, more nuanced, more accessible, more searchable, more sharable, more salable.

By adding useful tags and highlights and other observations and by making our sharing of content (with individuals, groups and the public) more tightly focused, we create benefits for all users. We do so altruistically and anonymously by default. Which is to say, this kind of selective, considerate curation and sharing of content is driven by our innate desire to help others (and to make the world a better place for everyone).

Note that, without a system to capture and protect mindsets (and other intellectual property), none of this will be possible.

### Mindset-Based Content Filters: Personal Watersheds

Here's another metaphor. Think of information as the water in a hydrological cycle. Consider the particular watersheds and ecosystems the hydrological cycle supports and the integration of water into other things.

A watershed captures water. But the water is not all immediately visible. Some water ends up deep underground. Some ends up in the soil, some in the plants and trees. Some water is visible on the surface in streams, brooks, and rivers, and in ponds and lakes.

The information (water) that may be of interest to you can be anywhere. It may be in this ecosystem, in one nearby, or in one that's far away. The range of potential places defines your scope.

In our system, the information you want—or may want later—is collecting all the time in your personal information watershed (or watersheds) because it is automatically identified as being of potential interest to you as a result of observations and mindsets associated with you. You don't need or want the information to all be available or visible all at once or at a particular time. But you do want the benefits of the information (water) to be there when you need it.

The information (content items) can stand alone (as H2O), or it can be mixed or otherwise combined with other things (content items and observations, for example) to form more complex information structures that include and build on the raw information. For example, the water can be organized in a tree, or a species of tree, or a big tree, or a little tree, or even a tree frog.

Information (content, by analogy or as an example) underlies all of these structures, and it is both integral and integrated. Our system is designed to make this sort of integrated, dynamic, interrelated structure of information, and of information ecosystems, possible.

Put differently, information in our system extends far beyond the content (information) itself. Most of the value that will be created using our system will come from a combination of human and algorithmic metadata that's created as supplementary indexes or maps or meshes for content, for example, in the form of tags and mindsets based on them. Indeed, despite the flood of information, the volume of metadata added using our system may ultimately exceed the volume of content by several orders of magnitude (that is, by 1,000 times or more).

Somewhat ironically, huge increases in information (e.g., the content) using our mindset-based system will help users consume less content, or consume the same amount of content (or more content) in a way that involves far less time or “work” or “pain” and yields far more value. Improvements to the structure, organization, ordering, weighting, tagging, curation, pattern matching, and personalization of content, among others, will make the information and the metadata associated with it much more useful. Users' consumption of this content will be more attentive, more in tune, more focused, and less stressful.

And as we all know, “watershed moments” are important to the shape and structure of our personal thinking. They are moments of growth, insight, or epiphany. They occur when we change our minds, or when many of us together experience a shift in perspective. Which makes this watershed metaphor that much more appropriate.

### Mindset-Based Advertising

All of these concepts: mindsets, mindset-based curation of content, mindset-based personalization of content, and a bias toward vigorous protection of user privacy, are applicable to advertising, as well. Online ads don't work very well, and in our view it's time to do a complete rethink. Improvements to advertising will help solve the business model challenges publishers face, and will help publishers create and offer better experiences to their readers, viewers, and listeners, (and to better compensate journalists).

Consumers want advertising that speaks to them. Advertising that is entertaining or amusing or inspiring or informative or timely. Or, better yet, some combination of all of these. Which is to say, they want advertising that is valuable content, and that is valuable to them at the moment they consume it.

Publishers want advertising that fits well with their brand. That readers, or viewers, or listeners will love. Ads that reinforce rather than undermine their brand position. They want advertising that lifts their position both aesthetically and economically. Ads that make their business model stand up and sing, “Glory, Glory Hallelujah.”

Advertisers want advertising that reaches consumers who will want to buy their product or service (or give to their political campaign or charitable cause). Advertisers want advertising that publishers who reach such consumers will want to carry.

Consumers—on average—don't seem to like the status quo. Most TV advertising is both interruptive and unwanted. Many consumers find TV ads irritating and use DVRs to skip as many of them as possible. Online advertising is often even worse. Survey data suggests that most consumers dislike banner ads. In many cases consumers say they hate them. And unlike TV ads, users can't skip most Web or mobile advertising (although banner blindness suggests that display ads may be largely ignored, at least at a conscious level).

Publishers don't like many aspects of the digital advertising status quo, either. Financial reports suggest that, in terms of advertising revenues, publishers are trading analog dollars for digital dimes (or pennies).

Many advertisers don't seem to like the status quo either. TV ads are getting more expensive, and thanks to DVRs and ad-free services like Netflix, fewer and fewer viewers watch TV ads (although the hours consumers spend watching TV continues to grow). Banners and other display ads, and even social ads, present their own set of problems.

Print advertising is an exception to this advertising gloom. Print ads can be attractive and useful at the same time, although this is not always the case. Many readers say that their content experience would be substantially worse without the print ads (in high end magazines, for example). Publishers welcome print advertising and they like the economics (which are favorable to publishers), provided they can get advertisers to sign up. Advertisers often find print advertising effective in building brand visibility, and many willingly choose it, provided they can afford it. But print is expensive and it's hard to accurately track ad performance.

Ideally, Web advertising would have the targeting and measurability and ROI of search ads, coupled with the beauty, utility, and impact of high-end print ads (or some combination thereof). Because it's the Web, new kinds of tracking, targeting, and personalization should be possible. So ideally Web and mobile app advertising would be far more targeted than display ads (or, with our approach, “tuned”).

To make additional targeting, tracking, and personalization a welcome change, consumers will need to know that their privacy is truly protected. Indeed, the better targeted the ads, the more important privacy will become.

As previously mentioned, consumers crave content experiences that are convenient for them. Yet the current structure of marketing, of advertising, and of content can make their content experiences inconvenient and less than ideal.

So what are consumers seeking? In many cases, they use the Web and mobile apps primarily to search for and to consume content. Desired content includes articles and books and audio and video and products. It includes data, especially if presented in a format that's useful for business or personal consumption. In most cases, consumers are not searching for (and do not seem to be interested in consuming) digital advertising, at least not in its current forms. Web and mobile ads may not be giving consumers what they want.

And yet such ads may take up 10 to 40% of Web page or mobile app screen real estate. Given click-through rates that may average only 1/10^{th} of one percent (one click per 1,000 ad impressions). This means that you could be seeing the equivalent of 100 full pages of advertising (at 10% of screen real estate per ad) before you choose to engage directly (rather than passively) with the advertising. Objectively, in terms of the use of time and attention and resources, this seems less than ideal.

Indeed, the digital marketing that consumers actually do hope to find (and consequently welcome when they do) typically comes in the form of valuable content and not as advertising per se. For example, users seem to be quite interested in gaining access to blogs, articles, photos, videos, and to items they might want to purchase (using a wide variety of digital catalogs and other e-commerce-related services), to name just a few examples. This is especially true if—in their view—the experience offer by this digital content is efficient or cost-effective or convenient or entertaining, or is otherwise superior to other available alternatives for searching, using, sharing, and acting on content. (As an aside, technically, content is marketing not advertising. However, advertising is a subset of marketing, and marketing provides the raison d'etre for advertising.)

In our system, advertising comes in the form of (primarily, but not exclusively) valuable content. That is, our approach to advertising is rooted in marketing, and more specifically in serving users content they are likely to value. Furthermore, we recognize that content often has promotional value (whether it's considered to be advertising or marketing or neither). We make the promotional value of content something that can be tuned, and tracked, and elevated, and compensated.

### Example: Advertising to a Consumer who is Renovating a Kitchen

Let's say you are renovating your kitchen. You'll need to make overall design choices about style, layout, floor plan, cabinets, countertops, appliances, flooring, and much more. It's not enough to pick items individually. Everything you choose needs to work well with everything else.

In many cases, consumers don't know how to ask for the content they desire. In describing what they want, they may resort to saying, “I'll know it when I see it.” This often means they can't readily describe what they want using words. So they resort to other methods of communication.

If you're like most consumers, to get started you'll rip from magazines pages of kitchens you love or hate (or “like” or “sort of like” or “sort of hate” or “hate”). Showing what you love is obvious. Showing what you hate is helpful, too. It allows others to understand what you don't want (often with a memorable emotional charge), and this is sometimes as or more helpful than knowing what you think you want.

You'll also print out—or otherwise save and organize—photos you find on the Web. You'll use these visual analogs to communicate with others. That way you'll help others “see” what you “know.” (This is, of course, a kind of clipping and sharing, which is to say a kind of expression of the user's mindset.)

Using words to communicate about design choices is often less effective than communicating using images, and it can be counterproductive. Words won't mean the same thing to every listener, and it's hard to know what they'll hear. Especially in matters of style, words may lead to divergent or even opposite conclusions. For example, if you say, “I'm looking for a contemporary sofa,” what are the chances that your spouse or your interior designer will conjure into mind the same image as yours, (or even one that's slightly similar)?

A known system to address home design choices was previously developed as part of a company called HomePortfolio. HomePortfolio addressed the “I'll know it when I see it” need by combining images with tags and allowing users to search for more images using selected combinations of tags. However, HomePortfolio's underlying technology and processes were entirely different from the approaches described herein.

The HomePortfolio ontology and technology platform were developed (primarily) in the late 1990s. A team of HomePortfolio editors built (top down) a single universal attribute language for home design. The underlying technology involved a relational database and a two-tier hierarchy. Semantic relationships were comparatively simplistic and rigid. The system did not benefit from energy and insight of a crowd, or from editorial curation of input from a crowd. Users were not able to add searchable tags or to order the priority of their tags. They were not able to add weightings to tags or to define relationships between tags. Information, while more flexibly organized and much easier to navigate than with conventional sites at the time, was siloed.

Words (tags, that is) attached to pictures can help facilitate effective communication. The picture defines what the user means when he chooses a word. It surfaces divergences in language and bridges them. Systematic integration of pictures and words increases the chances that communication and collaboration will be successful. Such integration, which is itself a kind of mindset map, is—in our view—one of the keys to successful online advertising, and it is a foundational function for advertising within our mindset-based ad system. Better, more nuanced tags that are associated with images will lead to more efficient communication about product and service choices. Nuances can come from the tags on content details and tags on tags that disambiguate these details, among other things. Tags can be added by advertisers (to their content). Or by the publisher (to their content and to each advertiser's content). Or by professionals. Or by a particular user.

Individual users can organize their preferred images and words (for their kitchen renovations) as vision boards, or as swatchboards, or as collages, or as slideshows, or in any number of other useful schemes. Also, much as an author or screenwriter might do in setting a scene, the user may describe what he envisions and desires as vividly as he likes. This description can be in the form of an essay, or may be interwoven with any of the image/word presentations.

Furthermore, words may be organized as clusters of attributes (tags), whether in the form of a conventional tag cloud, or as prioritized lists of tags, or as prioritized lists of semantic phrases. Images may be organized into pairs, clusters or grids, or other useful pictorial-semantic decision structures. Words, or patterns of words, or semantic phrases may be attached to these images or groups of images (either visibly, or as a hidden service that appears when you need it). You can choose to search for images and words based on differences, or you may choose based on similarities or based on complementarity.

All of these views of images and language express a kind of micro mindset. Among the mindsets of a given user and mindsets across users with respect to a topic, many, many mindset patterns will be observable and useful. The decision process is rooted in pattern recognition. Recognition that is human, not simply algorithmic. (Note that algorithms are helpful too and are used extensively in our system.)

To be successful with your kitchen renovation, you may also want or need to hire an architect, an interior designer, a general contractor, and others. This decision process—identifying, vetting, and hiring professionals—often involves advertising and other kinds of marketing. And use of images, words, collections, and collages are a key part of the matching making process with professionals (as well as of the decision making process once they are hired).

With or without the help of a professional, as the kitchen design process progresses, the consumer will face a bewildering array of choices. He will be inundated with information at every turn. Even after his kitchen design is fully in place, there will be more choices. Even when construction is complete, there will be more choices.

To make these choices successfully (before, during, or after a kitchen renovation), the homeowner needs access to the right information at the right time. If information he needs in order to make an informed decision comes too soon, the information (advertising) may be wasted. Too late is, well, too late. As a consequence, advertisers want to get in the game early, but not so early that they are lost in the shuffle or branded a nuisance.

Here's a potential process map for a hypothetical kitchen renovation:
Discovery
Collecting options
Organizing options
Weighing pros and cons
Seeking to integrate related options

Lists of things that work well together

Lists of things that don't work well together
Making preliminary cost-benefit trade-offs

Will that choice blow our budget?

Trade-offs between upfront and life cycle costs
Deciding how to resolve differences of opinions
Getting professional advice
Hiring professionals
   Architect, interior designer, builder

Figuring out how to choose the right professionals
Asking friends and relatives for input
Visiting showrooms
   Choosing which showrooms to visit
      Do they display items I'd like to see?

Will showroom staffers offer useful help and insights that match my needs, or not?
Choosing preferred options
Using preferred options to help with more focused discovery
Making design and product and people decisions

Creating a conceptual design
Specifying choices (often with the help of a professional)
Creating a buildable design
Getting quotes from contractors
Starting over because the price is too high
If costs are under budget, adding new features (made affordable by cost savings)
Arranging financing
Signing a construction contract
Living through construction

Resolving disputes
Creating and checking off punch list items
Stepping back and appreciating a job well done
Adding artwork
Buying small appliances
Cleaning stains on your new marble countertops
Replacing the tile backsplash (which, as it turns out, you hate)

This is a long, yet abbreviated list. The process of envisioning, designing, and installing a new kitchen is remarkably complicated. The process is non-linear, and it can seem infinitely nuanced. While it sometime proceeds in a predictable, well-ordered way, the opposite is just as likely, and the order of activity is often scrambled. Problems or discoveries often make it necessary or desirable to loop back to an earlier step. You might need to jump back five steps. Or all the way back to the beginning.

One key is knowing the right questions to ask and when to ask them. But figuring this out is more art than science. It comes with experience, but how many of us want to redo our kitchen every year just to stay up to speed?

Projects speed up and slow down. You get an unexpected bonus, and the project that yesterday seemed long off suddenly kicks into high gear. You get fired, and even though construction was supposed to start next week, you decide to postpone the project for a year. The delay ends up being 10 years. Or a lifetime.

It's a wonder anyone ever chooses to go through a process like this. It's trial by fire, and more than a few marriages haven't survived it.

### A User-Centric Approach to Advertising

Today's advertising models—digital and otherwise—are not well suited to handle a process like this. For this sort of kitchen renovation process to work well, the advertising needs to be much more fully integrated into the homeowner's decision-making, not just tacked on.

To break through the clutter, advertising needs to be welcome, relevant, and useful. It needs to match my style, my budget, and all of my richly nuanced preferences about details.

The steps in this kitchen renovation example reflect what we call mindsets. Although some people, some of the time, appear (especially to others) to be remarkably clear in their thinking (and are hence readily identified and classified as appropriate ad targets) most of us change our minds continually. The foundation for our individual mindsets—let alone its overall form, framing, detail, and ornament—is fluid, not fixed.

Even in our simplest descriptions, our overarching mindset or intent is a bit blurry (or still lacks precise detail). It's like a view of some glorious mountaintop in the distance. Alas, unlike the mountaintop, for which we may drive and then hike closer to understand more, when we consider design options and additional details emerge our intentions tend to shift.

Our home design goal (metaphorically the mountain) is not a rock. Imagining the details often changes our big picture intentions. And vice versa. Our destination keeps changing, and we have only ourselves to blame. As we discover new options, we alter our underlying assumptions about what is possible, and our vision of what's most desirable.

Heisenberg proved long ago that the very act of observation changes the nature of things we observe, and one can imagine him smiling from the grave.

Although they fit rather poorly with conventional approaches to advertising, such adaptations in thinking and intention should be welcomed, not resisted. Such adaptations are a sign that we are learning.

It's advertising that should change, not this process. Advertising should support what consumers need, not what advertisers think they should want.

Matching people with the right content (and products and services) is hard enough if the consumer has already decided what he wants. But people are, in many respects, impenetrable. We can never—not even for our spouses, significant others, children, friends, and colleagues—truly know what others are thinking. Operating effectively in the “real world” requires a combination of asking and guessing.

As we can never fully know another person's mindset in a particular context, at a particular time, and on a particular subject, we should, in the final analysis, rely on him to tell us what he's thinking and what he wants.

So advertising should ask, not tell.

This is, in our view, a central challenge, not just for advertising, but for all of information science. For our time. For any time. How can you know what people want unless you ask them? And will people answer honestly if the question is for the benefit of the marketer (or publisher), not the other way around?

This illustrates the difficulties with statistical approaches to advertising and to ad targeting, as well as with conventional targeting and personalization of content.

Advertisers are trying to reach and communicate and collaborate with real people in the real world. “Statistical demographic groups”—and eyeballs and clicks—are just the best available tactics and metrics (with current techniques). It's individual in-the-flesh human beings that advertisers seek. Ones who can be persuaded to buy, and who will be happy, not remorseful, if they do.

Advertisers' success (and by extension the success of publishers) depends on users being happy and engaged and delighted to spend their money on goods and services an advertiser offers. But happiness, engagement, and spending tend to decline if advertising turns off readers or viewers or listeners. And the data on click-throughs (along with consumer opinion surveys) suggests that people generally dislike currently-available display advertising experiences.

The features of conventional online advertising tend to set into motion a cascade of compromises that undermine the prospect of a constructive relationship with consumers. (If people who are tricked into buying, long term damage will be done to the advertiser's brand and to the publisher as well (Fred Reichheld, The Ultimate Question).

Advertisers need to ask consumers what they want, but with today's approaches to online advertising, they are not easily able to do so.

Advertisers (and publishers) need a game change. They need a way, either directly or in effect, to ask consumers questions and to get honest answers. Without user anonymity and ironclad privacy protections this won't happen.

Consequently, whether they know it or not, advertisers (and publishers) need an intermediary who, by fully protecting user privacy, makes asking possible. They need someone trustworthy to stand up for consumers and to help them know their own minds.

### Advertising Across Content Networks While Protecting User Privacy

Mindsets (which include and reflect user preferences) don't naturally fit within rigid content silos (one for kitchens, another for furniture; one for Architectural Digest, another for The New York Times). Mindsets and preferences naturally bleed from one information silo to the next.

A user-centric approach to advertising won't work well if our preferences are stuck in a bunch of different subject area or publisher-centric silos. If so, the full pattern of our preferences (and the full value of years of exploration and learning) won't be available to us when we need them.

To work well, such advertising needs to be in tune with individual user preferences, and the ad system should fully protect user privacy in order to get access to information (observations) about those preferences. The expression and use of such preferences (for both content and advertising) should work across millions of Web sites, and mobile apps, and other content experiences. But without ever betraying the user's trust.

Such advertising is unlikely to work if the intermediary's (we sometimes use the term intermediary interchangeably with host or system) preference profile for you is outside your control. Or if it is focused only on one brand or topic. Or if it's based on non-transparent cookie-based data gathering and snooping. Or if regulators, in response to perceived snooping, force publishers or other service providers to erase your preference data after a year or two.

If multiple mindset-based advertising systems are created and structured as silos, and if the owners are competitors and have divergent interests, then your user experience cannot be easily unified. Which is to say, the advertising probably won't work effectively (at least not up to its potential). Content silos will continue to reign.

So it's important that the underlying universal mindset system for advertising (and for content) be available to all publishers and advertisers and users without preference or discrimination. That is, the system should be—by design—non-competitive and non-aligned with any particular company or organization or other party. No preferential or volume pricing. No sales exclusives.

That's what we are doing. We are building a new framework for advertising, one in which we (as mentioned earlier, we sometimes use the word we interchangeably with system, intermediary, and host) control the unifying system that handles the underlying structure for mindsets, tags, privacy protection, and syndication of content (including ads), and we intend to operate it for the good of everyone. Any existing or future player can build on top of our platform and become part of this new privacy-protected mesh of information and information-related services. But they can't eliminate or corrupt or usurp its silo-busting, overarching integration, protection of user privacy, and spirit of fair play.

By building this underlying structure, we make it possible for any publisher to build their own specialized approach to information on top of it and to use this to help users. Any advertiser can do the same (note that in our system advertisers are also a kind of publisher). Our privacy protections extend to everything any participant (user) does. As a result, each user's view of his preferences (as well as of any content, including advertising) is unified.

Indeed, publishers can simply keep the information systems they already have and build complementary, host-intermediated, privacy protected layers of personalized content services (including advertising) on top.

### The Future of Advertising

The evolution of advertising has progressed in many stages. At first, advertising was essentially one to one. Think of small shop owners in ancient Greece or Rome, or in Renaissance England, or in America before the advent of modern media. Later, with the creation of mass markets, advertisers began to target their offerings demographically. That is, advertisers selected a particular publication or television program as a vehicle for selling. They did this because a publication or program attracted a demographic segment they wished to reach. Women of a certain age. Affluent homeowners. Automotive enthusiasts.

The Web changed this (although in the early going, targeting of online ads—e.g. at portals—was typically still broadly demographic). Targeting soon shifted from demographic to interest-based. With banner ads, ads could be more finely segmented. You didn't have to have the same banner ad for the people interested in cars and for people interested in appliances. You could have different ads for different Web pages or for different sections of a Web site.

In this respect, banner ads were a success. In the beginning, banner ad CPMs were high and so were click-through rates. Unfortunately for publishers and advertisers, over time consumers clicked banner ads less and less frequently. Click through rates went from two to three percent in the early years to an average of as little as 1/10 of one percent today. Furthermore, by the 2000s eye tracking studies showed that consumers were increasingly developing “banner blindness.” Cognitively-speaking, many users weren't even seeing the banner ads anymore.

GoTo (Overture) and Google refined interest-based advertising and made it more efficient. Instead of ads based on the content on specific Web pages or Web site sections (the areas of interest), they instead began to serve up search ads in response to the search query each user typed in. One could say that search ads are action-based expressions of interest, and some call this “intention-based advertising” (Battelle, The Search). The effort of typing text that says “2012 Toyota Prius” shows a much higher level of directional intention (and interest) than visiting a site about cars in general. Such ads are better targeted.

Search ads are presented as simple text descriptions and text links, not as banners or other display ads, and this makes them seem more useful and utilitarian. Such advertising is usually priced per click, rather than per impression, making it more like direct marketing. That is, advertisers pay only when a user has acted in response to an ad, not just when a user sees it. Search ads are thus often call performance-based advertising.

In the early 2000s, search ads took the market by storm and quickly grabbed a 40 plus percent share of online advertising. Along with the after-effects of the 2001 recession, and the resulting collapse in banner ad CPMs, this put tremendous pressure on sellers of banner ads. Fearing economic death, companies within the banner ad ecosystem responded by creating a new kind of ad that was “behaviorally” targeted. This way, they could serve you automotive advertising even when you were reading about sports (provided their behavioral targeting showed that you were interested in cars).

By snooping on users' behavior across sites, and by collaborating to share this (ostensibly anonymous) data on users, publishers, behavioral targeting service providers and advertisers were able to significantly improve the responsiveness of banner ads. Compared to untargeted ads, revenues per impression doubled.

However, the snooping has in recent years caused a reaction among consumers (and increasingly US and European regulators) regarding invasions of privacy. Rules have been implemented requiring that users be able to opt out of being tracked and requiring that publishers and behavioral targeting service providers discard private data after a year or two, undermining its value.

Recently, Facebook and Twitter have taken online advertising a step further. Their interest-based targeting of ads includes social signals, including who your friends are and what they like, what you “Like” or “Tweet,” and who you “Subscribe” to or “Follow” (including brands). Because it is not clear to users what's being tracked, behaviorally targeted and interest-based targeted ads are also causing a backlash from consumers and regulators.

To us, these approaches seem to present some of the same concerns as conventional banner ads. Indeed, recent research shows that increased targeting can actually decrease ad effectiveness, (for example, by “creeping out” users or otherwise making them feel uncomfortable).

How this will shake out is anyone's guess. But wouldn't it be better if ads were “tuned” to what consumers say or imply they want (that is, what they consent to), rather than being targeted at them.

Why shouldn't advertising fully protect your privacy, such that publishers and advertisers never see your preferences? Why shouldn't you control the advertising you see?

Put differently, as shown in FIG. 23, why shouldn't advertising 860 be based on your 862 mindsets 864 and tied to a mindset system 866 that you build, curate, and control. A mindset system that you can change at will, any time you want to.

Wouldn't such an approach be better for publishers and advertisers too? Wouldn't such ads be more valuable for everyone? Publishers, advertisers, and users, that is. Might they not be so much more valuable than today's display ads that you could see many fewer (and more useful) ads, and yet—thanks to your more focused attention, and the higher value of the resulting mindset-based advertising—publishers could actually generate larger ad revenues than is currently the case?

Our mindset-based advertising system 868 is designed to change the rules for advertising. Tuned, mindset-based advertising will shift the advertising dynamic from push to pull. That is, because users will be offered things that match their needs, they'll in effect request advertising (and associated marketing and content) that helps them decide.

With tuned, mindset-based advertising, it will be possible for marketers to build constructive relationships with consumers. These relationships will be consensual, not interruptive or intrusive. They'll exhibit subtlety and nuance. They'll develop over time. They'll be more like a conversation.

As a consequence, ad performance 870 will be more measurable than it is with today's online ads. Even compared to search ads, performance tracking will be improved. This is true, in part, because all of the steps in the advertising relationship will flow through our privacy-protected system 872. Other companies 874 will be able to build their own systems 876 on top, and others on top of those. But at root, no matter what anyone builds using our API, user privacy will be protected. (Copyrights will be protected, too.)

We don't expect other forms of advertising (banners, search ads, etc.) to go away any time soon. TV ads did not go away with the advent of the Web and banner ads. Display advertising did not go away with the advent of search advertising.

Indeed, we expect that the availability of new approaches to advertising will lead to further innovations in display advertising and in search advertising (and perhaps even in TV advertising). For example, it may be possible for users of our system to purchase banner ad inventory and replace it with higher value mindset-tuned content that drives increased ad revenues (or e-commerce revenues or payments for premium content) on subsequent pages. This might have the effect of driving up the value of (and CPM rates for) display advertising inventory.

### Mindset-Based Web Sites and Mobile Apps

As shown in FIG. 24, a publisher 880 will be able to use our system to power—completely or in part—its Web sites and mobile apps and other content experiences 882 available to users 884. As a result, the publisher will get all the benefits of our system 885, including tagging 886, mindset mapping 888, tools for curating content 890, content channels 892, syndication of content (inbound or outbound or both) 894, personalization of content 896, and monetization of focused user attention 898 (including through sale of premium content and services 900 and through our mindset based advertising 902).

Our services will make it possible for publishers to create user experiences 882 that cannot be created using today's tools. Our system will reduce the time and effort required for publishers to create robust, personalized, privacy-protected content experiences and content networks.

In some examples, to make this work, a publisher will clip 904 its content 906 into the content repository 908 of our system, either manually or using automated tools 910. The publisher will add tags 912 to the content. If the publisher already has tags 914 in its own databases 916, or in the metadata 918 for its Web pages or mobile apps or other content delivery platforms, the publisher will be able to pull these tags in automatically. Or it may choose to view such tags as one of the tag pools 920 out of which it curates its preferred lists 922 of publisher defined tags 924.

For any given item (or grain) of content 926, the publisher-defined tags may by curated by a single editor 928, or by multiple editors 930 with equal weightings 932 on their tags, or by multiple editors 934 with different weightings 936 on their tags, or by a combination of tags from editors and from users in general. Weightings may be established based on the type of user or based on privileges 938 a particular user has been given.

Using any combination of these weighted curatorial settings for editors and users in general (and users of any specified type or level of authority), the publisher may create its own observations including highlights 942 and tags 944 on highlights and ordering 946 of entire items of content and of content highlights and of tags (as they apply to entire items, or to highlights, or to tags).

The publisher may use our tagging facility 886 to note associations (that is, relationships or observations) 948 between items, and between highlights 950 (both within items and across them), and between tags 952 (and categories and topics, which are types of tags). The publisher may also use observations to define collections 954 or groups 956 of content and relationships 958 between these collections or groups.

As described earlier, the publisher may use our content exchange 960 to add in content 962 from outside sources 961. A specific item or bunch or collection of outside content may come from a single publisher, or from many. The item, bunch, or collection may also come from any outside content provider or content producer or content owner service 964 (or combination of services) that has built a content network 966 on top of our system 885.

The publisher may easily add mindset-based advertising 970 to its Web site or mobile app, or other content experience, creating for users an ad experience 972 that is tuned to their needs and desires (and for which they may turn off ads or brands they would prefer not to see for any other reason).

The publisher may also incorporate conventional banner ads 974 within their Web site, or mobile app, or other content experience. However, these conventional ads typically (although not necessarily) will not be targeted based on our user mindsets.

Publishers that use our system to build their Web sites or mobile apps or both, as well as any other content experiences, will be able to offer individual users mindset-based personalization 896. The user will be able to view the content generically, without any personalization 978, or with the fullest personalization that her current mindsets can offer 980. Or she may choose any desired degree 982 of personalization (versus a generic view) of the publisher's Web site or mobile app or other content experience (for example, 10%, 25%, 50%, 75%, 90%).

The publisher may also use our mindset technology to build a variety of content indexes 984 and summary pages 986 for their Web sites, and mobile apps, and other content experiences. That is, the publisher will be able to automatically generate pages that help the user navigate and choose content more productively.

For example, for his kitchen renovation, the user will be able to view available products and design ideas and other content from a manufacturer based on the category of product (sinks, faucets, cabinets, countertops) and based on narrower categorical views (stainless steel sinks, gooseneck faucets, granite countertops). He may view his choices based on style, color, or price, or size, or shape, or dimension, or the architect, or interior designer, or builder, or photographer who is responsible to the design or the photo or both. Or he may view his choices based on any combination of these attributes. Choices may be viewed as pages (of any layout, mixing text and images), or as lists, or as grids, or a collections, or as slideshows, or any combination of these within a single interface.

The publisher will not need to do any work to curate these pages. Simply by using our system of tags 947, the publisher will be able to automatically generate thousands (or millions) of useful navigational pages 988, and the publisher will be able to offer in conjunction with these pages customized, context-specific navigational tools 990. However, should the publisher wish to reorder (and otherwise organize, curate, or define) the presentation, they'll have the tools at hand.

These pages will improve the coherence and flexibility and responsiveness of the user experience, and the user may easily view content as personalized to match her mindsets. These pages may also prove helpful for search engine optimization and for low-cost generation of traffic and search referrals (see description below).

Finally, publishers will get detailed reporting 994 on traffic at their Web sites and mobile apps and other content experiences, (but not in a form that makes individual users' activities visible, let alone individual user information).

### How the Clipping can be Done

Clipping (for example, identifying, marking, and causing storage of content items) may be achieved any of three ways or combinations of any two or more of them, and in a wide variety of other ways and combinations of them.

In some implementations, for example, clipping can be done using email. As shown in FIG. 25, in some examples, a host 1000 of the system provides a user 1002 with a specific or generic e-mail address 1004 that, in combination with the user's e-mail address 1006, allows the host to place the item of content to be clipped 1008 in that user's personal content repository 1010 and (typically) in no other repository. To cause this to happen in some implementations, the user addresses e-mails 1012 to the host using this specific or generic e-mail address 1004. The body 1014 of the e-mail contains content identification information 1013.

The content identification information could be a wide variety of devices and combinations of them that are useful or available in identifying any piece of content or grain of content or combinations of pieces of content of any kind, for the purpose of clipping it. Content identification information could be implicit or explicit or a combination of the two.

In various implementations, the content identification information could be, for example, a link 1016 or other pointer to a Web page, to a mobile app, or to any other content 1018, or a link or a pointer to content on her own computer or mobile phone or other device 1020. Or the e-mail may include the content 1022 or a portion of it that has been selected by a user. In that sense, the content itself may be considered content identification information. Or the e-mail may include both a pointer to the content and a copy of the content. The host, on behalf of this user, copies the content that has been identified or directly contained in the e-mail.

In some examples, the e-mail may include an image, a video, a Web link, or any another content or pointer to content. It may include a quotation, or a journal entry, or any other personal musing, or any item of content of any sort that the user wishes to keep, and organize, and more easily retrieve at some future date. The item that is included may be a complete item in its original form. Or the item may be a piece or grain of a complete item of content, or a modified version of an item of content or a grain of an item of content. The e-mail may include tags 1024 and highlights 1026 and other notations 1028 about the content. The content may have been created by the user who is clipping it.

In some examples, one form of expression of such content and of the content identification information is observations that can include tags, highlights, tags on highlights, and tags on tags. This simple, economical e-mail mark-up language is designed to work well on mobile phones and tablet computers, as well as on desktop and laptop computers, and potentially other devices as well.

The mark-up can use the following or other similar syntax, illustrated by examples as follows:

TAGS
.technology

This markup gives all of the content in the email or pointed to by the email the tag “technology.” Our parser 1001 looks for the period (dot) before the text and recognizes that as the beginning of a tag.
HIGHLIGHTS
.“Apple today introduced the iPad.”

This markup, beginning with a dot, says that this user is choosing to create a highlight using this specific text contained within quotation marks, which is a portion of the content. A highlight is a special kind of tag. It indicates some level of interest by a user in the portion of the content that is highlighted.
TAGS ON HIGHLIGHTS
.“Apple today introduced the iPad.” .lede .Apple .iPad

This markup says that this user is choosing to tag this particular highlight using the tags as shown. The user can place as many tags after the highlight as she wishes. In this syntax, the tags appear immediately after the highlight with no intervening characters other than a space. As before, each tag is preceded by a period. A tag named lede—which is a kind of special tag—says that this highlight shows up at the beginning of this article. Other special tags include conclusion, nut graph (or graf), and pull quote. A conclusion is a highlight located at the end of an item of content. A nut graph (or nut graf) is a highlight that captures the essence of an item of content. A pull quote is a highlight that is short and has particular significance.
TAGS ON TAGS
.All Things Digital: source
.Walt Mossberg: author; author of this article; tech writer

This mark-up says that this user is choosing to add subordinate tags to the tags, in this case, All Things Digital and Walt Mossberg. A tag is an observation and a subordinate tag is an observation on an observation. Subordinate tags (observations) further clarify a tag's contextual meaning. In the first example, the word “source” is a subordinate tag on the tag “All Things Digital.” In our syntax, subordinate tags are separated from the tag to which they point by a space, a colon, and a space. In the second example, multiple subordinate tags are associated with the tag “Walt Mossberg”. This mark-up says that Walt Mossberg is an author, the author of this article, and a tech writer. If more than one subordinate tag is used, the subordinate tags are separated from one another by a semi-colon and a space. Thus, roughly speaking, the user has indicated in the tag something that the user would like to note about content. The user has also indicated in the subordinate tags things that the user would like to note about the tag (in this particular context, but not necessarily in general).
.review of iPad: thumbs up
.iPad: review; Walt Mossberg
.thumbs up: iPad; Walt Mossberg

This mark-up illustrates that combinations of tags and subordinate tags, and use of subordinate tags as tags, can clarify meaning.

Note that our system supports an infinite sequence or recursion of tags on tags. We often use the words subordinate tags to describe tags on tags. Any number of additional subordinate tags may be attached to subordinate tags At present, our e-mail mark-up language supports tags and one level of subordinate tags. To avoid unnecessary complexity and clutter within the e-mails, additional levels of subordinate tags are added using Web and mobile interfaces.

The structure of our mark-up language is intended to make it more efficient for users, editors, and other curators to add semantic structure—whether facts or opinions or observations or other indicators of the value or relevance or personal importance of—to content, and portions of content, and to tags, as they are clipping it.

Our system stores a copy of each such e-mail. As shown in FIG. 25, the system includes a process 1001 that parses the e-mail 1012 to locate the content 1022, any pointers 1015 or links 1016, the tags 1024, tags on tags 1032, highlights 1034, tags on highlights 1036, and tags on tags on highlights 1038 (multiple levels of hierarchy of tags are possible) and any other observations. The system stores these items in the user's personal content repository 1023 and the user's personal mindset repository 1025 (and associates it with the writer of the e-mail 1044). It also stores the recipients 1040 of the e-mail (primary and cc), the subject field 1042, the date and time stamp, and any other relevant information and associates it with the user and the item. In the case of a pointer or link to a Web page, the parser stores the Web page URL 1046, title of the page 1048, and the author 1050 (as appropriate). It also parses the content 1022 to which the e-mail points (whether the pointer is by a URL, or URLs, or is accomplished using some other pointer of any type or variety). These additional data fields and items of content are valuable for a variety of applications. Parsing is the word we use to describe how our system translates the contents of the e-mails, including the tags and highlights and tags on highlights and tags on tags and other observations (the mark-up) into data (typically in the form of XML).

An example of such an e-mail, including content, pointers to content, tags, tags on tags, highlights, and tags on highlights is shown in FIG. 30. One example of a echo e-mail, also called a “clean copy” e-mail, which is formatted for greater readability is shown in FIG. 31. One implementation of a Web page that allows a recipient of an e-mail to add desired clippings and highlights and tags to their own personal content repository is shown in FIG. 32. This page, which may be accessed using personal computers or using mobile devices or other devices represents one of many ways that a user may grab shared tags 1052 and highlights 1053 and tags on highlights 1054 for their own use.

By sending the e-mail to clip@host.com, the e-mail is assigned our default privacy setting (private, anonymously visible). Should the user wish the clipping to be public, she may send it to public@host.com. In this event, that clipping will be publicly associated with her name and her public identity within the host database and may be publicly searchable using her name. Should she wish a clipping to be private, but not anonymously visible, she may send it to hidden@host.com. She may also send it to superprivate@host.com or to semipublic@host.com (see below for details).

Thus, the address to which the clipping and tagging e-mail is sent can itself indicate the desired level of privacy for the content.

The user may set the individual tags, highlights, tags on highlights, tags on tags, and tags on tags on highlights within any of her e-mails to any of the host e-mail addresses at any of the available levels of privacy (five levels, in some examples). That is, the privacy setting for each individual tag or highlight (or tag on a highlight, or subordinate tag) may be the same (which is typically our default setting), greater, or less that the privacy setting for the overall e-mail. (Note that the user may reset her default setting, or settings, at any time to the specific level of privacy she most commonly prefers.)

For example, square brackets [content] around the content within a tag or highlight or tag on a highlight, or any other type of tag or content, indicate that this specific piece of content should be private, but not anonymously visible (which is to say hidden). Curly brackets {content} indicate that any piece of content should be treated as superprivate. Angle brackets <content> around any item of content indicate that this content should be public. For example:
.[keep this tag hidden]
.[“keep this highlight hidden]”
.{keep this tag super-private}
.{“keep this highlight super-private}
.<make this tag public>
.<“make this highlight public”>

Thus, the system provides a markup syntax for marking up content and pieces of content in accordance with a range of two or more or many different predefined levels of privacy. The syntax can then be parsed to assure that each piece of content is handled as requested. A wide variety of other syntaxes could be used.

Semipublic sharing could be handled through the host Web site or mobile app or other integrated services, and not through the e-mail, as the sharing potentially requires selection among many semipublic collaborative workgroups, and use of semantic mark-up within the e-mails, although possible, may introduce excessive complexity and considerable opportunity for error.

Content Clipping and Tagging Widget

For purposes of clipping content that is presented to a user through a Web browser, in some implementations, the content processing facility includes a content clipping widget that enables the user to drag a bookmarklet provided by the host via a Web page into her browser's bookmark bar. Or the bookmarklet functionality may be appear above (or below, or both) an embedded Web brower within a mobile application. Or she installs a browser plug-in, or uses any of a wide variety of other methods to gain additional functionality for use with a browser or a mobile app or another content delivery facility.

Any widget, plug-in, add-on, script, app, or program, or any combination of two or more of them that enable a user to work with content that is provided or exposed by a content source might be used to provide such functionality. We sometimes call the device a content processing facility which we use broadly to refer to any facility that would enable such functions.

In some implementations, the devices that provide such functionality could be ones that do not require any action on the part of the owner of the Web site, mobile content, or other content to integrate the host's services on top of the user experience offered by this Web site or other digital content source. In other words, the device or process that offers the content need not be altered, consulted, or aware in any way of the use of the clipping and tagging features. In some examples, it may also be possible to arrange the device or process or source of content to have specific functions provided.

Although we sometimes refer to a content processing facility as one device, the clipping and tagging function could be provided by two or more separate devices that operate independently or cooperatively.

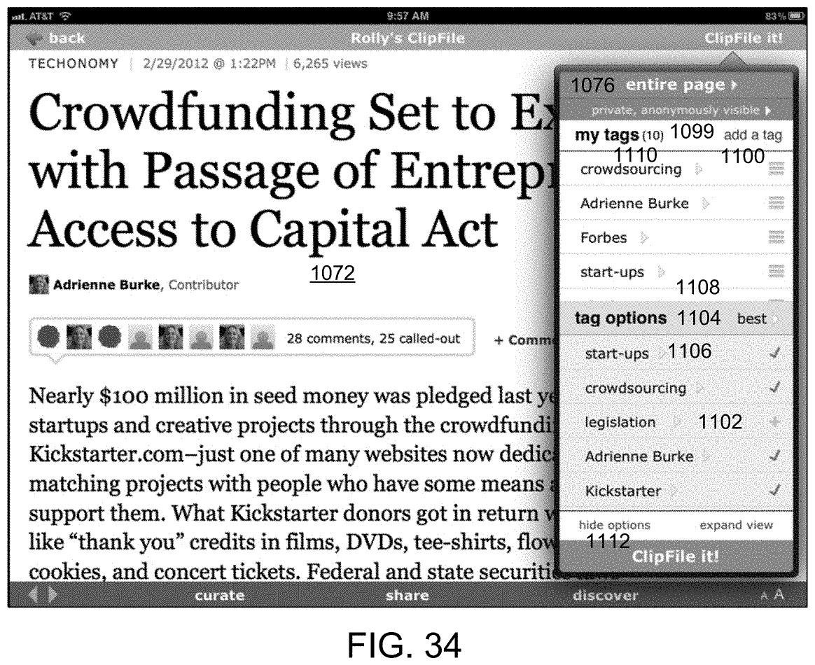

In the course of using the Web browser or a mobile app, or any other source of content, when content of interest is encountered, the user clicks on the bookmarklet or an icon or other device to launch or trigger or open the clipping and tagging facility. (In some examples, the facility may open automatically upon start up of the user device and remain active as long as the device is on. In some examples, the facility may open automatically for each app or content delivery facility that opens or is put into use and may close when the content delivery facility is turned off or closes.) In some implementations, as shown in FIG. 33, a top strip 1068 and a bottom strip 1069 may open up and frame the digital content. As shown in FIG. 34, a clipping and tagging widget 1070 may open on top of the content 1072. The user is given an option 1074 to use the clipping widget to clip the entire item of content 1076 or a specific part of it 1078. A default can be to clip the entire item of content. The user may also choose 1080 to select a) a highlight portion (e.g., a grain) 1082 of the text, b) a physical region 1084 of the page, c) a photo, graph, or other image 1086, or d) a portion 1088 of a photo, graph, or other image, or f) any of the many additional useful ways to capture all or part of the page or content. Any possible pointing, indicating, collecting, implying, or filtering technique and other techniques and any combination of two or more of them that are suitable for identifying content to be clipped can be used.

Thus, in some examples, an early step in using the clipping and tagging facility is for the user to identify the content to be clipped or to allow the default to apply. Once the content has been identified, or left at the default setting, the user may trigger the clipping of the item. Or she may choose to add tags to the content specified or tags on the tags recursively, whether a whole item or a highlight or an image or other content.

As shown in FIG. 34, in some implementations, the content processing facility includes a content tagging widget 1099 that enables the user to type tags in directly 1100. In some examples, the user may also select tags 1102 from one or more tag pools 1104, one or more of which can be provided by the host. Each of the tag pools can contain and present to the user lists 1106 of tags associated with the content being presented to the user, or with similar content (see below). The host system can determine, from the content, by inference, which tag pool and which tags may be more relevant to the content or otherwise useful to the user in tagging the content.

Tags added from the tag pool are moved by the widget to the bottom 1108 of the user's list of tags for this item of content, or content highlight, or image, or other content, and the list of tags is adjusted such that the tag most recently added is visible at the bottom of the user's active list of tags. (All the changes she makes over time may be recorded in her personal content repository.) A tag counter 1110 (for the user's list of tags for that item) may be included and may be incremented to indicate that the total number of tags has increased. The counter helps the user see that there are more tags in her list than are currently visible on the page.

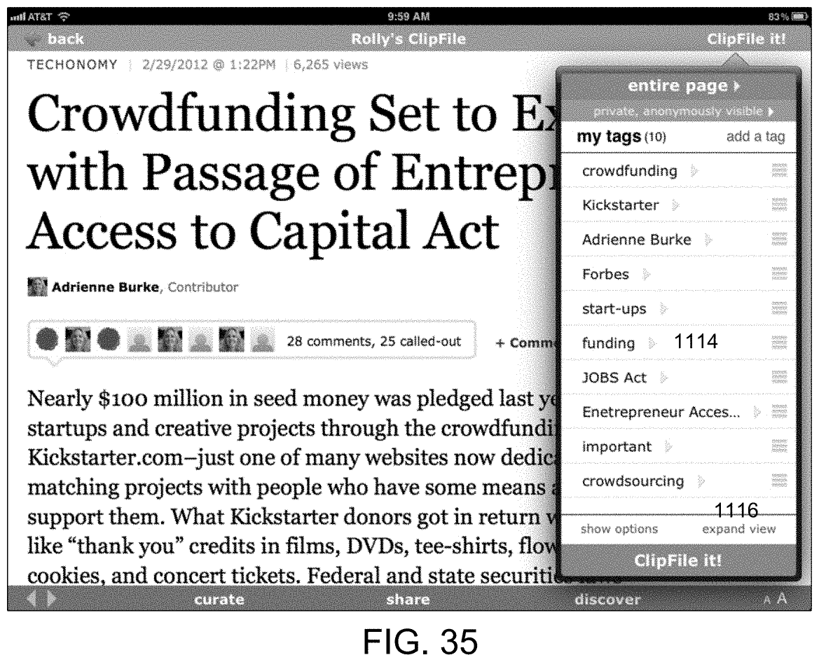

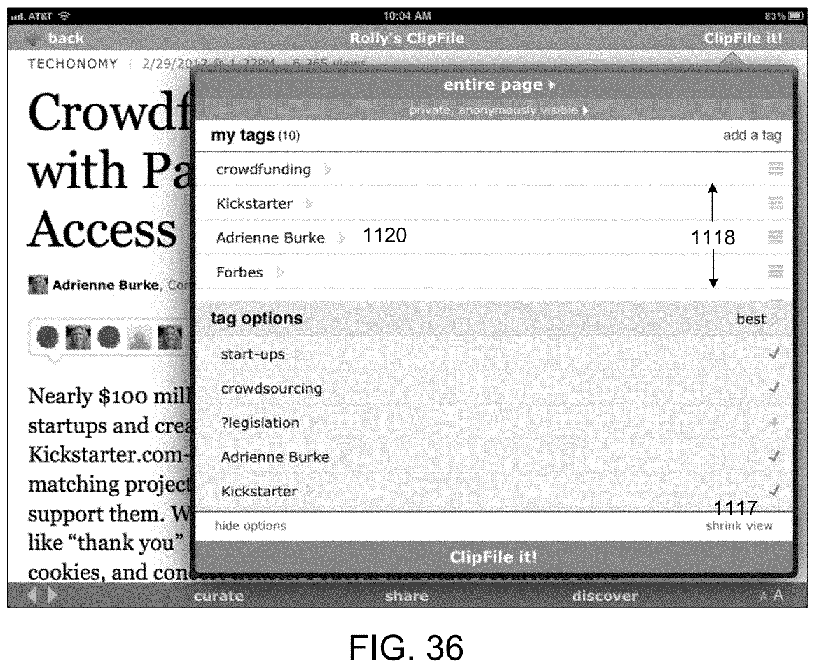

The user may, at her option, hide the list of tag options 1114, as shown in FIG. 35. This gives her a fuller view of her current tags and their current order. She may also expand 1116 the view of tags such that it is easier to read tags, and tag options, that are longer that the standard width of host's bookmarklet widget or pop-up or other functionality (or shrink it back 1117), as shown in FIG. 36.

The user may drag and drop 1118, or otherwise change the placement, of individual tags 1120 to adjust their order. For example, tags may be dragged upward. Tags may be dragged downward. Or their position may be adjusted using up or down arrows, or other appropriate methods.

The user may also add tags on tags to any tag in the list of tags in her tag widget (or through other interfaces and tools for clipping and tagging).

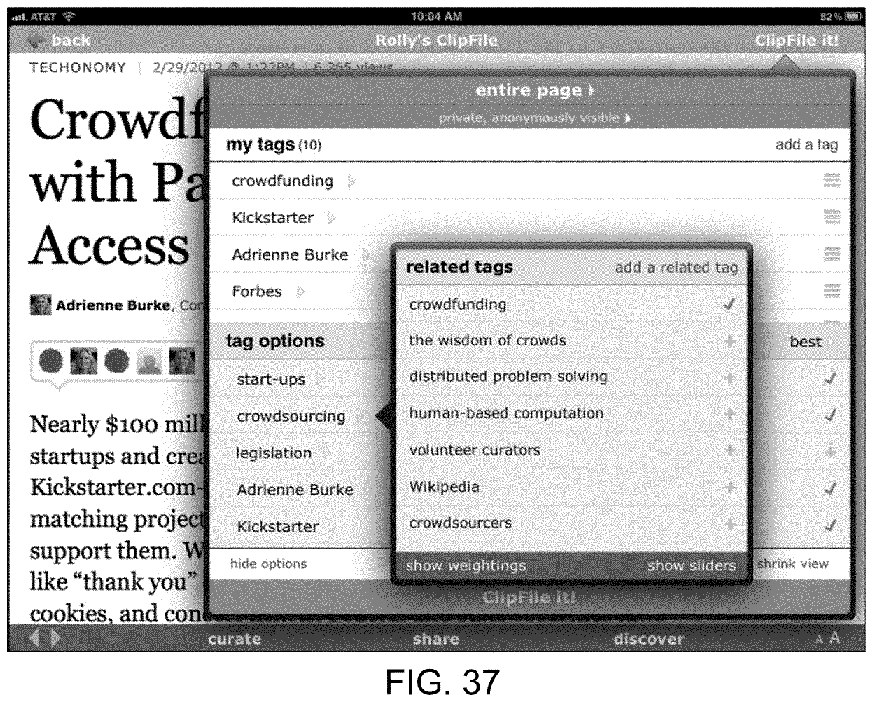

She may view tags that are related to any of the tags, as shown in FIG. 37, whether in her list of tags or within any of the views of tag options. By clicking on an arrow (or other pointer) next to a tag, she may open up a list of related tags (tags related to the selected tag). She may select any of the tags in this list of related tags (including from multiple related tag list views) to select and add a tag to her list of tags, or to a list of subordinate tags for any selected tag in her list of tags. She may also open up an interface that allows her to use these lists to related tags to create and curate (order, weight, etc.) her own lists of related tags (by selecting a related tag from any system list view of related tags or by typing in a related tag herself).

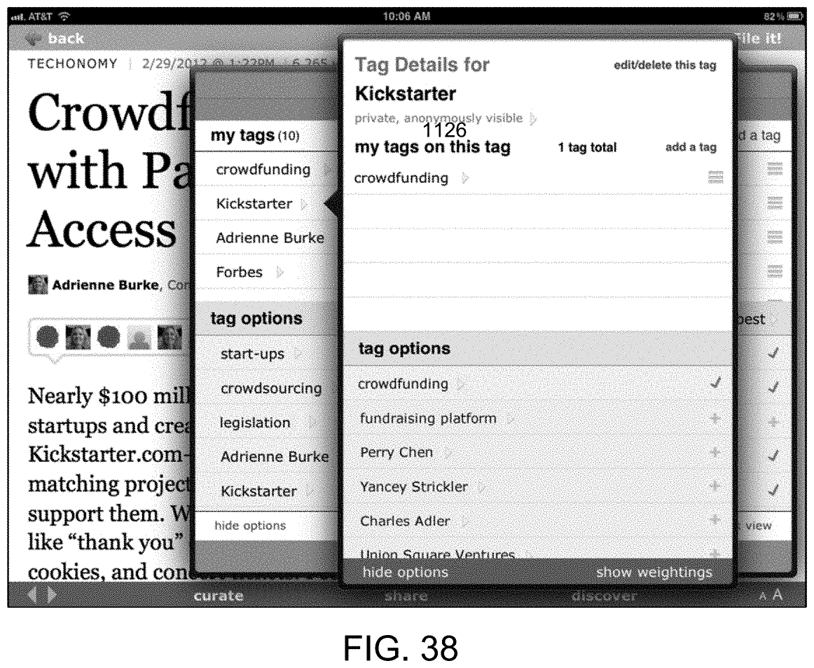

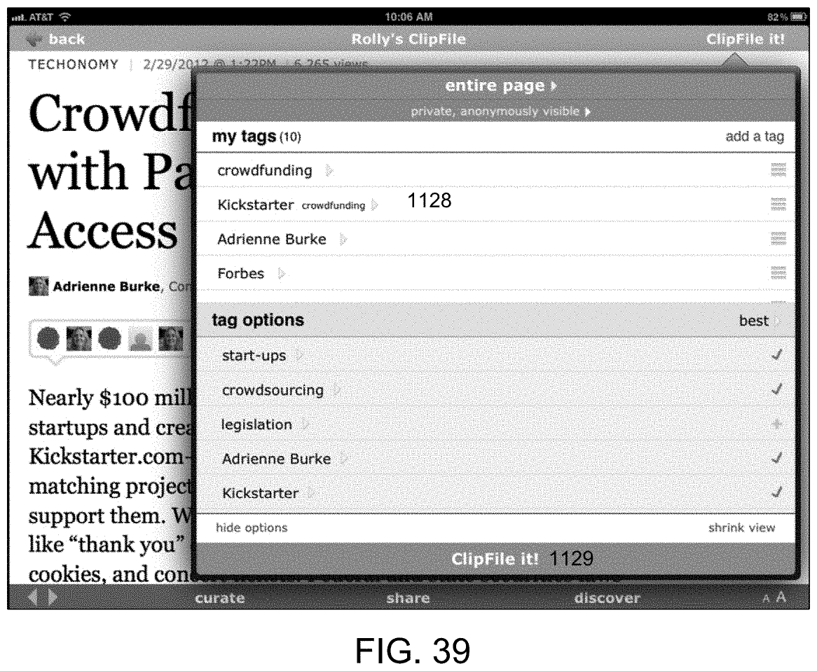

As shown in FIG. 38, the user may also add tags on tags 1126 to any tag in the list of tags in her tag widget (or through other interfaces and tools for clipping and tagging). She may also set the privacy and visibility of any tag, and any tag on any tag 1127. As shown in FIG. 39, once a tag on a tag is added, in some implementations it may be visible next to the tag itself 1128 (and is typically shown using a smaller font).

When she is finished with tagging, she may clip 1129 the item (that is, indicate to the system that clipping is to occur). Whether the item is clipped or not, the tags she has added are thereafter, or until they are revised, associated with the clipped, or as yet unclipped item, in her personal content repository. That is, the tags are saved even if the item has not yet been clipped.

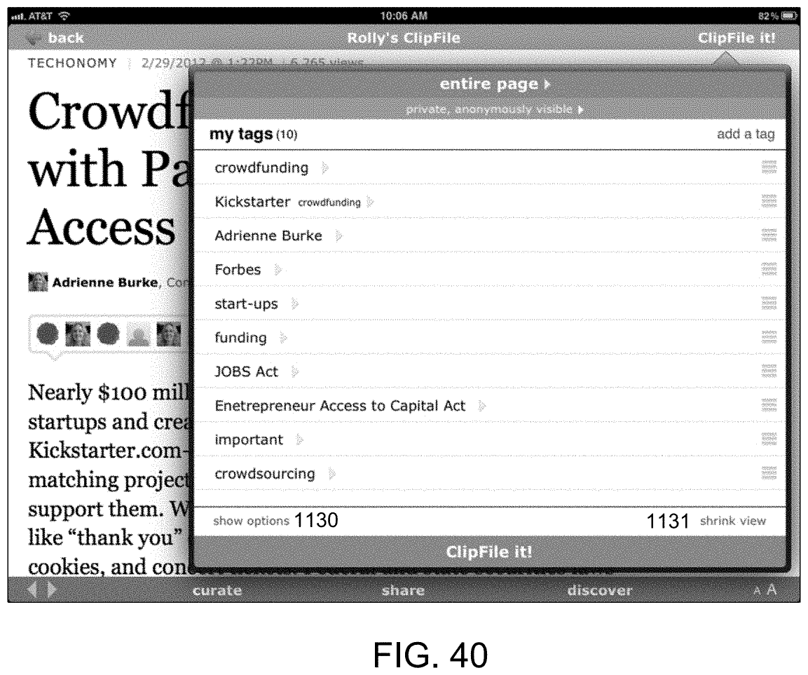

The user may, as shown in FIG. 40, hide or show 1130 the list of tag options. This gives her a fuller view of her current tags and their current tag order. She may reorder her tags, which may be of unlimited number, by dragging them up and down. If she prefers a more compact view of her tags, she may shrink 1131 the view of her tags back to the default width. She may hide the tag options 1132.

The user may add tags to an item and then clip the item later, or tag and clip an item at the same time using the bookmarklet or other tool or content processing facility. Or she may save the item into her personal content repository now by indicating to the facility that it is to be clipped, without adding tags, and later go to her personal content repository (e.g. through a web browser or other interface) to add tags. Or she may return to that item through the bookmarklet or other tool—and add tags later. Or she may add some tags now and more tags later. Although we often use the simple word tags here and throughout this description, we mean to refer broadly to any content identification information, including any kind of observations such as tags, highlights, tags on highlights, tags on tags, and tags on tags on highlights, among other things.

By default, the clips (and text highlights and screen regions and images and image regions) and the associated tags and tags on tags are marked as private, anonymously visible (see below), but the user may select any desired level of privacy for any item of content or grain of content.

Content Curation Widget

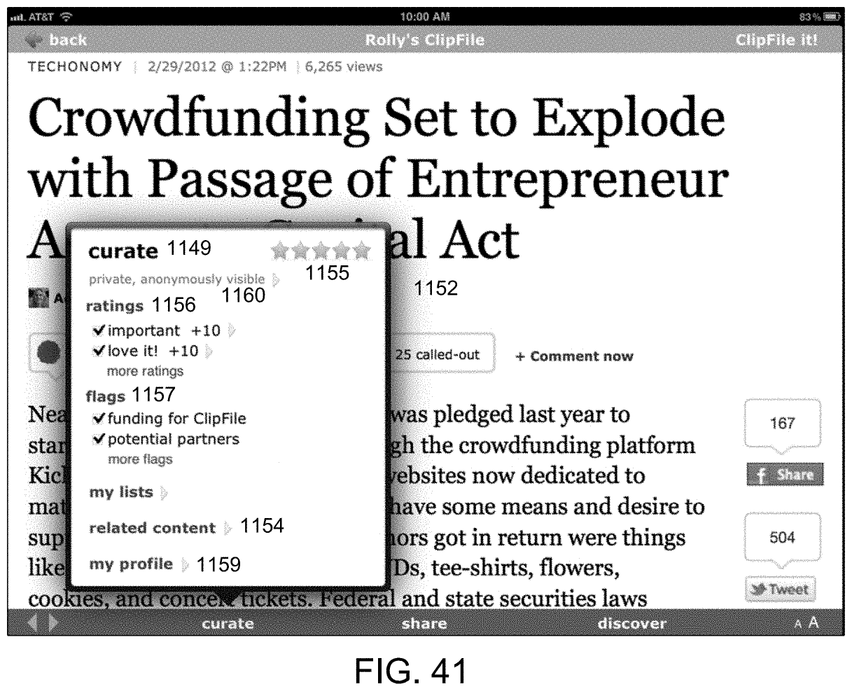

As shown in FIG. 41, the content processing facility may include a content curation widget 1149 that enables a user to associate items of content 1152 with related items of content 1154 (also known as associated content) and to perform curation functions such as characterizing their respective absolute values, and their relative values (that is, ordering in lists), using an almost unlimited number of metrics and weightings, both standardized by the host and user-generated metrics and weightings. Thus, the product of the process of curating is observations and recursive observations on observations.

By enabling the user to bridge across content (for example between individual items of content) and across content delivery platforms, content sources, providers, producers, and owners, the host makes possible new approaches to the curation of content. By incorporating this functionality into the bookmarklet or other content clipping and tagging facilities, the host makes it possible for all users and users of all types to curate content, the relative values of content, and the associations among items of content on the fly at any time and at any place, as part of an unbounded process of content discovery (somewhat analogously to Web surfing), but with greater scope, richness, power, granularity, and nuance.

In this way, the host can enable users to reduce the impact of the silos and other divisions and restrictions that currently impede the consumption, saving (clipping), annotation, and other tagging, sharing, curation and uses of content, and publication—or more limited private use—of comparative content structure and value.

The user may curate an item of content 1152 using star ratings 1155, ratings 1156, and flags 1157 (see below) and may access ordered lists that may include the item of content (or lists to which she may wish to add it), whether those lists be her own or a view of potential lists created by others. All of these are observations and recursive observations on observations.

The user may also associate the content with a specific mindset cluster as expressed in her personal profile 1159, and may set privacy levels 1160 for it.

Publishers, editors, content creators, and other curators of any type may be offered (through host or through partners using our API to build on top of our system) special privileges and special tools within the content curation widget to create, use, and have access to observations.

Users may be as rude, uncivil, and otherwise unconstructive as they desire. However, such behavior will tend to affect how much, or how little, their input is valued (weighted) in our system. Users will be able to identify objectionable content, including tags, that may appear as suggestions (for example, within tag options) and to easily notify the system, and through it our editors. While the source of an offending tag will remain anonymous, repeated unconstructive input (unless it is marked hidden or superprivate) may result that contributor to be weighted lightly or even at a level of zero by our system or by our editors.

Pools of the observations that make up curated content associations (from any variety of sources) may be offered to users to enrich their experience and to improve the efficiency of the process of curating associations. (The structure of this is similar to the structure of our tags options and tag pools.)

Content Discovery Widget

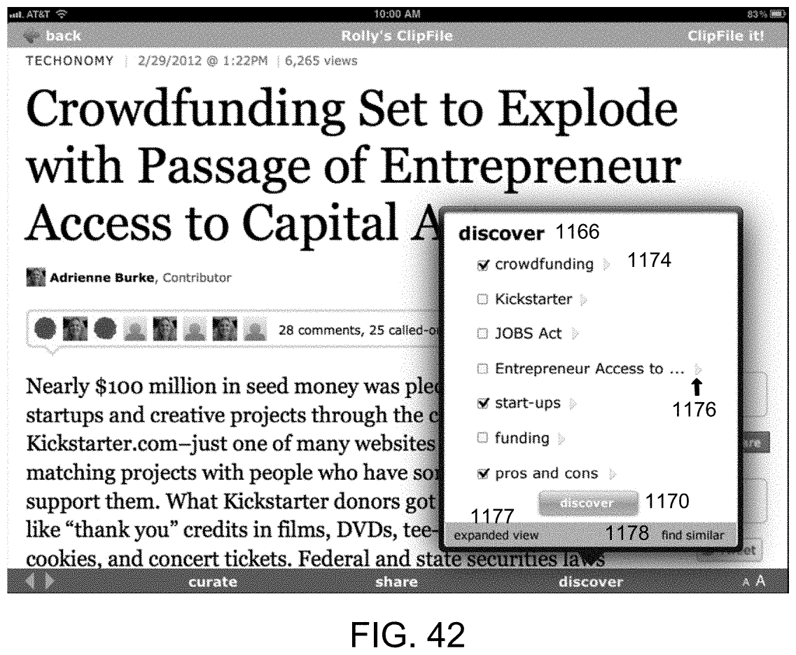

As shown in FIG. 42, the content processing facility may also include a content discovery widget 1166 that enables the user to use any piece of content—whole items, or portions thereof—as a point of departure for discovering related content 1170. The content discovery widget service may be integrated into the clipping widget or may be offered as a separate widget, or may be offered in both places, and may be offered in other places as well. We use the phrase content discovery very broadly to include, for example, any possible activity in which a user hunts for, finds, explores, locates, browses, and engages in any other activity that involves using content itself or to discover other desired content. Content includes entire items, highlights, tags (observations) and combinations of tags, and other factors that are useful for content discovery. Other factors include the user's current mindset, pattern matching against generic mindsets, algorithmic calculations of the importance (and relative importance) of content (including sources, people, and topics) and the similarity of one item of content to another, to name just a few.

The content discovery widget is supported by the host's integrated tag (observation) repository of observations and recursive observations on observations including tags 1174, tag weightings, tag combinations, tag associations, and weighted patterns of tag combinations for a particular item of content, as well for similar content.

In some implementations, the host can determine the similarity (or dissimilarity) of items of content. Similarity may be considered in aggregate (aggregate similarity), or based on specific tags or combinations of tags or clusters of tags or other attributes of the content (contextual similarity), or other factors or any combination of factors. The possibilities, and the potential, for precise or open-ended discovery are almost endless.

The host may also determine families of content (that is, versions of what is essentially the same article, despite variations in source, URL, and title, among others). The hos may also determine and expose clusters of content that are related to (similar to, opposing or contradictory of, complementary to, etc.) an item of content, along with other such valuable views of content.

The system offers powerful opportunities for discovery of content based on observations maintained by the system. The user may discover content using her own tags 1174, individually and in combination. She may use other users' tags of any type from the tag pool, individually or in combination (using checkboxes). She may use any tag (whether her own or from others) to discover tags related to that tag 1176. She may then use any of these related tags to help power her search. As part of an expanded view 1177 (power search), she may refine her search by checking and unchecking tags or by using sliders or other mechanisms to add weightings to, or adjust weightings for, individual tags. Or, if she's feeling lucky, she can open “find similar” 1178 and get a grid (or list or slideshow or any other format) of the content best matches the current content and her mindset, without the need to select any tags or related tags. Other options for searching based on similarity, which is to say based on weighted combinations of tags (and other mindset patterns), may also be offered to users by publishers, editors, authors, and other special curators (as appropriate). Examples include publisher discovery suggestions, author discovery suggestions, editor discovery suggestions, and many others. Curated options for discovery may also be offered to users as a paid service (and an unbounded number of content discovery curators may participate).

Tools for refining search results may be shown on screen or may be accessible through a pop-up window or other method, as needed.

Content Sharing Widget

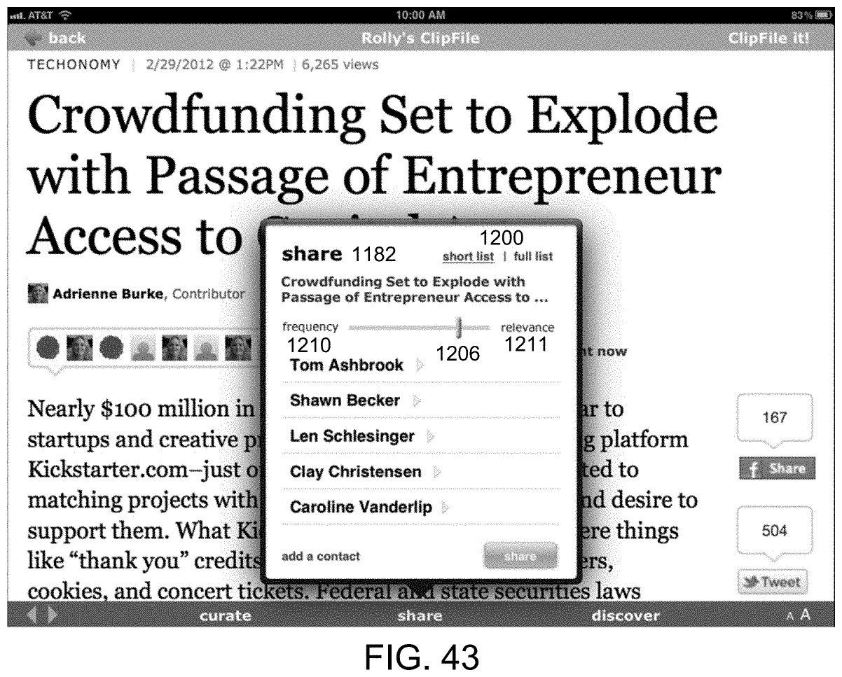

As shown in FIG. 43, the content processing facility can include a content sharing widget 1182 that enables the user to choose to share the content or part of it with others, and to share observations about content. In sharing content using the content sharing widget, she has access to lists 1200 of her contacts (which we sometimes call my network), which is provided and maintained by the host on her behalf. She chooses which contacts to send the shared item to by selecting 1206 these potential contacts one by one, or by selected a group of contacts, or by selecting all contacts, or—in some implementations—by choosing advanced sharing to help her filter an appropriate list of contacts using tags associated with content that the contact has sent or received from the user in the past.

In some implementations, the default list of suggested contacts for an item of content is based on a combination of a) how frequently 1210 she shares with that person, b) how frequently she shares content of this type with this user, and c) how frequently this user shares this type of content with you. Together, b and c represent the inferred relevance 1211 of the content to the recipient. That is, the short list of preferred contacts can be based on any mix of frequency of sharing and relevance of content. (In some implementations, the full list is alphabetical.)

To protect privacy, no exposure of tags of the user to the people with whom she shares occurs except if the contact has conversely (freely) shared those specific tags with that particular user. That is, your visibility into the preferences of one of your contacts is limited to the tags, categories, and topics associated with those items this person has chosen to share with you in the past. Tags, categories, and topics, and patterns among them may indicate potential types of user mindset. Likewise, her visibility into your preferences is limited to the tags, categories, and topics that you have chosen to share with her. In this way, sharing is focused and efficient, and privacy is protected.

When a user shares a clipping (or highlight), the recipient has ready access to the sender's tags. This applies to both tags on the clipping and to tags on any highlights of the clipping, subject to privacy protections. These tags may be presented as the featured list of tag options (the tag options first seen by the recipient). Normally the user first sees the “best” options. In the case of a shared item, the shared tags may begin with the sharer's tags, and may be followed by the “best” tags (which is typically the default view of tag options). The recipient may add any of these shared tags to her own list of tags one-by-one. Or she may choose to grab all of the sender's shared tags, thereby saving time.

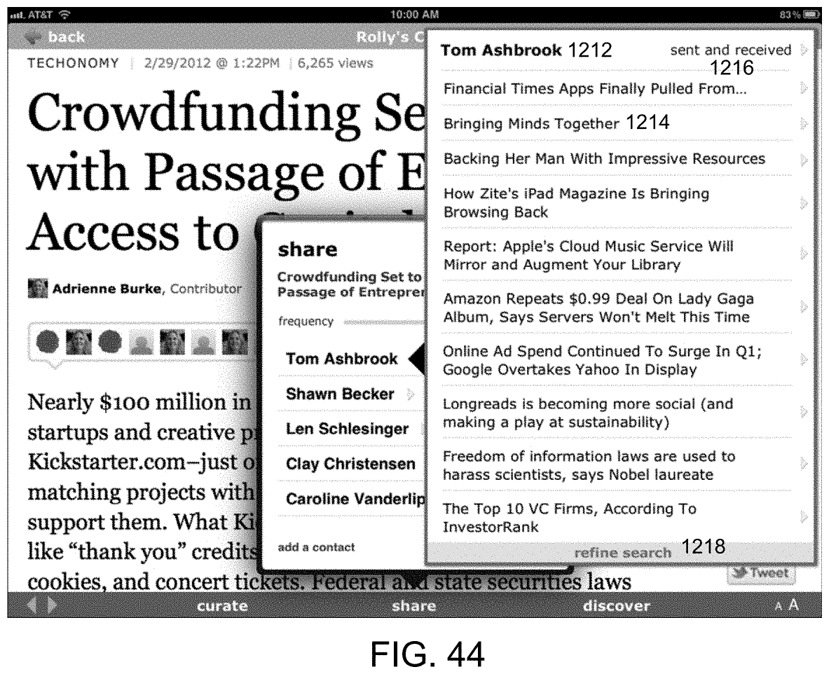

As shown in FIG. 44, a user has access through the content sharing widget to lists 1212 of items 1214 most recently shared. Any of these lists of items shared may include all items sent or received 1216, or only items sent, or only items received. Views of such lists of items may include a) a reverse chronological list of all items shared, b) lists of items shared with particular contacts, c) lists of items shared within a collaborative workgroup (semi-public), d) lists of items shared with any selected combination of recipients. In some implementations, such multi-faceted lists may be accessed using “refine search” 1218.

The user may use a tag chooser, or text search, or a combination of the two to filter the list of items shared or received or both. The user may filter any of these lists of items based on any applicable measure of their importance, or any other rating within host's system, including ratings (see below) added by user. The user may limit her results to entire items, to highlights, to pull quotes, to a specific time period, to a specific type of media or combination of types of media, or using any other filter or combination of filters.

The services of the content processing facility for clipping, highlighting, tagging, curating, discovery, and sharing of content, observations?, and others, can also be integrated directly (as a Web service or other service) into the Web pages and mobile apps and other services and devices and content delivery platforms offered by publishers and other organizations that own and distribute content and by suppliers of the devices. In some cases, the functions can be provided both in an integrated way and in a non-integrated way for use in the same content delivery platform. We sometimes use content delivery platform to include either or both of software or application supported facilities that run on devices and the devices on which they run.

The host offers an API that permits each partner or other user to effect this integration easily and quickly and in a way that permits high levels of editorial control and other kinds of curatorial control, while vigorously protecting user privacy.

When we refer to a partner, we use the term broadly to include, for example, any kind of content owner or content distributor, including but not limited to publishers, colleges, governments or government agencies, businesses, research institutions, hospitals, start-ups, bloggers, and many more. Each partner can make it easy for visitors to their content to clip anything, in part or in whole, from anywhere. The partner may use the host's services to perform editorial and curatorial tasks that make highly granular clipping, tagging, organizing, curating, content discovery, sharing, and other uses of any whole item of content—or any part thereof—easier for users. In some implementations, publishers, editors, authors, and users are curators, but not all users can be editors.

This integrated functionality may include any or all of the features described above and other features, and combinations of them. The functionality may be customized in a wide variety of ways: by reducing or simplifying features, by extending or expanding of features, by adding new features, or by any combination of these three approaches.

The functionality can be integrated directly or indirectly into the partner's Web pages, mobile apps, and other services and devices (we sometimes use the phrase services and devices interchangeable with the phrase content delivery platform) for which integration is possible. By integrated, we mean, for example, to include them directly as part of the functionality of those services and devices, offered and managed by the partner rather than the host. When the functions are integrated directly into such services and devices, communication can occur easily and sometimes natively between them and the host's facilities. This may be achieved through an API or any other appropriate method.

In contrast to “like” buttons or “thumbs up” and “thumbs down” ratings, this approach to integration and to granularity helps each user be much more focused and nuanced in his thinking, content consumption, clipping, tagging, sharing, and other uses of content, among other things. Furthermore, this approach enlists each user's own devotion to self-directed learning, work effort, and sharing. This deeper thought and more sustained attention permits the host to build for each user a more discriminating personal content map. It permits the host to create depth and value across users, as well, based on mindset maps, common mindset patterns, shared mindsets, conflicting mindsets, points of agreement, and tools that bring clarity to differences of opinion. Partners benefit from access to this better-attuned service, based as it is on mindsets, contextual mindsets, and mindset matching, and users have confidence that partners are not permitted to see their preferences.

Partners do not have access to private data on individuals users, but benefit from tremendous new insight into patterns, preferences, and behaviors across users.

Indeed, the clipping can be from physical rather than virtual content (magazines, newspapers, showrooms, museums, classrooms, libraries). The host of the physical content can facilitate clipping in a variety of ways (QR codes and photographic recognition of content, coupled with user location information, or even content scanning). In these cases as well, each user can avail herself of the pool of tags described above for discovery of content and for capturing aspects of her mindsets.

Individual known examples of bookmarklets and browser plug-ins and integrated buttons and other integrated tools that can be employed by users of websites include rudimentary discovery, clipping, and sharing of content.

One feature that makes the content processing facility provided by the host different and more powerful than known examples is how the process for tagging content and for sharing content works. In our content processing facility, among other things, the host adds new granularity and precision and mindset-based pattern recognition and personalization, as well as other features, to the process of tagging, of sharing, and of content discovery as described above.

Our users have at their disposal more powerful tools for tagging. Tags may, of course, be typed in by the user, as is typical with conventional tagging systems. But, among a wide variety of other new available features, our users have access from the tag facility to a deep well of potential tags and related tags, and tags on tags, and lists of potential tags that may be useful as subordinate tags for any given tag in any given context. Users may use the tag facility to navigate, use, or modify for use any of these tags and others. Any tag, and any subordinate tag, in addition to being an observation about content, may also have its own privacy level, star-rating, ratings, flags, and list of subordinate tags, which may be ordered and individually weighted. While none of this is required, (many users will simply clip items and leave tagging to others), a user's ability to easily grab (use), modify, associate, weight, order, and otherwise curate and disambiguate content (including tags) using tags from the tag facility is essentially unbounded.

Pulling tags from this well of potential tags, also called a tag pool or tag options, in the tag facility makes each user's experience more focused and effective. It saves time, and improves the quality, reliability, and utility of the resulting tagging, thereby enhancing the value of the tag facility itself.

The tags an individual user sees are presented in the form of contextually relevant, or personally relevant, lists of tags (or both simultaneously). Each list is sortable. Such tags may come from other users in general, and from specific users or types of users, and from algorithms maintained by the host, for example. The tags are presented as prioritized lists of potentially relevant tags and as prioritized lists of potentially relevant tags on tags and as prioritized lists of tags associated with a tag and as weighted associations of those tags with one another.

The pool of tags may be viewed in a wide variety of ways including the following examples, among others: a) our algorithmic sort of best tags, b) author tags (tags added by—or on behalf of—the content creator, provided these tags have been made public), the union of tags added by all the people in the user's network or the tags added for that item by any individual user in the user's network or the tags added by any combination of users in the user's network for that item, d) the user's tags for similar content, e) all of the user's tags, presented alphabetically, and f) tags that our code and algorithms see within the content itself or infer to be closely associated with the content, or a variety of other ways.

The set of “best” tags may be curated by the host, or a publisher-partner, or based on any combination of inputs. It may be further refined algorithmically to match the user's mindsets, as well as specific observable preferences she may have in the context of particular Web sites or mobile apps, or topics, or author, or any other factor, or any combination of factors. That is, best may be personalized (and in the best sense of the word). That is, lists of tags of any type or variety may be constructed based on a combination—or filtered set—of tags from all users, or of tags that are specific to a user (e.g. the author of the content) or to any group of users. These lists of potentially useful tags may be sorted algorithmically based on likely tag importance (based on individual filters or general filters of combinations of filters), or alphabetically, or in other useful ways.

For example, the sort can be based on general importance (with no personalization), contextual importance, inferred user-specific importance (based on past activity and preferences), explicit user-specific importance, or any blend of these or other sorts.

By offering users one or more pools of choices (tag pools), the host makes the process of tagging work better for users. This is true even if few or no users have yet tagged a specific piece of content.

In some implementations, an initial pool of tags for a piece of content can be created algorithmically and automatically. The content is inspected and parsed by a parsing process of the host. Words and phrases in the content, for example, are matched to the host's pool of topics, categories, and tags (all of which are kinds of tags) for all items of content. In some cases, the match will be exact. In others, an association will be inferred based on a wide variety of possible factors.

Even the author of a piece of content just published to the host's content repository can use the tag facility and inferred content-specific pool of tags to quickly and easily add tags for her own work. This improves the speed and quality of tagging and helps the user avoid unnecessary typing. It also connects the user's current list of tags to the body of tags already in use (by that user and by other users) and to the associations among those tags.

And it permits the user—in the context of the process of adding tags to content—to add, adjust, or remove associations among tags. In doing so, she further builds the integrity and value to her of her own personal pool of tags. In doing so, she may also—in many cases—help to improve the common pool of tags, as well.

The pool of tags may also include information on semantic equivalents, for example: direct synonyms (single words), phrases that mean the same thing (for example “financial results for the second quarter of 2012” means the same thing as “Q2-2012 financial results”), or almost exactly the same thing, and words or phrases that are closely associated but not the same thing. Indeed, when opened using the little arrow or other open icon, any tag—whether in your list of tags or in a tag pool—offers up a list of related tags. Synonyms, “means the same thing as,” and closely associated tags are all kinds of related tag.

In turn, opening up any of the tags in these lists of related tags (each of which may have a user-set associated weighting in addition to the system weighting) leads to another pool of potential related tags. A little arrow or other “open icon” next to each related tag in the pool of related tags for a tag opens up another pool of related tags for the user to select. She may also (as mentioned earlier) open up and curate her own list of related tags for each tag.

The user may engage in a string of hops from a) any selected related tag to b) a list of tags related to that tag to c) a list of tags related to any tag she selects from that list of tags (ad infinitum). When the user finds the tag she wants, she can pop it into her list of tags (or into her tags on a tag) simply by touching (or clicking on) the plus sign (or other icon) to the far right of the related tag.

The user may also use any list of related tags to select a related tag and to curate her own list of relate tags for that tag. This user-curated list of related tags is created by selecting tags from any pool of related tags, or by typing in her own related tags. To this pool, the user may add (or grab from below) her own preferred list and preferred ordering for tags related to another tag. Furthermore, the user may elect to clarify contexts for which different lists of related tags are appropriate. That is, different lists of related tags may be appropriate in different contents, and our system supports curation and disambiguation of such contextual tag associations.

Users (and especially editors and publishers) may view related tags from a single integrated view as well (the tag associations view), permitting further organization, ordering, clarification, weighting and curation of the associations between tags.

Unlike traditional sharing using bookmarkets and browser plug-ins and integrated services, host also facilitates sharing that is personalized and efficient, saving time. The user can call up from the host facilities 1399, her personal database of contacts 1400, algorithmically organized and prioritized based on associated topics, categories, and tags. She can do this from the host Web site or mobile application or from within any Web site or mobile app or any device. Using this database, the user has access to what she has shared with whom, and when, wherever she goes.

Generally, and in most—although perhaps not all—implementations, to protect her privacy and to avoid unwelcome surprises the sites she visits never see this information about her contacts or her sharing (neither what she's shared before, nor what she's choosing to share now, nor with whom). The same is true of her tags.

Unlike traditional sharing using bookmarkets and browser plug-ins and integrated services, the host also facilitates a more granular and personalized approach to discovery of Web sites and pages and content (or mobile apps content or other content) from wherever the user is.

Currently, information is trapped in silos. It is trapped in Web sites, Web pages, mobile applications and the like.

In some implementations of what we describe here, the host uses the content identification information 1402 or other attributes or observations about content (tags, tags on tags, highlights, tags on highlights, tags on tags on highlights) you are visiting—coupled with insight 1404 into your preferences and the projects on which you are currently working—to create a jumping off point to discover similar or related content.

Rather than force the user to leave a Web site (or mobile app or other content)—for example by going to a search engine to search for similar items—the user can explore options using the content processing facilities 1410 such as the host's bookmarklet or browser plug-in or other tools, as described above. After this exploration, she can choose to go back to the original site, to go visit a search engine 1412, to switch to her hosted personal content repository 1414, or to move on to any new Web sites or mobile apps or other content that she has discovered. This new level of integration helps the user stay more focused. It makes the experience of content more fluid and seamless. It improves discovery and saves time.

Finally, from within any Web site or mobile app or other content repository or other content source, the user can call up her entire personal content repository 1414, or any narrower view of her personal content repository. She has access to her record of all items—or portions of items—she has clipped and access to detailed information on all of what she has sharing from her personal content repository or has received through sharing by others into it. She also has access to her clippings, highlights, tags, and more that are specific to any Web site or app (and to any item or topic or source or author or any other tag—or combination of tags—of any variety and in any combination within that narrower repository).

Conversely, when she is visiting her uber personal content repository at the host's Web site or mobile app or other service or source, she can at any time jump to a view of only those items clipped from a particular partner Web site (for example, the New York Times) or mobile app or location or author, which is to say to her site-specific personal content repository 1418, or app-specific personal content repository 1420, or to a wide variety of other possible views 1422 of material in her personal content repository (see FIG. 26), even if the partner has not adopted full integration of the host's services (see below).

### The Clipping and Tag Repository

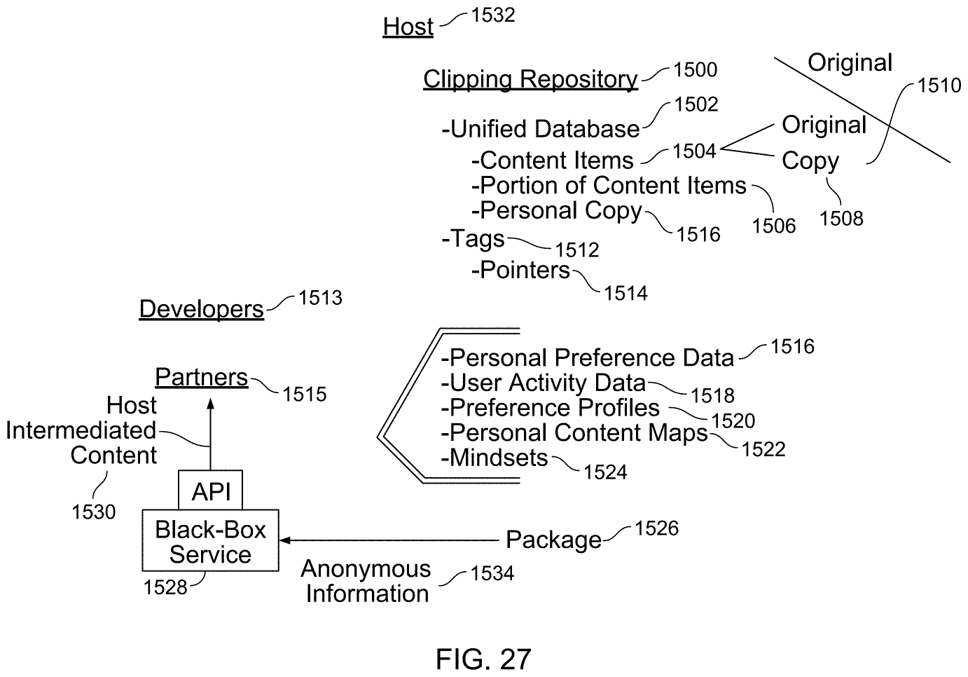

As shown in FIG. 27, in some examples, the clipping repository 1500 is a single unified database for every single item of content 1504, or portion of an item of content 1506, and for each and every piece of content identification information, such as a tag 1512, or highlight, or tag on a highlight, or tag on a tag, or any other content. That is, the clipping repository contains all the content that has ever been clipped and all of the content identification information that has ever been provided or inferred about the content. In such examples, the clipping repository and the tag repository discussed in earlier examples become integrated in a single repository under control of the single authority.

The content in the unified database that serves as the clipping repository can be the “original” content 1510 or can be a copy 1508 of the original content, which itself might be located elsewhere. Tags, for example, can contain pointers to any or all locations at which the corresponding item of content is located. The original content also may reside in many different places: databases, Web sites, mobile apps, content management systems. It resides wherever it has been found and the host creates a permanent record of that location or locations for later reference.

When a user clips an item, the host creates a Personal Copy of the content item and places it in her personal content repository. This way, if content disappears from other locations at a later date, the individual user still retains a single private copy. This private copy is a snapshot of the content at the time it was tagged or clipped or both. In some examples, this copy is for personal use and cannot be shared freely. The clipping repository (we sometimes use the simple phrase clipping repository to refer to the integrated repository that contains both content items and observations) is structured to make possible tight protection of privacy for each user, whether his activities conducted through the host using the host's content processing facilities such as a bookmarklet (or browser plug in or other tool) that interacts with Web sites, mobile apps, and other content, or are conducted through tight integration of the host's clipping, highlighting, tagging, organizing, curating, discovery, and sharing services into a Web site or mobile app or other content source.

Because the host is a single authority that stores, organizes, and controls the clipped items of content—at least in terms of how it is indexed, stored, tagged, curated, shared, and tracked—it is possible for the host to protect the privacy of individual users in ways not previously possible.

In some implementations, to protect user privacy, and to ensure that developers and other partners honor our terms of service, we do not give partners or any users access to individual personal preference data 1516 or user activity data 1518. We do not give them access, not even restricted access, to users' preference profiles 1520 or personal content maps 1522 or context-dependent mindsets 1524.

As shown in FIG. 27, when information is needed by the developers 1513 or partners 1515, we blend together the content—or pointers to content or observations and recursive observations—and the personal data and serve them to partners or developers in a package 1526, through an API-controlled black box Web service 1528, or potentially in a variety of other ways that achieve similar levels of privacy protection. Participating sites, apps, publishers, content creators, content owners and distributors, and other partners and users receive host-intermediated content 1530 (personal content and mixed with other content) through the black box service.

For example, when content is personalized for a specific consumer working with the host's tools at a specific Web site, that site never sees her personal data. This is possible in some examples because the host's tag repository contains both the preference data (user tags, inferred and explicit user mindsets) and the content itself or a copy of the content or a pointer to the content. It is not—in most cases—necessary to offer a partner direct use of the user's personal content map, or to let them directly personalize the content delivery or intermediate which personalized content is delivered. The host serves as the trusted intermediary and each partner receives only anonymous information of sufficiently large aggregations of users that privacy is protected.

This central organization of content is made possible because the content processing facilities provide tools for clipping, tagging, and posting by the user herself. Tags on content items flow to the repository based on decisions, choices, selections, and other activities engaged in by the user, not by the source of the content that is being acted on. The content processing facilities operate independently of and distinctly from the source of the content. Consumers may choose to clip any content from almost anywhere, including electronic or physical locations, and post it to the host's personal content repository specific to that user, without the involvement, permission, or knowledge of the source or producer or owner or provider of the content. Users may do this whether the host powers the underlying presentation of the content or not.

### Applying Mindset Maps to Search Engine Optimization and Marketing

Search engine optimization is a multi-billion dollar business. We permit the equivalent of SEO (and search engine marketing or SEM), but in a way that is more transparent. For example, the author or editor or curator or publisher of an article or other content may choose to clip that item of content and to tag it or apply other content identification information themselves. This creates value for individual users and for users in general. It helps them find content they want more easily. That is, the tags make the process of consuming the content and of tagging the content and of sharing the content more useful. The tagging is clearer, faster, more precise, and more granular.

As shown in FIG. 45, in some implementations, the system builds on these improved tags 1550 to syndicate SEO services 1552 to partners 1554. Others will be able do the same thing by building on top of our system. The SEO services will be created using the tags and highlights and other content identification information 1556 that have been added by content creators 1558, editors 1560, curators 1562, publishers 1564, and other users of the content—wherever it is consumed.

The depth and utility of these tags and highlights and other observations will be greater than is typically the case, and the tags and highlights may be further curated for the purposes of search engine optimization. Our user-responsive SEO services will help Web sites 1566, for example, to improve their search engine visibility, either as a free value add, as a paid service, or some combination of the two.

Partners will a) have access to auto-generated SEO pages 1568, b) the ability to use our contextual tags 1570 to curate new, SEO-friendly content and pages 1572 with much less effort and the potential for better results, and c) to generally make their content more friendly to users, even while improving search engine visibility. That is, we will simultaneously improve the quality of search engine results and add a new user tool 1574 for personalized search that's customized for individual publishers, content owners and distributors, and other partners and is embedded in their own Web sites, mobile apps, and other user experiences, including physical locations.

The tags facilitate personalization of content, and expression of moment-to-moment observations and opinions, for individuals and groups. They express shifting trends.

Our tags also facilitate discovery of content, whether at our Web site or through our mobile applications or through other our content presentations or through the potentially infinite external expression and curation of content by others in their own content presentations, or in the sharing (paid or unpaid) of their content with others.

### High Level View of the System

Stepping back now for a moment, as shown in FIG. 46, the system 3002 that we have been describing can be understood in a very broad sense to encompass a repository 3008 and access facilities 3006. The user, you 3004, takes advantage of the resources of the repository by interacting with the access facilities and also by interacting with commercial content delivery platforms 3010. The commercial content delivery platforms deliver content provided from commercial content production 3012, which uses both outside content 3014 and content found in the repository 3008. The repository contains content, observations, and mindsets 3016. Among important features 3020 of some implementations of the repository are that the entries in it are recursive, granular, protected, comprehensive, stored persistently, and controlled and managed by a single host. The access facilities enable users to consume, create, and share content, observations, and mindsets. Among important features 3018 of the access facilities are that they can be applied universally wide variety of platforms, they allow the user to work in a very granular way, and they protect the user's privacy.

### A User Interface

Here, we describe features of an example of portions of a user interface that enables the user to perform some of the functions described above. A wide variety of devices can be provided in the user interface to achieve these and other functions.

Home Page

As shown in FIG. 47, the host's home page 1590 can provide a feature 1592 to allow new users to sign up or get access to sign-up services. Existing users may sign in, or get access to a sign-in interface 1594.

In some implementations, the home page may be presented so as to allow users to experience content 1596 even before they have logged in. New users may engage in mindset-filtered navigation, tagging, highlighting, clipping, and discovery (but not sharing), even before they have signed up with the host as a registered user.

The content a user can view at this level of presentation may be controlled by a variety of filters, including based on media, type of sort, topic of content, and time period, and by any combination of these filters.

View by Media Type

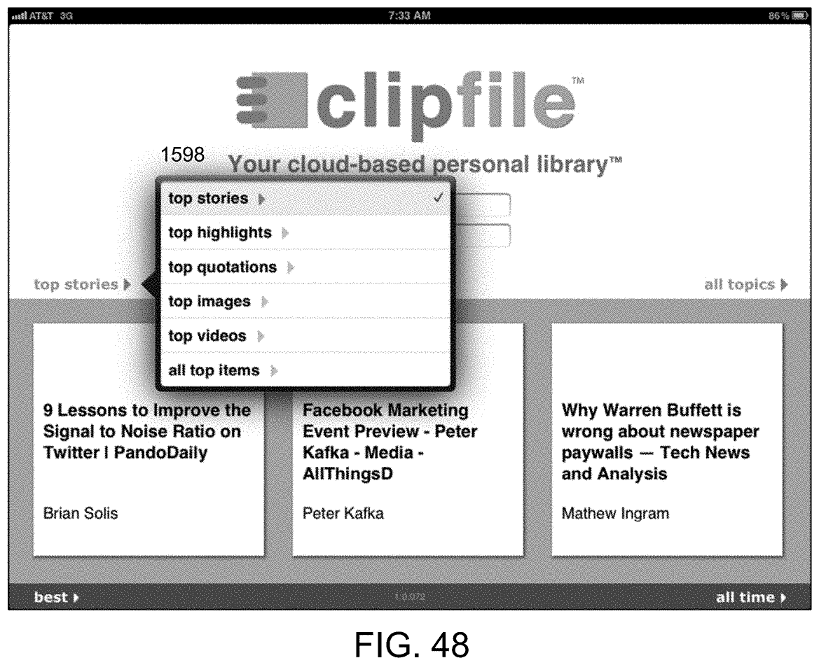

As shown in FIG. 48, the user may view all types of media mixed together. Or she may view content that she has selected 1598 by media type (just articles, just videos, just images, just datasets, just models, or just any other type of content she selects, for example). Or the user may view content by subtype within a media type (for example: photos, graphs, tables, and other sorts of image within the images filter). Or the user may view content based on any combination of filters: photos and videos, tables and graphs, articles and books, graphs and datasets.

View by Topic or Category

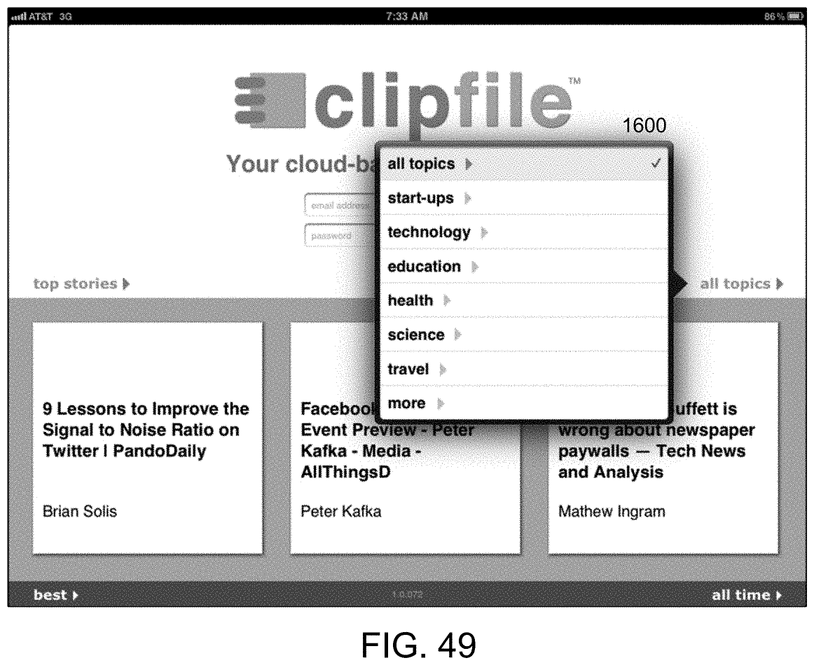

As shown in FIG. 49, the user may view content from all topics or all categories or both, such that this content is mixed together. Or she may select 1600 among a variety of general topics and general categories. Or she may drill down within these general topics or categories and select related topics or categories. Or she may view any combination of these general topics and subtopics and categories and subcategories.

In our system, topics and categories are types of tags. Users may add weightings to tags that express their categoriness and topicness, (that is how appropriate they are as categories or topics), as well as the importance of a topic and the importance of a category (in general and contextually). Or they may rely on the default weightings in our system. Or they may have access to default weightings provided by publishers and other content partners.

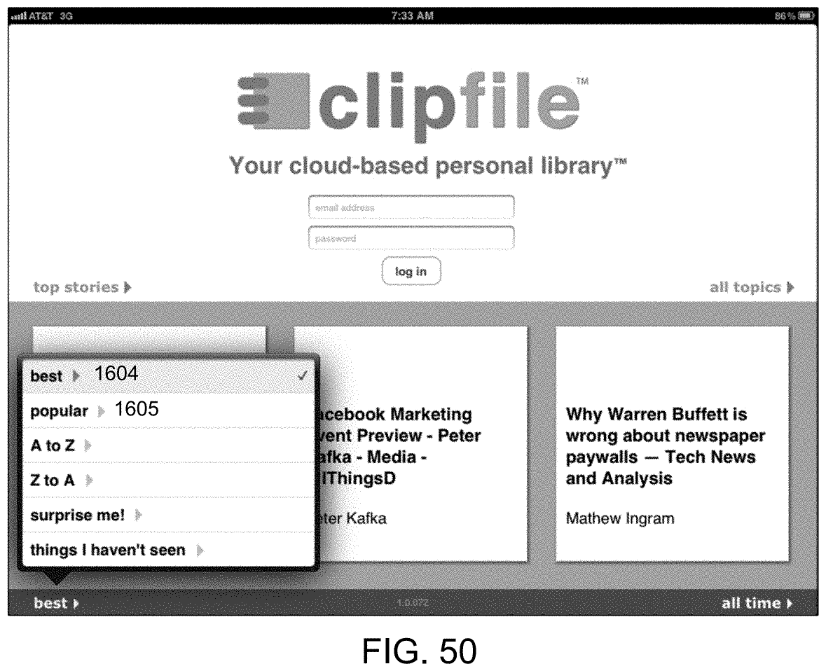

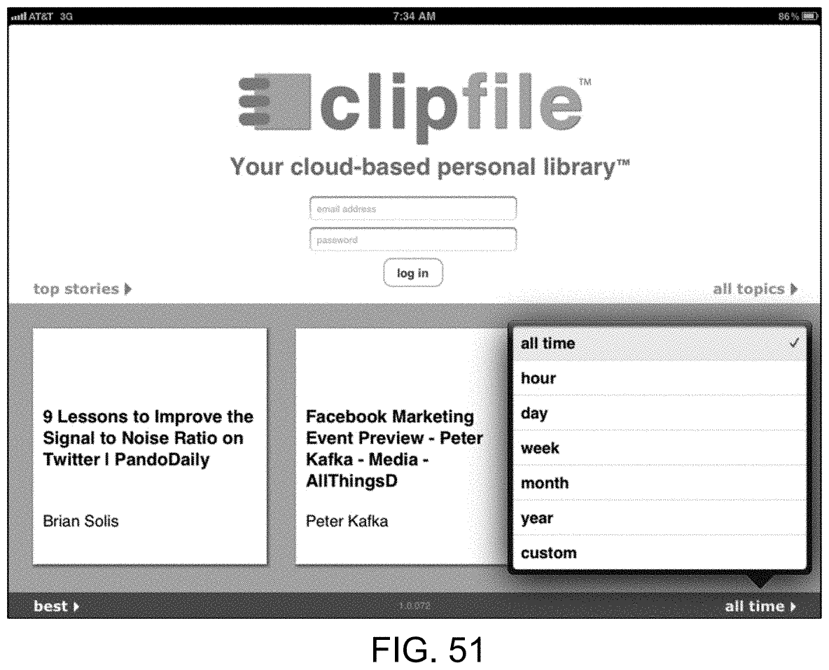

As shown in FIG. 50, she may further sort content by using filters such as “best” 1604 and “popular” 1605. As shown in FIG. 51, the user may filter content based on selected time periods 1606.

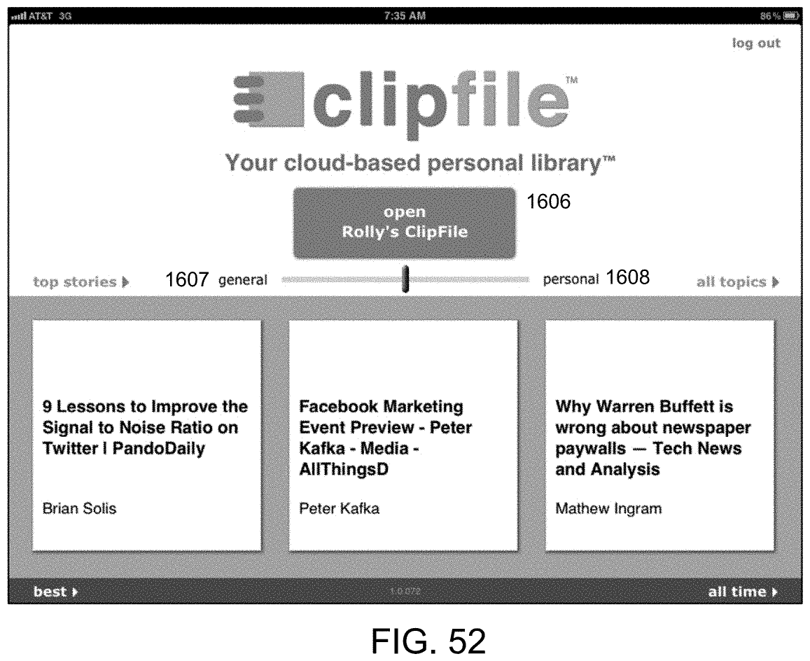

As shown in FIG. 52, the user may log in 1616. She may then choose to view all of her most favored topics (making all of them visible) or all of her favorite topics. Or she may drill down within her own most favored topics and choose one of them, or a subtopic of one of them. Or she may view any combination of her topics and subtopics. And similarly for her categories and subcategories.

Once logged in, she may navigate content generally 1607 (that is, in a way that is not tuned to her mindset) or personally 1608 (tuned to their mindset) or any mix of the two. It also lets her select specific mindset personas or combinations of mindsets, along with other content filters.

My Content Repository Page

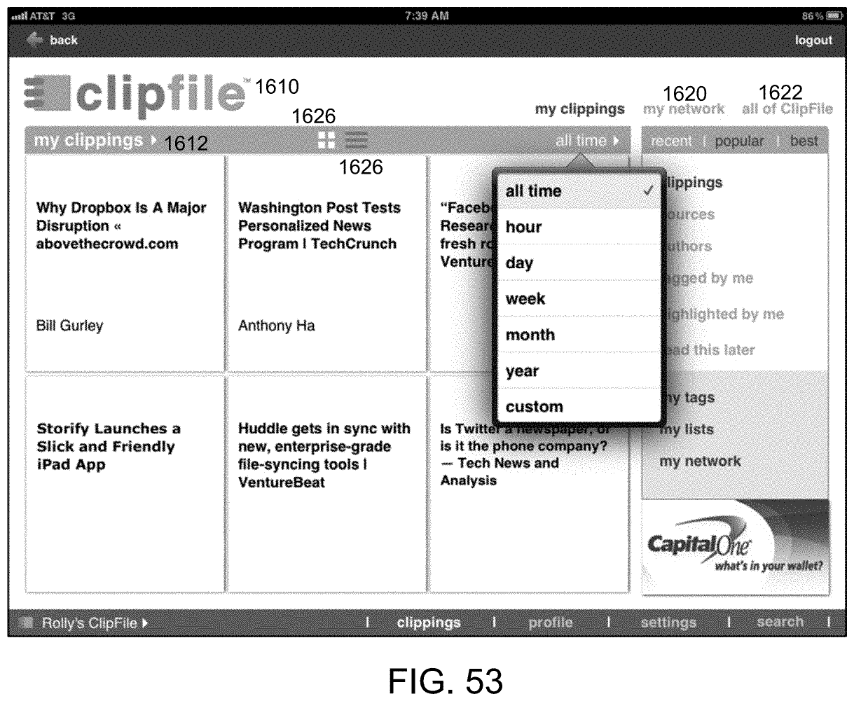

As shown in FIG. 53, some implementations provide a page called the My Content Repository page 1610 (also called my clippings or my host or any other appropriate name) that shows the user items she has clipped 1612 and offers structured, detailed, ordered, rated, searchable information on hers and other users' observations such as tags, tags on tags, highlights, tags on highlights, and tags on tags on highlights. She may choose to view just her clippings. She may choose to view the clippings she has been sent, or that she has sent, or both 1620. She may choose to see (subject to the privacy protections presented earlier) all of the items 1622 that users of the host have chosen to clip.

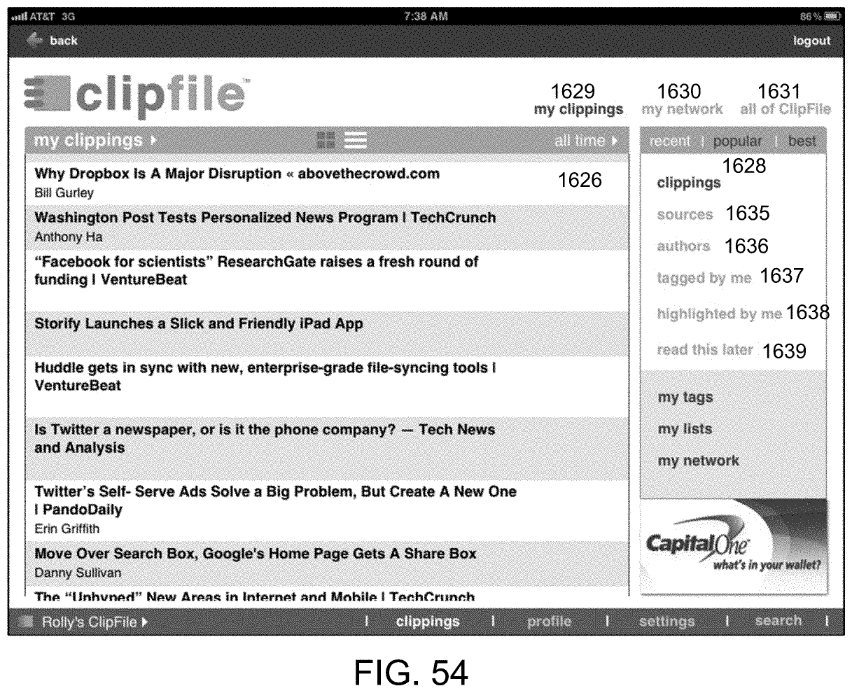

She may view the results as a grid 1624 (of any dimensions) or as a list 1626 in FIG. 54 or as a slideshow (whether manually advanced or automated). She may filter the grid or list or slideshow to limit it to any selected time period (for example, hour, day, week, month, year, custom time period, all time).

She may order her results in a wide variety of ways. Potential ordering includes “best” (with any potential definition thereof, including her own user-specific definition), “popular” (which may be based on her own views and actions, or those of others in general, or on the views and actions of more narrowly-defined groups of users or individual users), “recent” (which is reverse chronological ordering), and alphabetical (either A to Z or Z to A), and many others 1628.

Prominent top-level filters may include “my clippings” 1629 (typically the default), “my network,” 1630 and “all clippings” 1631. (Throughout our discussion, the names used for these features are merely illustrative of intent; a wide variety of actual names may be used by the host and by partners.).

My Clippings

This view shows the items I have clipped 1632. By default the view is usually a grid, although the user may change his settings to make his default view a list or a slideshow or any other available view.

My Network

This view shows the items I have been sent by others 1633. It may also show the items I have sent to others. Or it may show both.

Clippings by Others (Also Sometimes Called All Clippings or All of ClipFile)

Another view 1634 shows all items that have been clipped by all users of the host (subject to privacy protections). For a partner site or app that is powered by the host, the view may show only those items clipped by users of that partner site or app. That is, the definition of Clippings by Others or All Clippings (or any other name that may appropriately be used in their place) is contextual.

Typically, privacy requires that—to be visible to me—a clipping shown in All Clippings will have been marked anonymously visible, or semi-public for a group of which I am a member and have rights as a member to view this item, or public.

Sources (or Guests)

In some implementations, the user's clippings may be viewed by source 1635. For example, a view could be arranged to show me all the things I've clipped from The Wall Street Journal. Or from The New York Times. Or from TechCrunch.

The titles “sources” and “guests” are illustrative. Many other names might be appropriate and therefore substituted, especially in the context of partner Web sites or mobile apps or other content services powered by host.

Authors (or Interviewer)

In some examples, the user's clippings may be viewed by author 1636. For example, a view could be arranged to show me all the things I've clipped that were written by Michael Arrington. Or by Arianna Huffington.

The titles “authors” and “interviewer” are illustrative. David Brooks is an author (usually). Charlie Rose is an interviewer (usually). Many other names may be appropriate and therefore substituted, especially in the context of partner Web sites or mobile apps or other content services powered by host.

Items I've Tagged

In some cases, users may narrow their results to view only items to which they have added tags 1637. They may also identify content for which they have not yet added any tags. They may also filter content based on any specific tag or combination of tags or weightings or ratings or star ratings.

Items for which I've Added Highlights

In some instances, users may narrow their results to view only items to which they have added highlights 1638. They may also identify content for which they have not yet added any highlights. They may also filter content to find highlights based on any specific tag or combination of tags or weighting or ratings or star ratings.

Search for Flagged Items

In some examples, users may narrow their results to include only items that include a specific flag (a specialized kind of tag that we describe in detail below). Flags are used to keep track of a) your projects, b) special notations such as “read this later” 1639 or “tag it later,” and c) kinds of highlight (lede, conclusion, nut graf, pull quote, among others).

Text Search

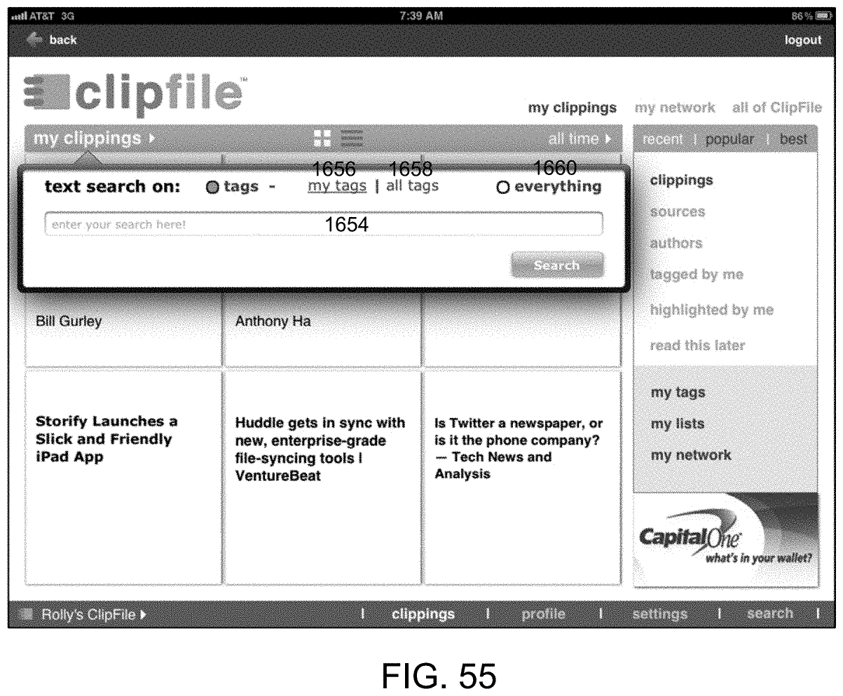

As shown in FIG. 55, from within any of these views and any others, the user may execute a text search by entering the text into a search box 1654. Access to the search box may be triggered in a variety of ways, including touching or clicking within a search box 1654, touching or clicking the word “search” (or any similar words or buttons used to initiate search queries) 1658, and by clicking on “my clippings” or “my network” or “all clippings” (or other words host or its partners may elect to use) in the interface navigation just above a grid or list or cameo view or slideshow or other presentation of content. In searching, the user may choose to execute the search against her own tags 1656, against all visible and anonymously visible tags from other users 1658, or based on full text in the content 1660, and in a wide variety of other modes. Users may also initiate an advanced search.

When a search is executed, a pop-up or other controller permits the user to further define the scope of the desired results. In one implementation of this controller, the user chooses to see My Clippings, My Network, or All Clippings. The user may also elect—before choosing My Clippings, My Network, or All Clippings—to refine the media type (or mix of media types) desired and time period covered (hour, day, week, month, custom). The default settings in the current implementation are “all media” and “all time.” Users may choose different default settings (within Settings). In the future, many other potential choices of pop-up search filters are possible and may be used.

Item View, Web View, and My Personal Copy

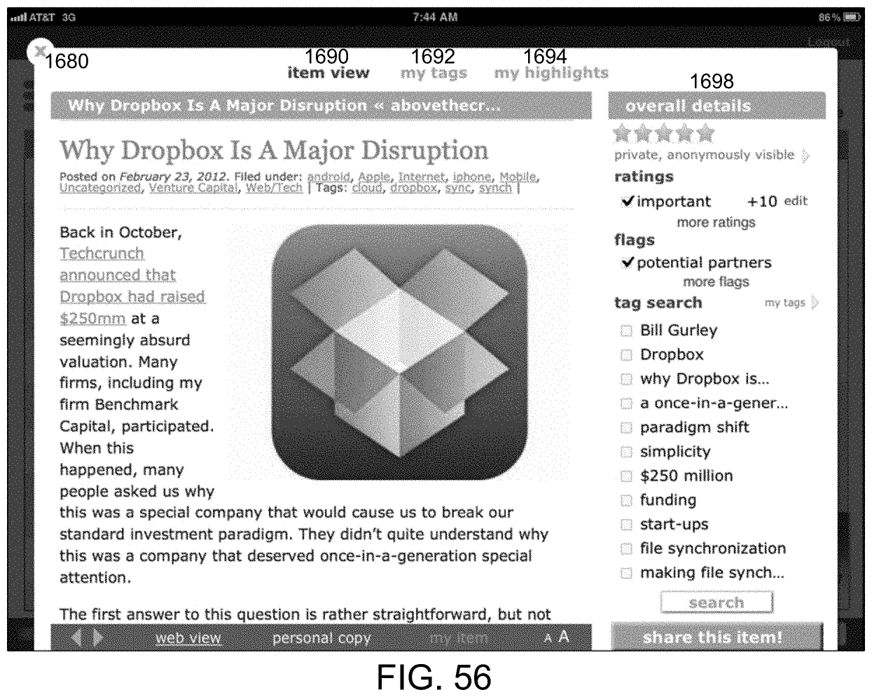

Referring to FIG. 56, an item view 1680 can be reached by clicking or touching an item in the grid or list or slideshow view. In the item view, some implementations may offer three views of information about this item: an item view 1690, a tag view 1692, and a highlight view 1694.

The item view shows the Web page or other item of content 1696 or grain of content or in some cases more than one item of content. It includes a sidebar 1698 that may be permanently visible or opened as a pop-up. The content may be resized to full-screen and shown without any visible on-screen functionality (or with very little). Or it may be viewed full screen but with the functionality described above in the section on bookmarklets. The sidebar is described below under “my tags.”

The content may be viewed in a wide variety of ways. For example, if the content is a “page” from a Web site or mobile app or other external source, it may be shown as a “Web view” (or it may be described with any other appropriate word or words). If it is a piece of content you have added directly to host, e.g. a note or a photo, you can view it as “my content” or “my item” (or other words).

Whether the content comes from an external source or from the user, we also create a special, annotated view 1700 called “my personal copy” (or other names, as appropriate). My personal copy is a powerful tool. First, it ensures that, if the content comes from an external source, you have and can view your personal copy of it. That way, if a Web page goes away, or is modified in terms of its content, or is modified in terms of its look and feel, or if the URL or other pointer to it changes or “breaks,” you retain a copy of it for your personal use, (and only for your personal use), if you so choose. Your personal copy, among other things, captures and preserves for your future use exactly how the content looked and what it contained when you clipped it. (You may, of course, also view the current version of any content by linking to it, or using other methods offered by host.)

The personal copy is—by design—a snapshot at a moment in time, and it may be viewed in a variety of ways. It may show a screen grab of the content at the time you clipped it. It may show the HTML and CSS and other structure of the content. It may show the content in other potential formats. It may show the content stripped of advertising and of navigation. It may show text only or text and photos (and tables and graphs). A wide variety of other approaches can be used and combinations of them.

The user may choose to view her personal copy using any of the available fonts, fonts sizes, and font spacings she prefers. She may view her personal copy such that her tags are visible or hidden. She may view her personal copy such that her highlights are visible or invisible. She may view both her tags and her highlights (overlaid on top of one another). Other views may be added in the future.

The personal copy is designed to offer a new framework for retrieval, visualization, and annotation of personal content. With the permission of the content owner, the personal copy may be shared. Without permission, it typically may not be shared. (Exceptions may include cases in which the content is generally available for free, and others.) Thus, we are building a tool that simultaneously enhances the user experience and protects copyrights. Indeed, copyright holders may use the host to offer users the ability to pay to share copyrighted material with others. Unlike paper copies, PDFs, and links, such sharing will be fully tracked (privately). The anonymous data collected by host may also be of value to copyright holders.

My Tags (on an Item)

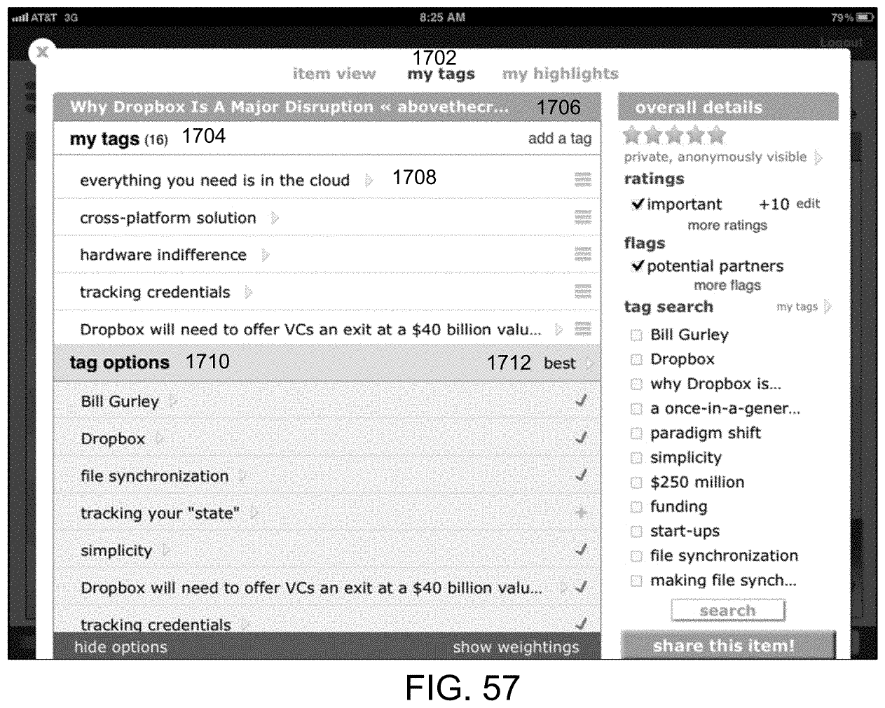

As shown in FIG. 57, an additional view of an item is the tag view 1702 also called “my tags.” In the tag view, the user sees the tags 1704 he has added for this particular item 1706, whether the tags have been added using our dot-tag e-mail mark-up or using our bookmarklet or browser plug-in or other tool, or whether the tags have been added using the host's services integrated into a Web site or mobile application or other content-related service, or whether the tags have been added directly through the host (on the Web or using a mobile phone or tablet or using another device or method).

The tags are presented in the order 1708 they were added, as most recently modified using drag and drop. The user has easy access to the pool 1710 of tags for this item, as described above, including best tags 1712 (using any definition of best), tags from the author (if available), tags by the user for similar content, tags by the user in general, tags for this item from your network or from individuals within your network (subject to privacy protections), tags for this item from all users, and many more.

A private history of all revisions by each user is logged and may be made made available to her, for example to roll back to an earlier version or to visualize progress, or for other purposes.

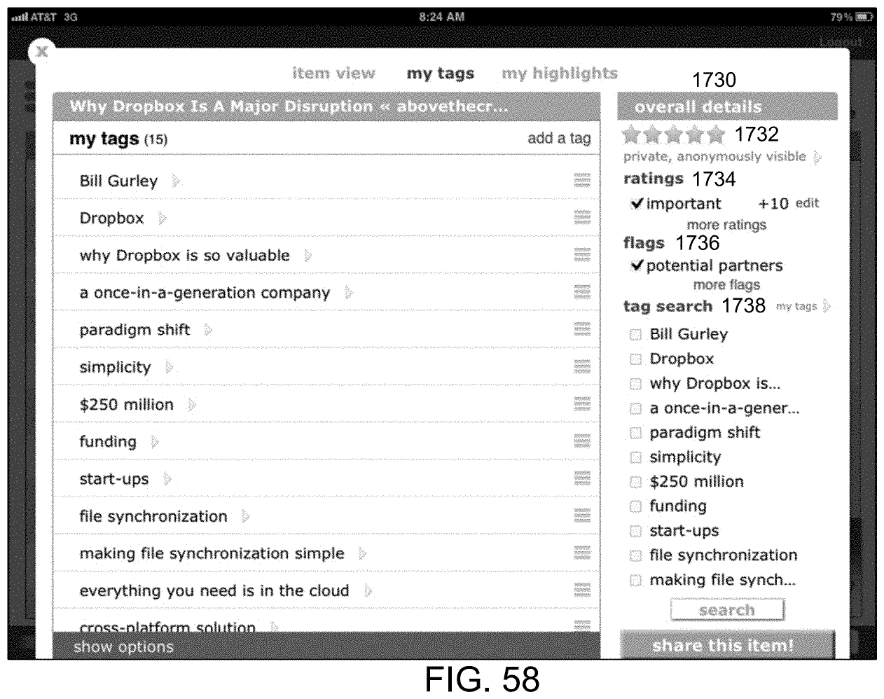

The tag pool may be concealed or hidden, as shown in FIG. 58. In some circumstances, it may be expanded so that longer tags are more fully visible. The user may add tags on tags, and tags on tags on tags. Ad infinitum. Privacy and visibility, for entire items of content and for any grain of content associated with them, may be controlled differentially.

In landscape view, a sidebar 1730 for star-ratings 1732, ratings 1734, flags 1736, and tag-based searching 1738 is typically visible (but may be hidden in some circumstances). In portrait view, this sidebar is typically hidden (but may be visible in some circumstances).

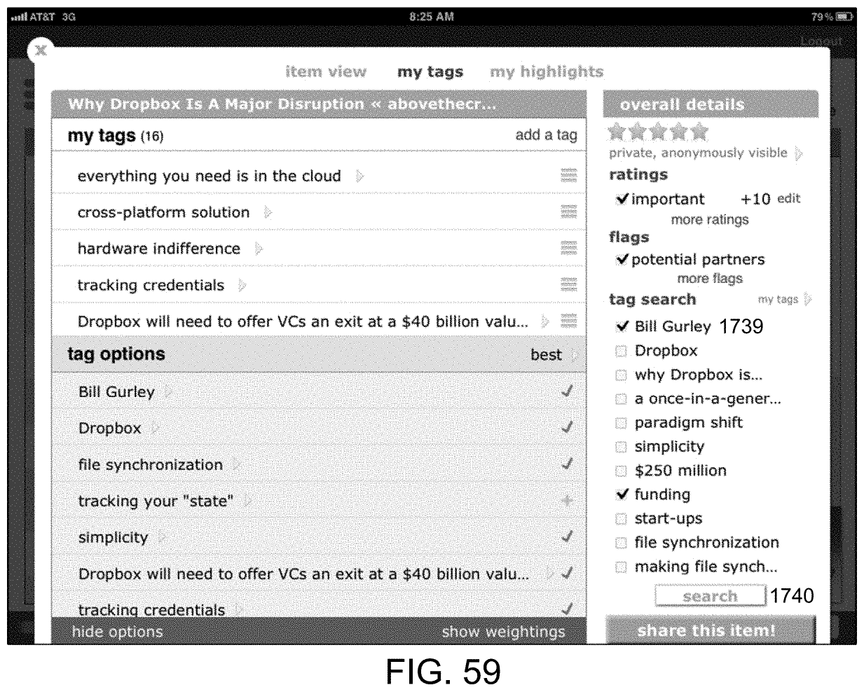

As shown in FIG. 59, the user may select tags 1739 in the sidebar and click search 1740.

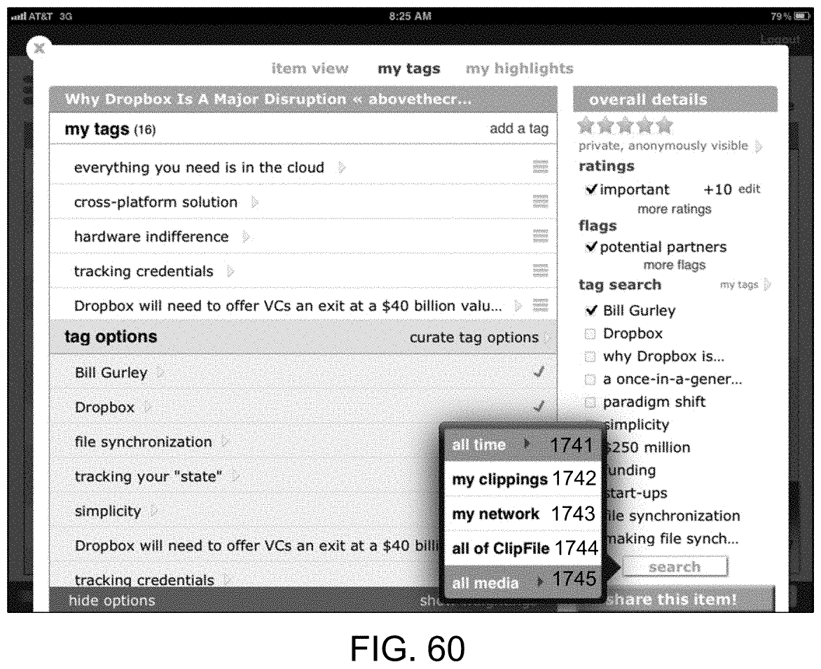

As shown in FIG. 60, a pop-up permits choices about the scope of the search (my clippings 1742, my network 1743, all users 1744), as well as choices in terms of media and time frame. In some implementations the defaults are “all time” 1741 and “all media” 1745.

The user also has access for any tag (or tag on tag, etc.) to a pool of related tags. Related tags, which we also sometimes call tag associations, are tags that have numerical weightings (from the host or from the individual user or from the publishing partner or from others or from combinations of them). Such weightings may suggest a strong or weak association of a tag with another tag. The weighted association may be of a variety of types, include a general association, a contextual association, a potential identity (in general or contextually) as a synonym for the tag or as “means the same thing as,” which is not quite the same as a synonym.

In viewing related tags or associated tags or contextually associated tags, the user may see—or choose to see—the weighting for the association or other relationship that has been provided by the host (or a partner). She may also add her own weighting, in which case both her weighting and the general (from the host or partner) weighting may both be made visible. If she adds a weighting that is different from the weighting in our system, our system will (as a default) respond to her activities using her weighting, not ours (or a partner's). This will alter the orders of tags and algorithmic searches and pattern matching performed of her behalf, among other things. How users have adjusted their weightings will be visible to the host anonymously and in aggregate (unless the data is public), and may be used by the host (or by partners) to guide both human and algorithmic changes over time to general weightings.

The tags on tags feature also gives the user access to a tag pool, in this case of potential tags on this tag. The tag pool feature offers may different views, including tags on this tag by the author, by the user elsewhere for this content, by the user elsewhere for other content, by the user's network (collectively, individually, or in any combination), and by all users (subject to privacy protections).

The user may edit or delete tags, and tags on tags, and tags on tags on tags, at will.

My Highlights (on that Item)

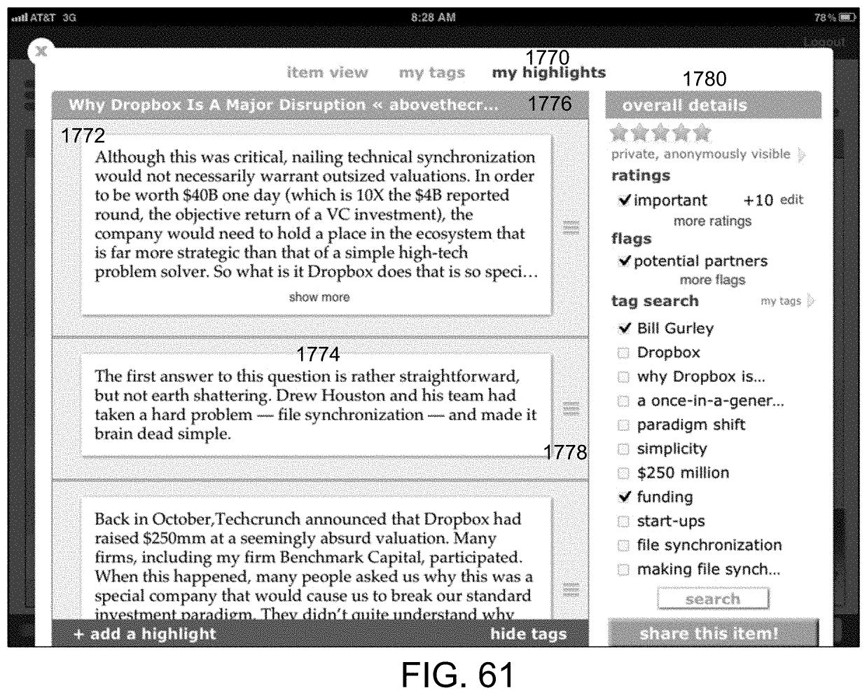

As shown in FIG. 61, the “my highlights” feature 1770 shows the user an ordered list 1772 of the highlights 1774 she has created for an item 1776 she has clipped. The highlight may be, for example, a section of text, or a portion of a page, or a cropped element of a photo or other graphic or a video, among others. The order of the highlights may be changed using drag and drop 1778, or through other functionality that permits reordering. The view of the highlights may be filtered in a variety of ways so that only some of the highlights are visible. In some cases, this ordering of highlights will be different than the order in the original content or in the user's list of highlights, or both.

The user may create a new highlight by copying and pasting text from, for example, a Web page. The user may create a new highlight by selecting text or an image region from her personal copy.

The user may create overlapping highlights and highlights within highlights. Features may be provided to enable the user to enter any possible kind of content identification information.

In landscape view, “my highlights” typically shows the same item-level tag overview sidebar 1780 as was discussed above in item view, although this sidebar may in certain circumstances be hidden. In portrait view, “my highlights” typically conceals the tag overview sidebar, and the user may drill down to open it. (In some cases, the tag overview sidebar may be visible in portrait view.) As with the item view, the user may add a star rating and may set the overall visibility (privacy) for the item. The user may add ratings, flags, tags, and tags on tags.

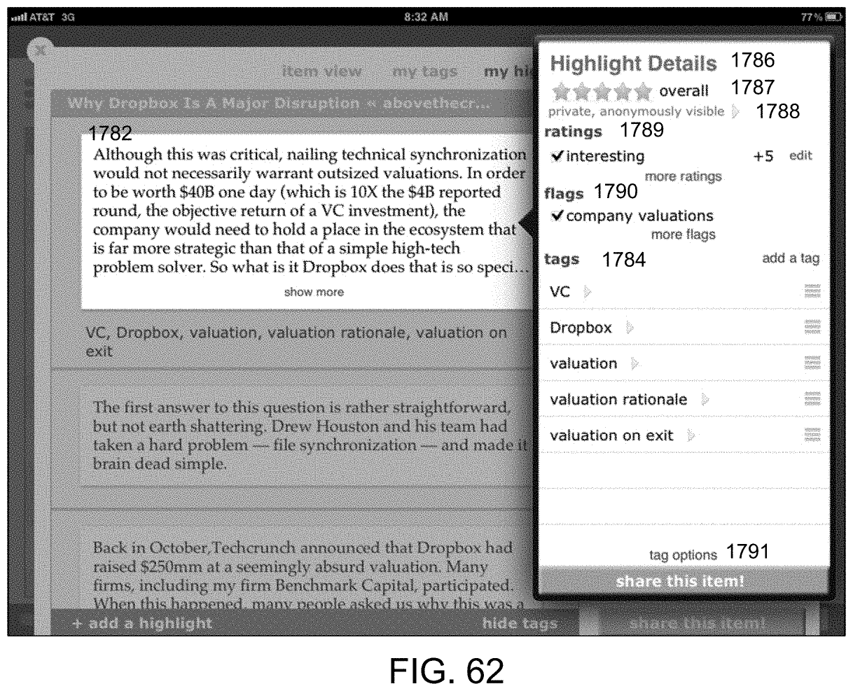

As shown in FIG. 62, the user may select an individual highlight 1782 and may add tags 1784 specific to that highlight and that highlight alone. In this case, in landscape view the tag overview sidebar is concealed by a “highlight details” pop-up 1786. The pop-up lets the user select the star rating 1787, privacy setting 1788, ratings 1789, flags 1790, tags, and tags on tags for that specific highlight. The user also has access to a tag pool 1791 (sometimes called tag options). The tag pool is viewable in many different ways that are designed to be appropriate and helpful for adding tags to that specific highlight.

The user may add a tag to any tag in her tag list. This view (tag on tags) also includes access to a customized array of useful tag pools. She may also add tags on tags (and tags on tags on tags, ad infinitum).

The user may add star ratings and ratings to any item of content and to any content highlight. She may build her list of ratings using suggested words (love, important, agree, etc.), or she my build her own list of words (and their opposites).

The user may add flags to any item of content and to any content highlight. She will typically build her own list of flags. One useful default flag is “tag it later.” User can build her own list of ratings, or use standard ratings, or use a combination of the two. The user can reorder her ratings list for any particular item. She may choose to have these changes stick (become the default) or not. She may choose to have different default ratings that apply in different circumstances.

By default, words and numbers flip for negative numbers. That is, as the ratings slider goes negative, the word Love becomes Hate and the number begins to rise, rather than fall. The user may also adopt settings such that the words and numbers do not flip.

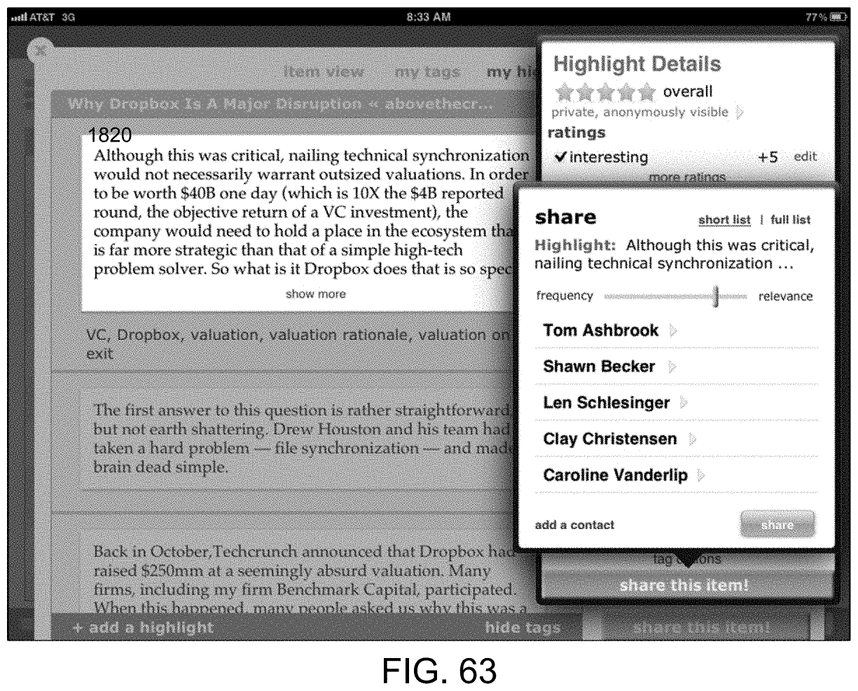

As shown in FIG. 63, a user may share any highlight 1820 (using the sharing functionality discussed previously).

My Tags

The user may use our “my tags” functionality to gain insight into the tags, categories, and topics she has used or that she prefers or both. She may use her own tags to search for items or highlights associated with those tags (whether within her own clippings or elsewhere).

The user may view her tags alphabetically or reverse chronologically or based on frequency of use, or based on other inferred types of importance, or in a variety of other ways. The view of tags may be limited to a specific time period (hour, day, week, month, year, custom) or may be across all time.

The user may filter the view of his tags to include sources or to exclude them. He may filter the view of his tags to include authors or to exclude them.

The user may filter the view of his tags to include or exclude a) tags on highlights, b) tags on tags, and c) duplicate tags (whether at the top level, or within tags on highlights, or within tags on tags.

The user may filter the view of his tags to include only tags associated with particular types of content. For example, he may choose to see only tags associated with (via a Flag) the Shakespeare paper he is writing for Freshman English. In addition to permitting filtering for ratings and flags, this scrollable list of filters may include filters for his top topics and his top categories.

In some implementations, at the top of the filtering sidebar (pop-up in portrait mode), the user may use a text box to filter results.

The user may search for entire clippings, or for highlights, or for both simultaneously.

The user may check off any of the tags that appear, as constrained by the filters, and may use that specific combination of tags to execute a search for content. As usual, the search request may be (and is typically by default) interrupted by a pop-up that asks the user what kind of search results he'd like to see. The results may be further filtered by media type and by time period. The defaults are “all media” and “all time.” The user then chooses whether to get search results that match “my clippings,” “my network,” or “all clippings.” Many other implementations are possible.

For any given tag, the user may see a list of the items associated with that tag (in any order of importance) and the people with whom he has shared content that matches that tag. The lists of items or people may be sorted based on recency, frequency, and alphabetically, as well as in other ways.

The user may also view tags related to any tag and may choose to search based on the related tag, rather than on the tag itself. He also has access to related categories and to related topics.

This system gives the user insight into his own use of tags (and therefore into his mindsets), as viewed from many different potential perspectives.

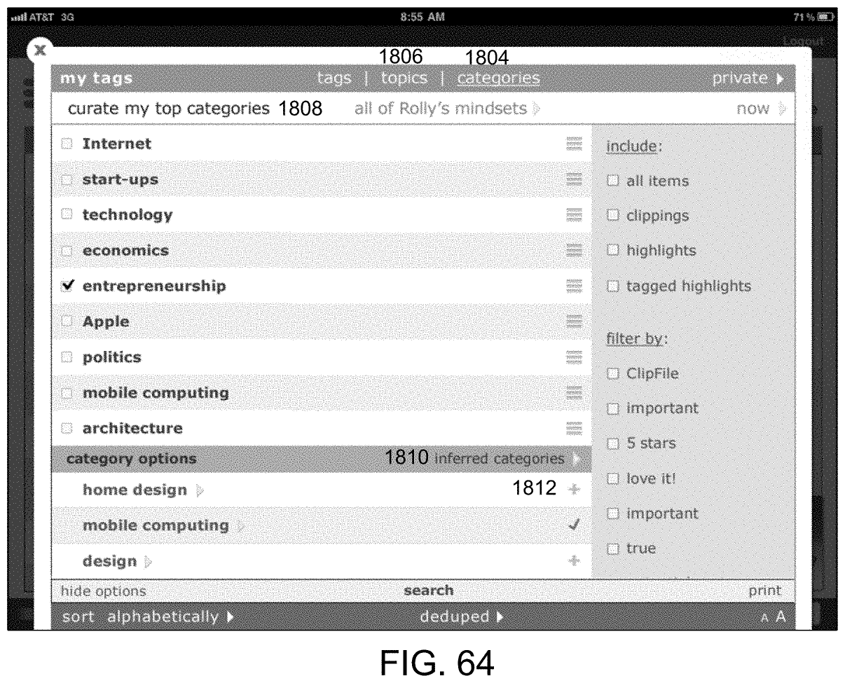

As shown in FIG. 64, the user may also view his categories 1804 and his topics 1806 (which are, after all, just types of tags).

Within this view of categories (which may be narrowed or expanded to cover any time period), the user may choose to curate a list 1808 of top categories. For any selected time period (or other filtered refinement), he is shown his inferred top categories 1810. These are selected by algorithm. He may then use this inferred list to create an explicit list. He may add an inferred category 1812 to his top category list by clicking on or touching the plus sign next to a category in his inferred category list. Categories that have already been selecting have a check mark rather than a plus sign. Categories that are added go to the bottom of his explicit list of categories. The user may then adjust the order using drag and drop, or another appropriate technique.

The user may view his list of categories with or without weightings.

The weightings associate an absolute value with a category. The weightings may be presented as sliders. The default weightings center around (above or below) zero percent, 10 percent, 20 percent, 30 percent, 40 percent, 50 percent, 60 percent, 70 percent, 80 percent, 90 percent, and 100 percent. Ten percent increments is equivalent to star ratings where half-stars are also considered. We call this approach ordered clustering. Most people can't easily discriminate between a weighting of 73 percent and 74 percent. But they can put something roughly in the 70 percent cluster and work from there.

What we're doing is bridging a silo in the user's mind. The silo is between a) a relative ordering approach and b) an absolute value. We're making it possible for these to work together, without getting either too rigid or too flexible.

In our system, ordering generally trumps weighting, but we keep close track of both. We let users do things that are contradictory and then we infer useful things from the fact that they did.

Scales for ordered clustering can also be in 25% increments, in 5% increments, in 2.5% increments, in 1% increments, and on finer-grained scales, as well as others.

My Lists

The “my lists” view lets users (including professional content curators) create and curate lists. In a sense, this is somewhat similar to the lists of categories and topics describes above. However, these are the sorts of lists most people think of creating (shown as grids or lists or slideshows). Examples include:
Best articles I've read
My favorite books
My favorite movies
My favorite photos
My favorite videos
My favorite sources
My favorite authors

For example, if you're ordering lists of articles, you might choose to set your filters at “best articles” and “all topics” and “all time.” Or you might choose “best articles” and “technology” and “this month.” Or you might choose “best articles” and “iPad” and “this week.” Or today.

Our system keeps track of all the lists you create, and all the incremental changes to these lists over time. Thus you have access to both a full history of snapshots of your lists and to saved versions of them (snapshots) you have deemed to have special importance (through the act of saving them and—optionally—naming them).

Users can start with inferred lists. This is similar to a tag pool, but in this case the inferred list will be an algorithmically ordered list of articles you have clipped. You'll be able to view this pool of articles a variety of ways (based, for example on your overall Star Rating, or your other Ratings, or based on the number of tags or highlights you added to them).

By clicking on or touching the plus symbol to the right of the article, it pops to the bottom of your list. You may then drag and drop it to change the order.

Professional curators may use My Lists to create lists that are published (with attribution, that is). They may also use My Lists to create lists that, behind the scenes, determine (in part or in whole) how content is prioritized within a publisher or other content owner's Web or mobile app (as well as how they fit within a range of potential contexts).

Along with many other options, users may filter their lists by time period, by topic, by category, by source; by author, and by tags and any combinations of tags. They may filter their lists using star ratings and ratings and flags, of based on people they have shared content with (or received content from, or both), to name a few, and based on any combination of these filters.

My Network

My network helps users view content based on the people with whom they have shared. For example, users can view lists of contacts organized alphabetically based on the frequency of sharing (for any selected time period). Such lists of contacts may be filtered down. The user may filter the list by typing text into a search box. The user may filter this list to include items sent, items received, or both. The user may filter this list using Star Ratings, Ratings, Flags, Categories, or Topics (among other options).

By selecting a particular contact, the user may view all of the relevant (filtered) sharing with them. The items shared may be viewed as a grid, a list, a slideshow, or other available views. The presentation of content may be further refined using a) text in a search field b) items I sent, items I received, or both, and c) any combination of these that match defined star ratings, ratings, flags, categories, and topics. The results may show items, highlights, comments, or any combination of the three or others.

My Profile

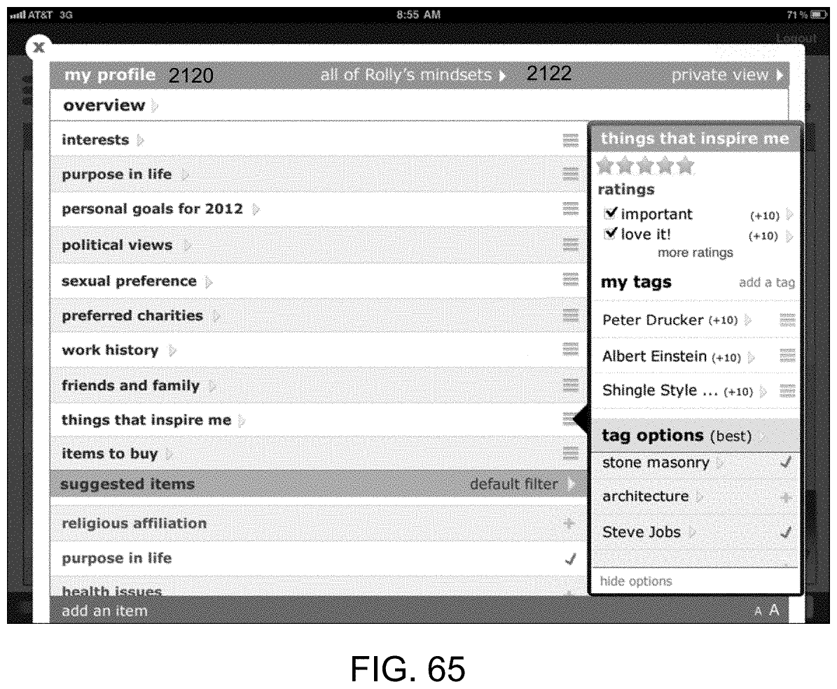

As shown in FIG. 65, a user can view and curate his personal Profile 2120 at any time. The Profile view lets them characterize their purpose, passions, and interests at a somewhat more abstracted level than “My Lists.” It also lets them dig deeper into a variety of self-descriptive areas.

My Profile allows a user to list and organize the things she chooses that matter most to her. In total, the items a user places in my profile, along with all of the information associated with clippings, highlights, and tags (including star ratings, ratings, flags, weightings, and subordinate tags, among others) and all of my tags and my topics and my categories and my lists and my network represent a view into that user's mindset, which is shown in as “all of Rolly's mindsets” 2122.

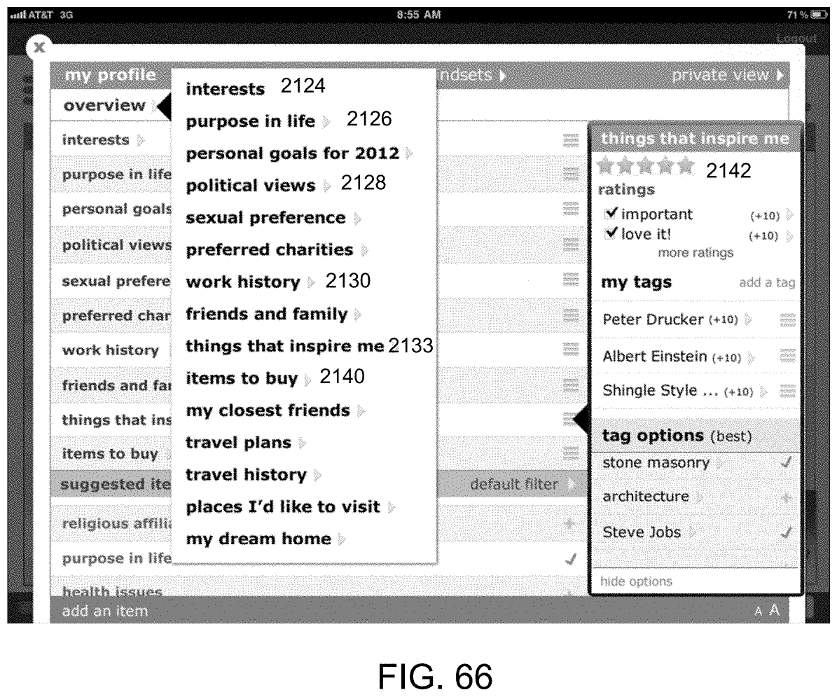

As shown in FIG. 66, a user may actively create and curate his specific interests 2124, purpose in life 2126, personal goals, political views 2128, CV 2130, list of family members and close friends. He may bring clarity to which things most inspire him 2133, or in a more mundane sense, what items he'd most like to buy 2140. Our system may suggest items to go in his overview (the top level of his profile), but he may add anything that matters to him to this list.

Further, he may add star ratings and ratings and (optionally) flags and tags and subordinate tags and tag weightings and tag orders for any list items 2142.

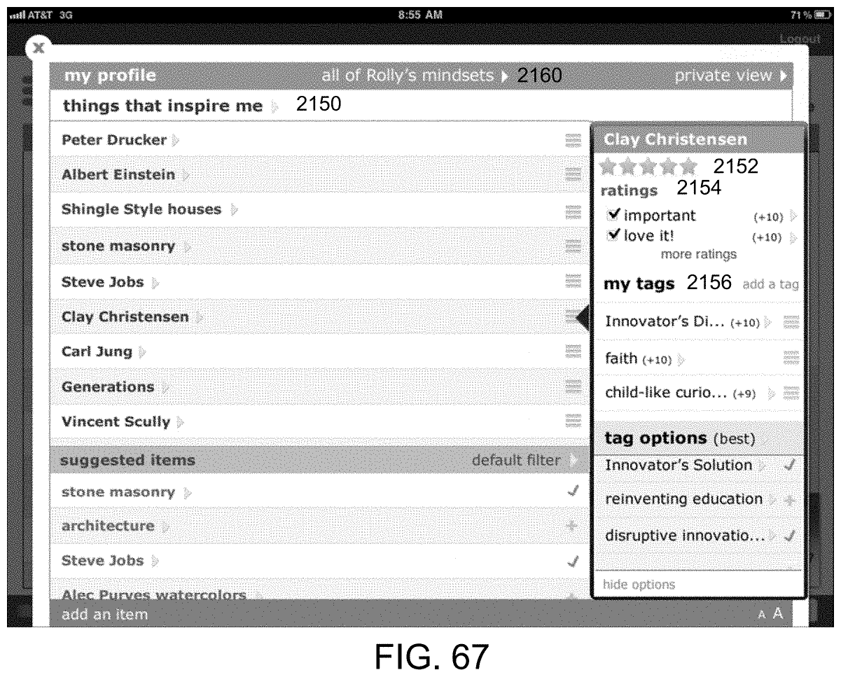

As shown in FIG. 67, he may choose to focus on any of these list items individually 2150.

He may curate this list and add star ratings 2152 and ratings 2154 and tags 2156 and subordinate tags and tag weightings and tag orders to any list items.

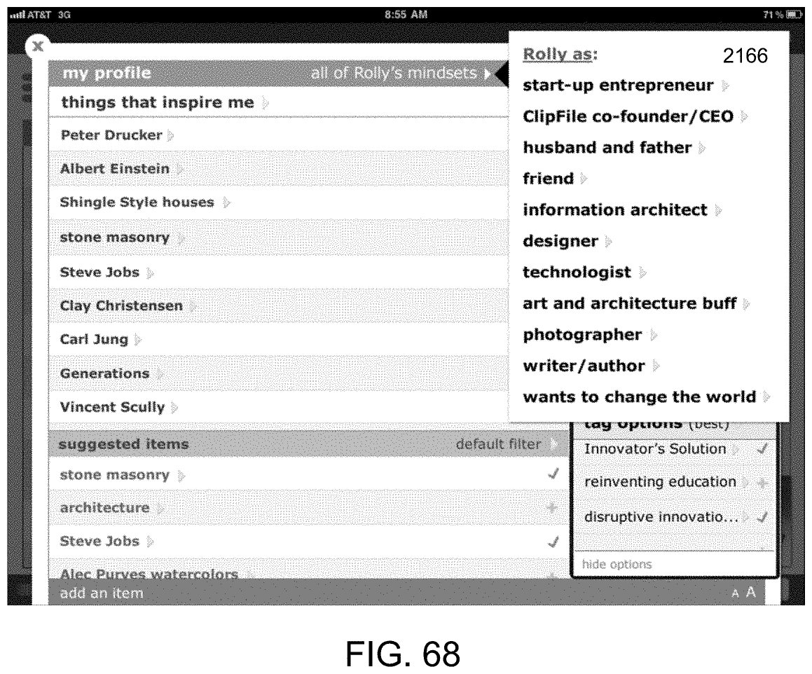

So far, these views are across all of the users mindsets 2160. As shown in FIG. 68, he may also select a specific mindset or “mindset persona” that usefully expresses a portion of his mindsets. These mindset personas may include as many self-descriptions as the user prefers 2166.

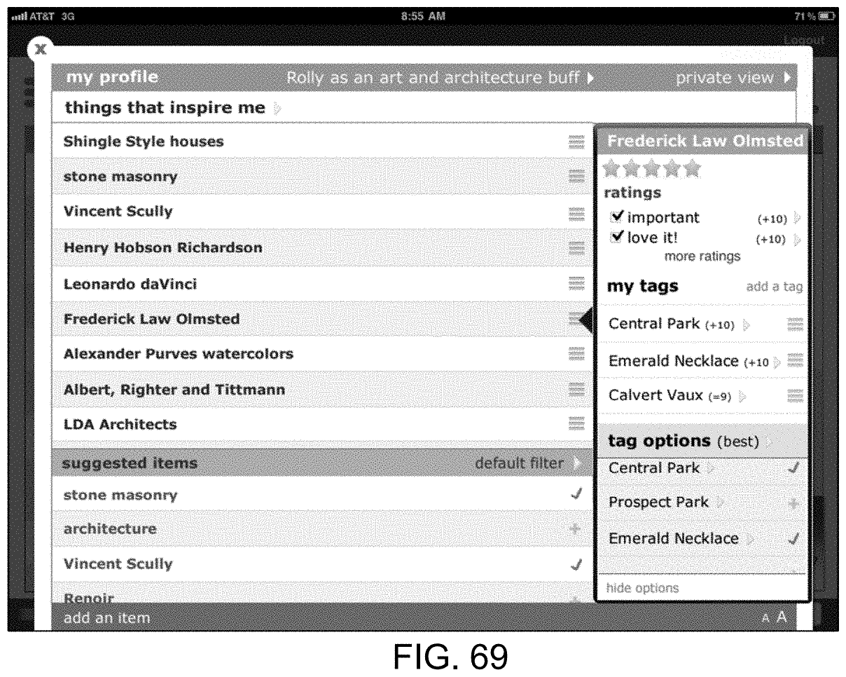

When the user select a view on his mindsets that has been narrowed, the content in his lists changes, as shown in FIG. 69. The lists may (or may not) overlap with the “all mindsets” view.

The user may choose to associate any list item and any of his lists (whether within his Profile or elsewhere) with any combination of his “mindset personas”. Or he may start with a selected mindset persona and choose items.

It is not necessary for a user to use the profile for our system to work. A user may simply choose to clip and tag and share items. Or to simply clip and share items. However, curating a profile may help users become more focused and self-aware. Such self-awareness will make the user's experience of content even more rewarding. It will also make it easier for publishers and advertisers to serve that user well.

The techniques described here can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. When we refer to computers we include any sort of computing device including mobile devices and mobile phones, without limit. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described here can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

A wide variety of data models can be used to implement features that we have described here. The following is only one example. Additional related information is illustrated in FIGS. 28 and 29. We sometimes use the trademark ClipFile in the following description as one example of the host or system discussed above.

Entity

In this example, all objects created, manipulated, and persisted by ClipFile are, at base, of the class, or type, Entity. As such, the Entity is the so-called supertype of all ClipFile objects. This allows ClipFile, and its users, to operate upon any ClipFile object instance using common data values and operations. In addition, an object instance can, depending upon its subtype, be differentiated and operated upon with subtype-specific operations and data. many of the features and capabilities of ClipFile's are enabled by this design; this design framework is also, and not coincidently, a recognized and well-tested common and current engineering best practice used the world over to build complex, but reliable, software systems.

All instances of every ClipFile object, no matter what its special capabilities and functionality may be, are at minimum constituted of the following values:
EntityID—a unique system-generated value used to identify an entity. This value is guaranteed to be unique, across space and time, within the ClipFile data space Every EntityID is otherwise opaque or invisible to a user or ClipFile application, and has no other semantic value.
EntityType—the system type, or subtype, of an entity, which self-identifies it as one of the subtypes described below, e.g. Tag, Artifact, etc.
ClippedBy—the Account, described below, of the user which created this entity
ClippedByDateTime—a standard encoded description of the date and time of creation of the entity with millisecond precision and time zone.
ModifiedBy—the Account, described below, of the user who last updated this entity
ModifiedByDateTime—a standard-encoded description of the date and time when last updated
DeactivatedBy: the Account, described below, of the user who has deactivated this entity. Deactivation of an entity can be thought of as the deletion or destruction of the entity; however, for various reasons, such as enabling the ability to audit Clipfile operations and security practices, deactivated entities are never actually erased or otherwise destroyed.
DeactivatedByDateTime—a standard encoded timestamp of the date and time of deactivation of this entity
SecurityLevel—a system-supplied, sometimes user-specified value describing a default or desired amount of security applied to operations to be performed on this entity. Example values include private, super-private, private-visible, public, etc., as described elsewhere in this document.
ListPosition—an integer value used for ordering entities in a List, described below.
Weighting—another integer value used for ordering entities in a List, described below.
Children—a List, described below, of entities explicitly and strongly associated with an entity. Entities such as Highlights, Tags, and Artifacts are commonly, but not exclusively, used as “children” of an entity. For example, a Clip of a web page can include artifacts describing and containing the HTML and raw text data on the page, user-generated Highlights excerpting the page, and user-entered Tags describing user-identified attributes of the web page, highlights, etc. This Clip can alternatively be thought to contain these child entities. Note that all entities, including Tags, described below, can contain child entities; indeed, Tags that are children of other Tags are an important enabling technology supporting the claims contained in this document.
FromEntity—the entity containing the List of which this entity is a member, i.e. its parent entity.
TopEntity—the entity, generally but not exclusively a Clip entity, described below, from which this entity, and its parent, are ‘descended’ from. More specifically, the TopEntity contains, as one or all of its children, either this entity, or more likely, an entity contained recursively as a child in another entity which contains this entity in the list constituting its children.

List

A List is an optionally-ordered collection of entities. Multiple signifiers of possible canonical orderings for list elements are an entity's list position and weighting, described above, as well as ratings, flags, and other attributes encoded in Tags, as described below.

Account

Each user of the ClipFile system is associated with one or more Accounts. The Account entity is used to identify, authenticate, and authorize a user, or application, to access and operate upon ClipFile entities. The type-specific data that constitute an Account are comprised of elements used in current and common engineering best practices as applied to application and system security, and as such can be effectively enhanced over ClipFile's lifetime to utilize future state-of-the-art security practices.
The EntityID, the unique identifier found in every entity, described above, is in this case used as a user's unique identifier within the system, which, as with all EntityIDs, is otherwise opaque or invisible to the user and to others.
Name. A simple string that may be used to label a user.
Email addresses, which are the “login” identities of a particular user, among other uses.
Credentials. Associated with each user account are a set of distinct credentials of multiple types/technologies, ranging from simple password to Public Key certificate, retina scan, fingerprint image, or any known or as-yet-undeveloped so-called shared secret used by ClipFile's security systems for authentication and authorization. Multiple credentials can be used for multi-factor authentication challenges, e.g. a demand for a second password to allow access to a user's super-private data.
Roles: lists of various user “actors” (publisher, editor, curator, author, agent, representative, broker, administrator, system administrator, general user, other) that a user may operate as in ClipFile, each of which may correspond to a set of Permissions, as well as to a set of Credentials.
Permissions: collections of business rules governing a user's access to ClipFile features and data. A set of ClipFile permissions will generally correspond to a set of Credentials, Roles, etc.
Lists. Each user's account can have multiple lists of other entities attached to it. Uses for lists can include accounts of users comprising the user's various networks, as well as a user's sets of Personas, Preferences, Contexts, and so forth, as described elsewhere in this document.

Clipping

A Clipping, or Clip, is a collection of Entities—in the simplest case a single Entity—which commonly, although not exclusively, describes an electronically encoded “thing,” or data object, which has been “clipped”, i.e. saved or published, in ClipFile. A Clip can encapsulate many types of objects including: a web page, a video clip, an email, a “tweet,” a chapter of a book, an audio clip, etc., as described elsewhere in this document.
Title—Many objects that are candidates for clipping, such as a web page, book, article, etc., either already have, or could have, a Title. A title is a free-text field containing a title for a clip.
Subject—as with the Title, many objects that could be clipped already have, or could have, a Subject. The Subject field holds a character string containing a clip's subject.
Description—the Description field is also an analogue to the Title and Subject fields.
Source—objects such as an article, web page, or book chapter, could have been published by a specific publisher, e.g. The New York Times, ABC News, Springer-Verlag, etc. The Source field contains a character string describing the publisher of a clip.
Author—as with the Source, many clips could have been produced by a human author; the name of this person may be contained in the Author field.
PublishDate—a Clipping may describe and contain data that was created or otherwise “published” at a specific date and time; data such as photographs, video, web pages, and magazine articles typically have a defined publishing or creation date and/or time
ClippingArtifact—an Artifact, as specified below, which describes and contains a copy of the original data item which is being clipped, in its original encoding. The data clipped by a user or application, to be stored in ClipFile, is always copied into the ClipFile database; this ensures that the data itself, as well as all the meta-data contained in the accompanying ClipFile entities, is saved within the ClipFile system itself.

Media

A Media entity is a subtype of both the Entity and Clipping classes, described above; it contains descriptive data specific to the type of media being clipped. The fields in the Media entity describe attributes of the data that are not generally associated with all data stored in ClipFile. For example, a WebPage entity contains two fields in addition to those inherited from the Entity and Clipping classes above:
URL—a web page is usually accessed and rendered using a web browser as specified in a Universal Resource Locator, a string that can be thought of as an “address” used to locate and then download the HTML-encoded data. It is useful to store the original URL of a web page clipping, even though it will be copied and stored within ClipFile in the Clipping's ClippingArtifact, as described above.
PureTextArtifact—in addition to the clipped data persisted in its original encoding, it is useful to also store another copy of the data contained in the original web page; this copy has had all HTML, CSS, Javascript, Java, Ruby, and all other formatting and control elements from the data, leaving only the human-readable text. This allows a program other than a web browser or other rendering device to present the text in a readable form to a ClipFile user.

Media entities for other media or encodings of data to be clipped and persisted in ClipFile will contain appropriate and sufficient data fields specific to the particular media being clipped to enable optimal manipulation and rendering of the data in ClipFile. An example field not appropriate to contain in a WebPage Media clipping, but useful in a Book Media entity, would be the ISBN number assigned to a book being clipped or published in ClipFile. As there are many dozens of such data objects and data encodings in existence today, and possibly many others not yet developed that could be clipped in the future, an exhaustive list of possible fields contained in Media entities is outside the scope of this document.

Artifact

The Artifact entity is designed to provide ClipFile with the capability to efficiently and robustly persist and manipulate data objects clipped and published by ClipFile users. The Artifact entity contains data elements that describe the data object as stored in the ClipFile database. This abstraction allows ClipFile to use database technology appropriate for the storage and manipulation of data, which can be different, as well as physically separate, from that used to persist and manipulate ClipFile entities themselves.

Class—the data object described and referenced by an Artifact can be differentiated by “type”; for example, an Artifact contained as a PureTextArtifact within a Media entity can have a Class designation of “PureText,” which enables the Artifact to describe itself independent of the enclosing entity.

DataDBName—the DataDBName of an Artifact contains a DBMS-specific value specifying the particular data store containing the data object. This string is typically opaque to the ClipFile system itself, but is needed by ClipFile to manipulate and persist this data object within the DBMS.

DataObjectKey—this value contains the DBMS-specific key or index used to access the data described by this Artifact. The combination of DataDBName and DataObjectKey fields is generally sufficient to access data within a typical DBMS; however, other DBMSs used to persist Clip data may in future need fewer, more, or different fields and values for this functionality.

Data—the Data field is used to access clipped data objects as stored within the local server's memory, after reading or before writing data to the DBMS used to persist clipped data objects. This allows ClipFile to also use the Entity that describes and logically encloses the data objects to access and manipulate these data objects during operations on ClipFile objects and data. For example, the Data field can be used to access and prepare clipped data to be sent over the network from a ClipFile server to a user's ClipFile client application running on a cell phone or other portable device.

ByteLength—the size, in 8-bit bytes, of the raw binary encoding of the data object as stored in the data DBMS used by ClipFile. As such, this field may also describe the size of the data object as transmitted over a network, as stored in a server's local memory, or as stored in and rendered by a ClipFile client application.

MIMEType—the standard Internet Media Type, or Content Type, of the clipped data object, as originally defined as a MIME (Multipurpose Internet Mail Extension) type in IETF RFC 2046, with the extensions currently in common use by applications and systems that transmit, receive, render, and otherwise operate upon data communicated over the Internet. The MIMEtype of a data object can be thought of as the international standard type designation for the object, one that completely describes the encoding scheme, and the encoding and decoding methodologies, for this data object.

MD5Checksum—a commonly used method of data error detection, as well as ensuring data integrity, is the use of checksums, which are values typically calculated from a data object's physical properties, with the added integrity provided by standard data encryption algorithm such as MD5. By calculating and storing an MD5 checksum as data is created or stored, and then recomputing the checksum on the data object after it has been retrieved from a database or received over a network, a system such as ClipFile can detect whether data has been garbled or even maliciously changed since the time of creation, storage, or transmission across a network.

UsageCount—data objects clipped and published in ClipFile can be used by multiple Clip or other entity instances; sharing data objects within ClipFile optimizes the resources used to manipulate and persist clipped data (e.g. 1 copy of a 30 minute video clipped and shared by a million ClipFile users, versus a minimum of one million copies of the same clip), as well as ensuring that multiple entities that describe and contain the same data item actually describe and logically contain the same ClipFile data object persisting the encoded data. Maintaining a usage count for a data object, that is, a number of entities describing and logically containing this piece of clipped data, is a technique commonly used in applications and database management systems to control and manage the sharing of data within the system.

Tag

Tags are entities containing data used to describe, classify, qualify, or otherwise enhance the “meaning” of a parent entity, beyond that which can be encoded within the fields of that entity object itself. A tag may be thought of as meta-data attached to an entity, encoded as a singleton or tuple.
TagText: the tag value, specifying some semantic information, which is commonly, but not exclusively, free text input by a user. For example, “Norman Mailer”.
TagClass: describes the type of this tag. Examples include “title”, “author”, “publish date”, “publisher”, and “web page URL”.
ListPosition: an integer value used to define the position of the tag in a list of tags.
TagWeighting: an integer value used to compare this tag to other tags.
TagScale: an integer used to hold a user-defined degree of agreement with the tag's TagText. For example, an application could provide a slider to let the user choose any value between −10 and +10 to indicate how much they agree [zero to +10] or disagree [−10 to zero] with each of the statements: “I am a Republican”, “I am a Democrat”, and “I am an Independent”.

Note that ClipFile also uses Tags to add application-specific data to a parent entity. For example, a Tag with TagClass=“flag” could be used to further differentiate whether its parent entity is a “ClipFile patent document” or a “potential competitor.”

Another application-specific use for this generalized Tag functionality is Ratings. For example, given TagClass=“rating” and TagText=“Important!!!” this could indicate that its parent entity has been rated as “Important!!!”

Highlight

A Highlight entity describes a user-selected subset of the data described by its parent Clip. An example Highlight could be a paragraph of text contained within a web page article, or a snippet of audio data containing a single question and answer edited from an hour-long radio program.
HighlightArtifact: an Artifact entity describing and containing the opaque blob of data constituting the highlight.

TagRelationship

A TagRelationship entity is used to go beyond a tag's basic parent-child relationship using the FromEntityID field. The TagRelationship entity type is used to describe many-to-many “relationships” between tags. This entity can be used to define any type of named and directed relationship between a pair of Tags. One or more TagRelationship entities can be used to define how (and to what degree) a single Tag relates to another single Tag or to a list of Tags.
RelateFromTagText: the text value of a pre-existing Tag entity. The “FromTag” can also be thought of as the “BeginTag” or “StartTag”.
RelateTagText: the text value of a pre-existing Tag entity used to describe a directed relationship between a pair of Tags. Examples of directed relationships include: “is a child of”, “is a parent of”, “is similar to”, “is a kind of”, “is a part of”, “belongs to”, “is a member of”.
RelateToTagText: the text value of a pre-existing Tag entity. The “ToTag” can also be thought of as the “EndTag” or “FinishTag”.
RelateWeighting: an integer value used to describe the strength of the given relation. For example, the weighting could be used to describe the weighted relationships among 3 Tags, “Teal”, “Blue” and “Green”:
   Teal is 70% Blue
   Teal is 30% Green
RelateFromTagID: the entity ID of the FromTag
RelateTagID: the entity ID of the RelateTag
RelateToTagID: the entity ID of the ToTag

For example, TagRelationships can be used to describe a variety of blue or blue-ish colors:

| RelateFrom | Relate | RelateTo |
|---|---|---|
| TagText | TagText | TagText |
| Aquamarine | Is a type of | Blue |
| Blueberry | Is a type of | Blue |
| Blue Bell | Is a type of | Blue |
| Blue Gray | Is a type of | Blue |
| Blue Green | Is a type of | Blue |
| Cerulean | Is a type of | Blue |
| Cobalr Blue | Is a type of | Blue |
| Cornflower Blue | Is a type of | Blue |
| Denim | Is a type of | Blue |
| Indigo | Is a type of | Blue |
| Midnight Blue | Is a type of | Blue |
| Navy Blue | Is a type of | Blue |
| Pacific Blue | Is a type of | Blue |
| Pewter Blue | Is a type of | Blue |
| Sapphire Blue | Is a type of | Blue |
| Sky Blue | Is a type of | Blue |
| Steel Blue | Is a type of | Blue |
| Teal | Is a type of | Blue |
| Turquoise Blue | Is a type of | Blue |

Conversely, if the From and To tags are switched then the “Is a type of” type of relationship would need to be inverted to something like “Is a primary component of”.

| RelateFrom | Relate | RelateTo |
|---|---|---|
| TagText | TagText | TagText |
| Blue | Is a primary component of | Aquamarine |
| Blue | Is a primary component of | Blueberry |
| Blue | Is a primary component of | Blue Bell |
| . . . | . . . | . . . |
| Blue | Is a primary component of | Sky Blue |
| Blue | Is a primary component of | Steel Blue |
| Blue | Is a primary component of | Teal |
| Blue | Is a primary component of | Turquoise Blue |

ClipFile Entity Functionality

ClipFile Entities implement various operations upon themselves, and upon the data they describe, in order to enable the activities of ClipFile users and applications. These activities, described elsewhere in this document, include Discovery, Curating, and Sharing. The primary ClipFile entity operations designed to support these and other ClipFile activities can be described as follows:

Entity, List: Create, Find, Update, Disable Entity

These operations comprise the so-called CRUD operations—create, read, update, delete—which are common and current engineering terms-of-art describing the basic operations performed upon an idealized set of persistent data objects, such as those performed by ClipFile entity instances, in software and hardware systems. All ClipFile Entities and Lists, of all Entity types, implement these operations.

Furthermore, every Entity also implements two operations, getx and setx, for all x which are names of fields in an entity; these functions allow the application to retrieve and replace the values contained within those entity fields. The use of “getter and setter” functions in an idealized persistent object, as implemented by a ClipFile entity instance, is also a common and current engineering best practice utilized in the design and implementation of software systems.

Account: LoginUser, LogoutUser

Accounts implement loginUser to authenticate and certify a user, application, a specific computer system, or combination thereof, and then to “arm” ClipFile to authorize operations on ClipFile objects, based upon the data contained in the Account entity, such as Credentials, Roles, Permissions, and possibly Lists of Users, Contexts, Personas, Profiles and the like. logoutUser is performed to gracefully exit the user from ClipFile, and to help prevent access to data and operations controlled by the Account entity when the user or application has not been authenticated.

Other implementations are also within the scope of the following claims.

1.-162. (canceled)

163. A computer-implemented method comprising:
receiving a request from a user to create a particular tag,
wherein a tag can be a root-level tag, a subordinate tag, or both;
wherein each subordinate tag refers to a root-level tag or to another subordinate tag,
wherein each root-level tag is referred to by zero or more subordinate tags, and
wherein a subordinate tag that is referred to by another subordinate tag is also a root-level tag;
in response to receiving a request from the user to create the particular tag, storing, in a tag facility, data for the particular tag, the data comprising:
a token that represents a particular observation of the user,
a set of tag attributes, and
a content pointer to a content item or to another tag;
organizing the particular tag within a pool of tags; and
exposing the organized pool of tags to the user, to another user, or to a machine, using a user application.

164. The method of claim 163, wherein each tag represents an observation made by a user.

165. The method of claim 163, wherein the user comprises a content consumer, a content creator, a content curator, a content publisher, or a content marketer.

166. The method of claim 163, wherein the set of tag attributes comprises a type attribute, a strength attribute, and a context attribute.

167. The method of claim 163, wherein the data for the particular tag further comprises association information.

168. The method of claim 163, comprising generating an index using a cluster of tags including the particular tag.

169. The method of claim 163, comprising navigating a content option using the particular tag.

170. The method of claim 163, comprising personalizing an index using the particular tag.

171. The method of claim 163, comprising personalizing a navigation of content items using the particular tag.

172. A system comprising:
one or more processors; and
one or more non-transitory machine-readable storage devices storing instructions that are executable by the one or more processors to perform operations comprising:
receiving a request from a user to create a particular tag,
wherein a tag can be a root-level tag, a subordinate tag, or both;
wherein each subordinate tag refers to a root-level tag or to another subordinate tag,
wherein each root-level tag is referred to by zero or more subordinate tags, and
wherein a subordinate tag that is referred to by another subordinate tag is also a root-level tag;
in response to receiving a request from the user to create the particular tag, storing, in a tag facility, data for the particular tag, the data comprising:
a token that represents a particular observation of the user,
a set of tag attributes, and
a content pointer to a content item or to another tag;
organizing the particular tag within a pool of tags; and
exposing the organized pool of tags to the user, to another user, or to a machine, using a user application.

173. The system of claim 172, wherein each tag represents an observation made by a user.

174. The system of claim 172, wherein the user comprises a content consumer, a content creator, a content curator, a content publisher, or a content marketer

175. The system of claim 172, wherein the set of tag attributes comprises a type attribute, a strength attribute, and a context attribute.

176. The system of claim 172, wherein the data for the particular tag further comprises association information.

177. The system of claim 172, wherein the operations comprise generating an index using a cluster of tags including the particular tag.

178. The system of claim 172, wherein the operations comprise navigating a content option using the particular tag.

179. The system of claim 172, wherein the operations comprise personalizing an index using the particular tag.

180. The system of claim 172, wherein the operations comprise personalizing a navigation of content items using the particular tag.

181. A non-transitory computer storage medium encoded with a computer program, the computer program comprising instructions that when executed by one or more processors cause the one or more processors to perform operations comprising:
receiving a request from a user to create a particular tag,
wherein a tag can be a root-level tag, a subordinate tag, or both;
wherein each subordinate tag refers to a root-level tag or to another subordinate tag,
wherein each root-level tag is referred to by zero or more subordinate tags, and
wherein a subordinate tag that is referred to by another subordinate tag is also a root-level tag;
in response to receiving a request from the user to create the particular tag, storing, in a tag facility, data for the particular tag, the data comprising:
a token that represents a particular observation of the user,
a set of tag attributes, and
a content pointer to a content item or to another tag;
organizing the particular tag within a pool of tags; and
exposing the organized pool of tags to the user, to another user, or to a machine, using a user application.

182. The medium of claim 181, wherein each tag represents an observation made by a user.
